(19) United States
(12) Patent Application Publication
(10) Pub. No.: US 2026/0161127 A1
(43) Pub. Date: Jun. 11, 2026

(54) IMAGE FORMING APPARATUS

(71) Applicant: CANON KABUSHIKI KAISHA, Tokyo (JP)

(72) Inventors: SHUHEI TAKANO, Kanagawa (JP); NAOKI KANNO, Kanagawa (JP); SHOTOKU MATSUI, Kanagawa (JP); SATOSHI ISHIDA, Kanagawa (JP); TAKUYA HAYATO, Kanagawa (JP); HIROMITSU TAKANO, Kanagawa (JP)

(21) Appl. No.: 19/181,781

(22) Filed: Apr. 17, 2025

(30) Foreign Application Priority Data
Apr. 18, 2024 (JP) 2024-067720
Apr. 22, 2024 (JP) 2024-069170
Apr. 24, 2024 (JP) 2024-070811
Apr. 24, 2024 (JP) 2024-070812

(51) Int. Cl. G03G 15/00; G03G 15/08; G03G 21/16

(52) U.S. Cl. CPC G03G 15/556; G03G 15/086; G03G 15/0863; G03G 21/1619; G03G 21/1676; G03G 2215/0697; G03G 2221/163

(57) ABSTRACT

An image forming apparatus is configured to have a cartridge containing toner detachably attached thereto. The image forming apparatus includes a photosensitive member, a developing unit and a control unit. The developing unit is configured to be supplied with the toner from the cartridge and develop an electrostatic latent image formed on the photosensitive member using the toner. The control unit is configured to control whether or not to execute replacement processing for replacing the cartridge on a basis of information relating to the cartridge in a case where there is an instruction to replace the cartridge.

### BACKGROUND OF THE INVENTION

### Field of the Invention

The present invention relates to an image forming apparatus that forms an image on printing material.

### Description of the Related Art

Relating to electro-photographic image forming apparatuses, a known rotary developing system forms a color image by rotating a rotary provided with a plurality of developing rollers. In Japanese Patent Laid-Open No. 2007-183305 and Japanese Patent Laid-Open No. 2008-096852, an image forming apparatus is described that includes a rotary including a plurality of developing rollers and a plurality of toner cartridges (toner containers) detachably attached to the rotary.

Hereinafter, a toner cartridge may be simply referred to as a cartridge.

A cartridge used in such an image forming apparatus may be the target of a subscription service. A subscription service is, for example, a service that enables a specific number of sheets to be printed using an image forming apparatus that is the contract target, by a user paying a service provider (hereinafter, referred to as a business operator) a predetermined amount of money, as described in Japanese Patent Laid-Open No. 2018-156224. Note that the image forming apparatus that is the contract target is installed in a user environment such as the office of the user. With the subscription service, as part of the subscription contract, the business operator, for example, monitors the remaining amount of toner in the image forming apparatus that is the contract target and provides the user with cartridges so that the toner does not run out.

### SUMMARY OF THE INVENTION

Normally, an image forming apparatus that uses cartridges executes the processing required for replacing a cartridge in response to an instruction to replace the cartridge. Thus, the cartridge replacement is to be performed according to an instruction to replace a cartridge with sufficient toner still remaining. Here, in a case where the image forming apparatus is the target of a subscription service, if a cartridge with a large amount of toner remaining is replaced and discarded, the business operator would need to provide the user with more cartridges than necessary. Also, even in a case where the image forming apparatus is not a target of a subscription service, if a cartridge with a large amount of toner remaining is replaced and discarded, the user is disadvantaged. An aspect of the present disclosure enables realization of technology for preventing the unnecessary replacement of a cartridge.

An aspect of the present disclosure provides an image forming apparatus configured to have a cartridge containing toner detachably attached thereto, comprising: a photosensitive member; a developing unit configured to be supplied with the toner from the cartridge and develop an electrostatic latent image formed on the photosensitive member using the toner; and a control unit configured to control whether or not to execute replacement processing for replacing the cartridge on a basis of information relating to the cartridge in a case where there is an instruction to replace the cartridge.

In an image forming apparatus using a rotary developing system such as those described in Japanese Patent Laid-Open No. 2007-183305 and Japanese Patent Laid-Open No. 2008-096852, for example, an image forming operation may not be performed in a case where there is a small toner remaining amount inside a toner cartridge. In such cases, the image forming apparatus needs to prompt the user to replace the toner cartridge by displaying a message on a display unit or the like. However, in a case where the user does not see such a message, the user finally learns of the need to replace the toner cartridge after an image formation instruction has been input to the image forming apparatus and an image forming operation is not performed. Thus, the significant amount of time will be required until the replacement task for the toner cartridge is completed and image formation can be made performable. Accordingly, another aspect of the present disclosure provides technology for making it easier for the user to recognize the need to replace a cartridge in an image forming apparatus.

Another aspect of the present disclosure provides an image forming apparatus configured to have a cartridge containing toner detachably attached thereto, comprising: a photosensitive member; a rotary configured to be able to rotate and comprising a developing unit configured to develop an electrostatic latent image formed on the photosensitive member using the toner supplied from the cartridge; a moving device configured to move the cartridge between an installed position where the cartridge is located inside the rotary and a retracted position where the cartridge is located outside the rotary; a control unit configured to execute, in a case where a movement instruction for the cartridge is received, movement processing to control the moving device to move the cartridge from the installed position to the retracted position; and an obtaining unit configured to obtain a toner remaining amount inside the cartridge, wherein in a case where the obtained result of the obtaining unit satisfies a predetermined condition, the control unit executes the movement processing even in a case where the movement instruction has not been received.

When there is an instruction from the user to replace a toner cartridge, the image forming apparatus using a rotary developing system rotates a rotary so that the toner cartridge to be replaced is moved to a predetermined replacement position and is then put on standby until the user performs replacement. Depending on the posture (attitude) of the rotary before the start of the movement of the toner cartridge to be replaced, the rotation angle of the rotary when moving the toner cartridge to the replacement position may increase. This creates a waiting time from when the user makes a replacement instruction to when the user can actually perform the replacement task for the toner cartridge.

Accordingly, yet another aspect of the present disclosure provides technology for reducing, in a case where a cartridge in the image forming apparatus needs to be replaced, the amount of waiting time until the user can perform the replacement task.

Still another aspect of the present disclosure provides an image forming apparatus configured to have a cartridge containing toner detachably attached thereto, comprising: a rotary configured to be able to rotate and comprising a containing portion that contains toner supplied from the cartridge, and a developing member that develops an electrostatic latent image formed on a photosensitive member using the toner contained in the containing portion; a moving device configured to, in a case where the rotary is in a replacement posture, move the cartridge from an installed position where the cartridge is located inside the rotary to a retracted position where the cartridge is located outside the rotary; a control unit configured to, in a case where a movement instruction for the cartridge is received, rotate the rotary until it is in the replacement posture and further cause the cartridge to move from the installed position to the retracted position; and an obtaining unit configured to obtain a toner remaining amount inside the cartridge, wherein in a case where the obtained result of the obtaining unit satisfies a predetermined condition, the control unit executes processing to rotate the rotary to approach the replacement posture and rotate the rotary until it is in a standby posture.

Further features of the present invention will become apparent from the following description of exemplary embodiments (with reference to the attached drawings).

### BRIEF DESCRIPTION OF THE DRAWINGS

FIG. 1 is a schematic cross-sectional view of an image forming apparatus according to some embodiments.

FIG. 2 is a schematic drive configuration diagram of an image forming apparatus according to some embodiments.

FIG. 3 is a schematic view of a developing unit, a cartridge, and a tray according to some embodiments.

FIGS. 4A and 4B are cross-sectional views at or near a rotary of an image forming apparatus according to some embodiments.

FIG. 5 is a perspective view of a rotary body according to some embodiments.

FIGS. 6A to 6C are perspective views of an image forming apparatus according to some embodiments.

FIGS. 7A and 7B are cross-sectional views at or near a rotary of an image forming apparatus according to some embodiments.

FIG. 8 is an explanatory diagram of a rotary body according to some embodiments.

FIG. 9 is an explanatory diagram of a rotary body according to some embodiments.

FIG. 10 is an explanatory diagram of a rotary body according to some embodiments.

FIGS. 11A and 11B are explanatory diagrams of a tray movement configuration according to some embodiments.

FIGS. 12A and 12B are explanatory diagrams of a tray movement configuration according to some embodiments.

FIG. 13 is a diagram illustrating an example of a control configuration of an image forming apparatus according to some embodiments.

FIG. 14 is a diagram illustrating an example of operation buttons provided on an image forming apparatus according to some embodiments.

FIGS. 15A to 15C are functional block diagrams of an engine control unit according to some embodiments.

FIG. 16 is a flowchart of processing executed by an engine control unit according to an embodiment.

FIG. 17 is a flowchart of processing executed by an engine control unit according to an embodiment.

FIG. 18 is a flowchart of processing executed by an engine control unit according to an embodiment.

FIGS. 19A to 19D are diagrams illustrating detection examples of tray states according to some embodiments.

FIGS. 20A to 20D are diagrams illustrating detection examples of tray states according to some embodiments.

FIG. 21A is a block diagram illustrating an example of a control configuration of an image forming apparatus according to some embodiments.

FIG. 21B is a block diagram illustrating an example of the functional configuration of an engine control unit according to some embodiments.

FIG. 22 is a flowchart illustrating an example of a cartridge movement control process according to an embodiment.

FIG. 23 is a flowchart illustrating an example of a cartridge movement control process according to an embodiment.

FIG. 24A is a flowchart illustrating an example of a sleep transition control process according to an embodiment.

FIG. 24B is a flowchart illustrating an example of a sleep restoration control process according to an embodiment.

FIG. 25A is a block diagram illustrating an example of a control configuration of an image forming apparatus according to some embodiments.

FIG. 25B is a block diagram illustrating an example of the functional configuration of an engine control unit according to some embodiments.

FIG. 26 is a flowchart illustrating an example of a process of posture control for a rotary body according to an embodiment.

FIGS. 27A and 27B are flowcharts illustrating examples of a process of replacement determination processing (step S2602) according to an embodiment.

FIG. 28 is a configuration diagram relating to control of an image forming apparatus according to an embodiment.

FIGS. 29A and 29B are flowcharts relating to control according to an embodiment.

FIG. 30 is a diagram illustrating a display unit according to an embodiment.

FIG. 31 is a flowchart relating to control according to an embodiment.

FIG. 32 is a configuration diagram relating to control of an image forming apparatus according to an embodiment.

FIG. 33 is a flowchart relating to control according to an embodiment.

### DESCRIPTION OF THE EMBODIMENTS

Embodiments will be described in detail below with reference to the attached drawings. Note that the invention according to the scope of the claims is not limited by the embodiments described below. A plurality of advantages of the embodiments are given. However, all of the plurality of advantages are not required for the invention. Also, the plurality of advantages may be combined in a discretionary manner. Furthermore, in the attached drawings, the same or equivalent components are denoted with the same reference number, and redundant descriptions will be omitted.

### First Embodiment

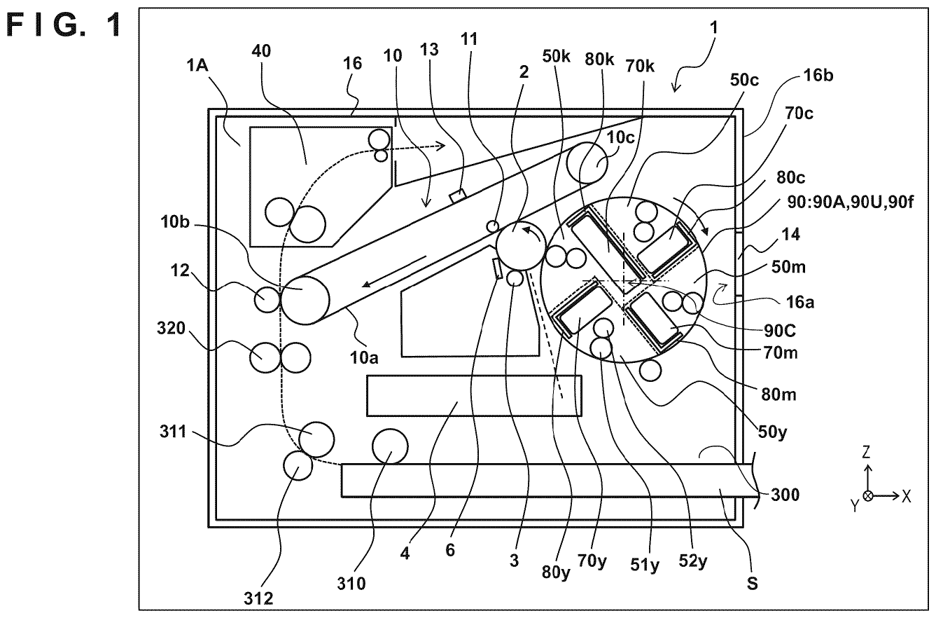

An image forming apparatus 1 according to the present embodiment will now be described using FIGS. 1 to 12B. In the following description and each diagram, the vertical direction when the image forming apparatus 1 is placed on a horizontal plane corresponds to a Z direction. A direction of a rotation axis 90C of a rotary body 90 described below (rotary rotation axis direction) that intersects the Z direction corresponds to a Y direction. A direction that intersects both the Z direction and the Y direction corresponds to an X direction. The X direction and the Y direction are preferably horizontal directions. Also, the X direction, the Y direction, and the Z direction are preferably orthogonal to one another. Also, when necessary, the direction of arrows X, Y, and Z illustrated in the diagrams are represented by the +X side, the +Y side, and the +Z side, and the opposite sides being represented by the-X side, the-Y side, and the-Z side.

### Overall Configuration of Image Forming Apparatus

First, the overall configuration of the image forming apparatus 1 will be described. The image forming apparatus 1 is a laser beam printer that forms an image on a sheet S via electro-photography. Specifically, the image forming apparatus 1 is a color laser beam printer provided with four developing units 50y, 50m, 50c, and 50k. Various sheet materials of different sizes and materials can be used as the sheet S, which is the printing material (printing medium), with examples including paper such as plain paper and thick paper, plastic film, cloth, coated paper and similar sheet material obtained by surface treatment, sheet material with a special shape such as envelopes and index paper, and the like.

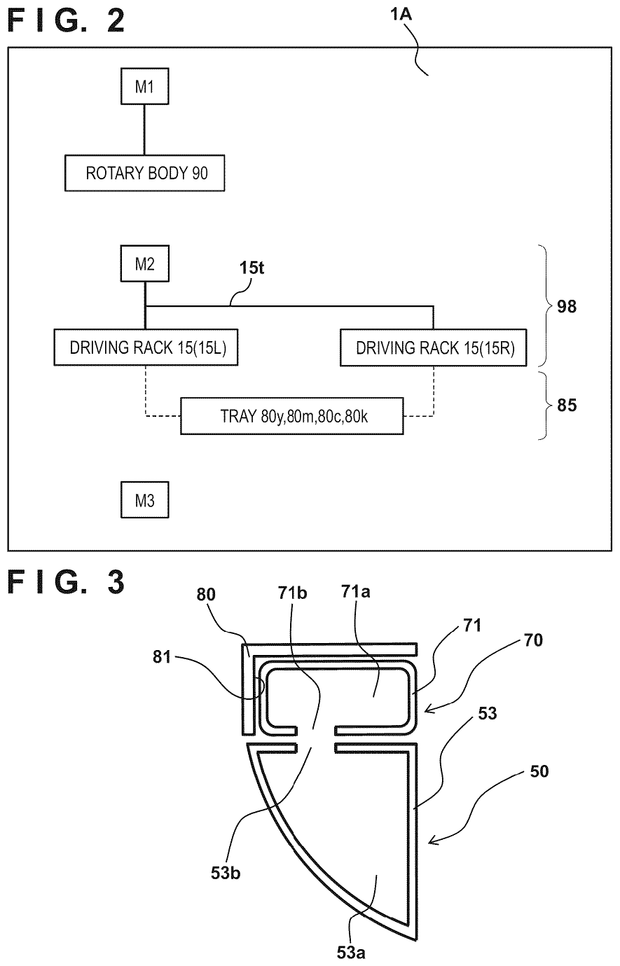

The general configuration of the image forming apparatus 1 and the image forming operations will now be described using FIGS. 1, 2, and 3. FIG. 1 is a schematic view illustrating the cross-sectional configuration of the image forming apparatus 1. FIG. 2 is a diagram for describing a drive source of the image forming apparatus 1. FIG. 3 is a conceptual diagram illustrating a configuration for supplying toner to the developing unit 50 from a toner cartridge 70. Note that in the present specification, a toner cartridge may be simply referred to as a cartridge. As illustrated in FIG. 1, the image forming apparatus 1 includes an image forming apparatus body (hereinafter referred to as an apparatus body) 1A and the cartridges 70y, 70m, 70c, and 70k detachably attached to the apparatus body 1A. The apparatus body 1A corresponds to the part of the image forming apparatus 1 excluding the cartridges 70y, 70m, 70c, and 70k.

The apparatus body 1A includes an electrophotographic photosensitive member (hereinafter referred to as a photosensitive drum) 2 with a drum shape (cylindrical shape) as an image carrier for carrying an electrostatic latent image. Around the photosensitive drum 2, a charging roller 3, a scanner 4 functioning as an exposure device, and a cleaning unit 6 are arranged. The charging roller 3 is an example of a charging unit that uniformly charges the photosensitive drum 2. The scanner 4 is an example of an exposure unit that performs exposure by emitting laser light to the photosensitive drum 2 according to image information. By a laser light being emitted to the photosensitive drum 2 after charging, an electrostatic latent image is formed on the photosensitive drum 2. The cleaning unit 6 is an example of a cleaning member that removes toner remaining on the surface of the photosensitive drum 2.

Also, the apparatus body 1A includes a sheet housing portion 300, a pickup roller 310, a feed roller 311, a separation roller 312, a conveyance roller pair 320, a secondary transfer roller 12, a fixing device 40, and an intermediate transfer unit 10. The pickup roller 310 is an example of a supply unit that supplies the sheets S. The feed roller 311 and the separation roller 312 are an example of a separation/conveyance unit that separates the sheets S via friction and conveys them one sheet at a time. The secondary transfer roller 12 is an example of a transfer unit that transfers an image onto the sheet S from an intermediate transfer belt 10a.

The intermediate transfer unit 10 includes the intermediate transfer belt 10a, a belt driving roller 10b, a tension roller 10c, a cleaning device 13, and a primary transfer roller 11. The intermediate transfer belt 10a is an example of an intermediate transfer member that carries an image transferred (primary transfer) from the photosensitive drum 2 and conveys the image for transfer (secondary transfer) onto the sheet S. The intermediate transfer belt 10a is stretched around the belt driving roller 10b and the tension roller 10c. The belt driving roller 10b is rotationally driven by the drive source and in turn rotates the intermediate transfer belt 10a.

Also, the apparatus body 1A includes the rotary body (rotary, or rotating member) 90 including the developing units 50y, 50m, 50c, and 50k. As described below, in the present embodiment, trays 80y, 80m, 80c, and 80k are installed in the rotary body 90. The cartridges 70y, 70m, 70c, and 70k are detachably installed on the trays 80y, 80m, 80c, and 80k.

The tray 80k supports the cartridge 70k. The tray 80m supports the cartridge 70m. The tray 80y supports the cartridge 70y. The tray 80c supports the cartridge 70c.

The developing units 50y, 50m, 50c, and 50k develop (make visible) the electrostatic latent image formed on the photosensitive drum 2 into a toner image using the toners of the corresponding colors. The developing units 50y, 50m, 50c, and 50k develop the electrostatic latent image formed on the photosensitive drum 2 using yellow toner, magenta toner, cyan toner, and black toner, respectively.

The developing unit 50y includes a developing roller 51y, a supplying roller 52y, and a developing blade. The developing roller 51y is a developer carrier that carries a toner as a developer, rotates, and supplies the toner to the photosensitive drum 2. The supplying roller 52y is a supply member that is disposed in contact with the developing roller 51y and supplies toner to the developing roller 51. The developing blade is a regulating member that regulates the thickness of the toner layer carried by the developing roller 51y. The other developing units 50m, 50c, and 50k similarly include developing rollers 51m, 51c, and 51k; supplying rollers 52m, 52c, and 52k; and developing blades.

In the rotary body 90, the cartridges 70y, 70m, 70c, and 70k corresponding to the developing units 50y, 50m, 50c, and 50k are installed adjacent to the developing units 50y, 50m, 50c, and 50k. Inside the cartridges 70y, 70m, 70c, and 70k, as toner for supplying the developing units 50y, 50m, 50c, and 50k, yellow toner, magenta toner, cyan toner, and black toner are housed.

Here, the rotary body 90 includes a rotary frame body 90f that supports the developing units 50y, 50m, 50c, and 50k. The developing units 50y, 50m, 50c, and 50k are supported by the rotary frame body 90f, which is a rotatable rotary support member.

Also, the trays 80y, 80m, 80c, and 80k are installed in the rotary body 90. The portion including both the rotary body 90 and the trays 80y, 80m, 80c, and 80k can be referred to as a rotary unit 90U. In other words, the rotary unit 90U includes the rotary body 90 and the trays 80y, 80m, 80c, and 80k.

The cartridges 70y to 70k are detachably held in the trays 80y to 80k. As described below, the trays 80y to 80k are supported in a manner allowing them to slide to the outside of the rotary body 90. The portion including both the rotary unit 90U and the cartridges 70y, 70m, 70c, and 70k can be referred to as a rotary assembly 90A. In other words, the rotary assembly 90A includes the rotary unit 90U and the cartridges 70y, 70m, 70c, and 70k.

As described below, the rotary body 90 can rotate about the rotation axis (center of rotation) 90C. The rotation axis 90C is aligned with the rotation axis of the rotary frame body 90f, the rotary unit 90U, and the rotary assembly 90A. Also, the rotation axis 90C is essentially parallel with the rotation axis (center of rotation) of the photosensitive drum 2.

The rotary body 90 can be put in a developing posture where one of the developing rollers 51y, 51m, 51c, or 51k faces the photosensitive drum 2, by rotating about the rotation axis 90C. A posture where the developing roller 51y faces the photosensitive drum 2 is referred to as a yellow developing posture. A posture where the developing roller 51m faces the photosensitive drum 2 is referred to as a magenta developing posture. A posture where the developing posture 51c faces the photosensitive drum 2 is referred to as a cyan developing position. A posture where the developing roller 51k faces the photosensitive drum 2 is referred to as a black developing posture. In other words, the rotary body 90 can be rotated about the rotation axis 90C to change the position of the developing rollers 51y, 51m, 51c, and 51k with respect to the photosensitive drum 2.

As illustrated in FIG. 2, the apparatus body 1A includes motors M1, M2, and M3 as drive sources. As described below, the motor M1 supplies the driving force for rotating the rotary body 90 about the rotation axis 90C. In other words, the motor M1 rotates the rotary assembly 90A and the rotary unit 90U about the rotation axis 90C.

Also, the apparatus body 1A includes a driving device 98 including the motor M2 and a transmission device. The transmission device includes, as a drive gear described below, driving racks 15L and 15R and a transmission portion 15t. The driving force of the motor M2 is transmitted to the driving racks 15L and 15R via the transmission portion 15t. In other words, the motor M2 is configured to drive the driving racks 15L and 15R, and the trays 80y, 80m, 80c, and 80k are moved relative to the rotary body 90 via the driving racks 15L and 15R.

The motor M3 drives the members other than the members driven by the motor M1 and the motor M2. For example, the motor M3 drives photosensitive drum 2; the developing units 50y, 50m, 50c, and 50k; the pickup roller 310; the feed roller 311; the conveyance roller pair 320; the secondary transfer roller 12; the belt driving roller 10b; and the fixing device 40.

Note that the members driven by the motors M1, M2, and M3 can be changed as appropriate. Also, the function of any two or all three of the motors M1, M2, and M3 can be grouped into a single motor. Also, a drive source other than the motors M1, M2, and M3 may be added.

Here, the suffix y, m, c, k attached to the developing units 50y, 50m, 50c, and 50k; the cartridges 70y, 70m, 70c, and 70k; the trays 80y, 80m, 80c, and 80k; and the like indicate the toner color. The developing units 50y, 50m, 50c, and 50k all share the same basic configuration and function. The cartridges 70y, 70m, 70c, and 70k all share the same basic configuration and function. The trays 80y, 80m, 80c, and 80k all share the same basic configuration and function. Thus, in a case where there is no need to differentiate between them, the suffixes y, m, c, and k are omitted, and an element with the suffix omitted is described as being one of the four units, cartridges or trays.

As illustrated in FIG. 3, the cartridge 70 includes a toner frame body 71. The toner frame body 71 includes a toner containing portion 71a containing toner and a discharge opening 71b connected to the toner containing portion 71a.

The developing unit 50 includes a developing frame body (containing frame body) 53. The developing frame body 53 includes a developing side containing portion 53a and an receiving opening 53b connected to the developing side containing portion 53a (toner supply chamber). Note that as described above, the developing unit 50 includes the developing roller 51, the supplying roller 52, and the like. However, these members are omitted in FIG. 3.

As described below, the cartridge 70 can be moved between an installed position and a retracted position where the cartridge 70 is retracted away from the installed position, with respect to the developing frame body 53. In a state where the cartridge 70 is at the installed position with respect to the developing frame body 53, the discharge opening 71b faces the receiving opening 53b. In other words, the toner containing portion 71a of the cartridge 70 and the developing side containing portion 53a of the developing unit 50 are connected via the discharge opening 71b and the receiving opening 53b. When toner is supplied from the cartridge 70 to the developing unit 50, at least a portion of the receiving opening 53b is located below at least a portion of the discharge opening 71b.

Then, the toner contained in the toner containing portion 71a is discharged from the discharge opening 71b, and the toner discharged from the discharge opening 71b flows through the receiving opening 53b and is contained in the developing side containing portion 53a. The toner contained in the developing side containing portion 53a is supplied to the developing roller 51. The toner contained in the toner containing portion 71a is supplied to the developing roller 51 via this path.

The cartridge 70 may include a non-illustrated sealing member (first sealing member) covering the discharge opening 71b. Also, the developing unit 50 may include a non-illustrated sealing member (second sealing member) covering the receiving opening 53b. The cartridge 70 and the developing unit 50 may be configured so that, in a state where the cartridge 70 is not installed in the developing unit 50, the outflow of the toner from the discharge opening 71b and the receiving opening 53b is controlled by the sealing members covering the discharge opening 71b and the receiving opening 53b.

### Image Forming Operations

Image forming operations according to the present embodiment will now be described. First, the photosensitive drum 2 is rotated in the arrow direction of FIG. 1 (anticlockwise) in sync with the rotation of the intermediate transfer belt 10a. Then, the surface of the photosensitive drum 2 is uniformly charged by the charging roller 3.

In the case of forming a color image on the sheet S, as described below, the rotary body 90 rotates in the arrow direction of FIG. 1 (clockwise) while supporting the developing unit 50y, 50m, 50c, and 50k. Then, the electrophotographic process is repeated while moving the developing rollers 51y, 51m, 51c, and 51k to the developing position one at a time.

First, the scanner 4 emits a laser light based on the image data corresponding to a yellow image to form an electrostatic latent image corresponding to the yellow image on the surface of the photosensitive drum 2. In parallel with forming the electrostatic latent image, the motor M1 rotates the rotary body 90, putting the rotary body 90 in the yellow developing posture. When the rotary body 90 is in the yellow developing posture, the developing roller 51y is at the developing position, and the electrostatic latent image formed on the photosensitive drum 2 is developed using the yellow toner.

Here, in the present embodiment, each of the developing rollers 51y, 51m, 51c, and 51k is a flexible roller including a metal shaft covered with rubber. At the developing position, each of the developing rollers 51y, 51m, 51c, and 51k perform development of the electrostatic latent image while in contact with the photosensitive drum 2. In other words, the image forming apparatus 1 according to the present embodiment uses a contact developing system. However, at the developing position, each of the developing rollers 51y, 51m, 51c, and 51k may perform development of the electrostatic latent image with a gap between each of them and the photosensitive drum 2. In other words, the image forming apparatus 1 may use a non-contact developing system.

When the yellow toner image is developed, the yellow toner image on the photosensitive drum 2 is primary-transferred onto the intermediate transfer belt 10a via the primary transfer roller 11 disposed on the inner side of the intermediate transfer belt 10a.

Thereafter, the rotary body 90 is rotated, and the developing rollers 51m, 51c, and 51k are moved in order to the developing position to form the toner images of each color. In other words, after the yellow toner image is formed on the intermediate transfer belt 10a, the rotary body 90 is brought to be in the magenta developing posture, and a magenta toner image is formed on the intermediate transfer belt 10a. After the magenta toner image is formed on the intermediate transfer belt 10a, the rotary body 90 is brought to be in the cyan developing posture, and a cyan toner image is formed on the intermediate transfer belt 10a. After the cyan toner image is formed on the intermediate transfer belt 10a, the rotary body 90 is brought to be in the black developing posture, and a black toner image is formed on the intermediate transfer belt 10a.

By repeating the primary transfer to layer the toner images of the four colors on top of one another on the intermediate transfer belt 10a, a color image is formed on the intermediate transfer belt 10a. Note that up until the color image is formed on the intermediate transfer belt 10a, the secondary transfer roller 12 and the cleaning device 13 do not come into contact with the intermediate transfer belt 10a.

The sheets S are supplied via the pickup roller 310 from the sheet housing portion 300 provided at the lower portion of the apparatus body 1A. The sheets S are separated by the feed roller 311 and the separation roller 312 and sent one at a time to the conveyance roller pair 320. The conveyance roller pair 320 sends the supplied sheet S to a transfer region (secondary transfer region), which is a nip region between the intermediate transfer belt 10a and the secondary transfer roller 12. The color image on the intermediate transfer belt 10a is transferred (secondary transfer) onto the surface of the conveyed sheet S.

The sheet S with the transferred color image is sent to the fixing device 40. At the fixing device 40, the sheet S is heated and pressed to fix the image on the sheet S. The sheet S having passed through the fixing device 40 is discharged outside of the image forming apparatus 1 as a finished product.

On the other hand, in the case of forming a monochrome image on the sheet S, the rotary body 90 is put in the black developing posture. In this state, after an electrostatic latent image is formed on the surface of the photosensitive drum 2 via charging of the photosensitive drum 2 and exposure, the electrostatic latent image is developed using the black toner by the developing roller 51k located at the developing position. The black toner image is primary-transferred onto the intermediate transfer belt 10a and thereafter secondary-transferred onto the sheet S. The following processes are similar to those described in the color image example.

### Rotary Configuration

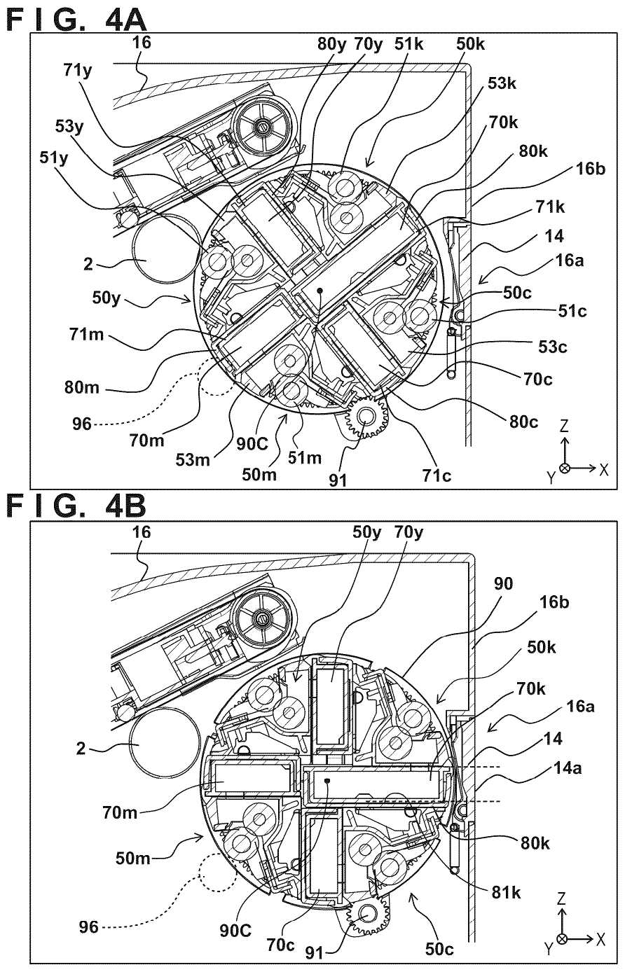

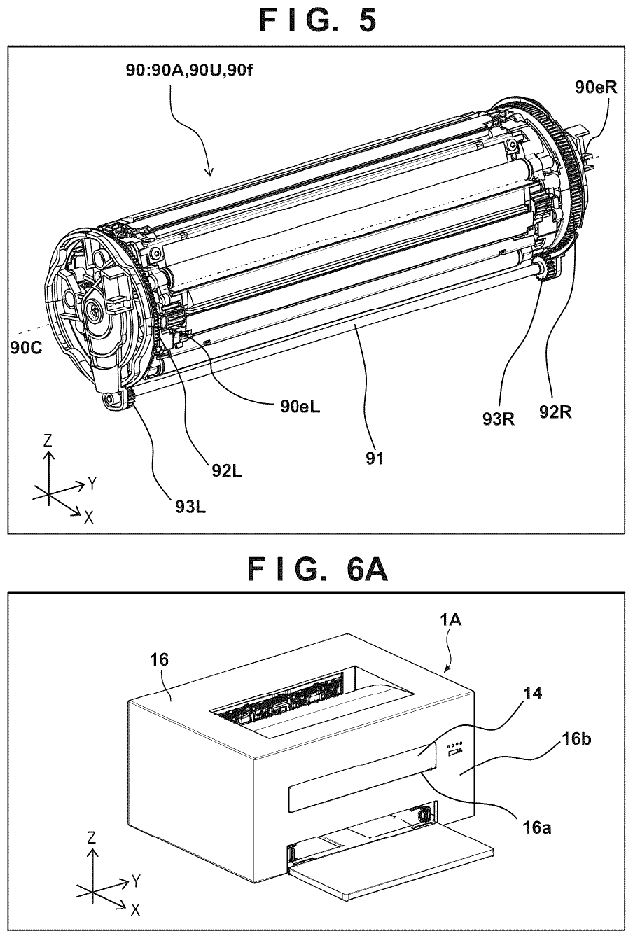

The configuration of the rotary body 90 will now be described using FIGS. 1, 4A, 4B, and 5. FIGS. 4A and 4B are cross-sectional views illustrating the rotary body 90 of the image forming apparatus 1 and the area therearound. Note that FIGS. 4A and 4B are cross-sectional views of the apparatus cut along an imaginary plane perpendicular to the rotation axis 90C of the rotary body 90. FIG. 5 is a perspective view of the rotary body 90.

As described above, the cartridges 70y to 70k are detachably attached to the rotary body 90. When the toner inside the cartridges 70y to 70k runs out, the user can resupply the image forming apparatus 1 with toner by replacing the cartridges 70y to 70k.

As illustrated in FIG. 1, the apparatus body 1A includes a frame body 16 that houses the rotary body 90. The frame body 16 is a frame for the body of the image forming apparatus 1 according to the present embodiment. The frame body 16 is a casing for the apparatus body 1A made of a frame and an outer sheath member and substantially has the shape of a rectangular parallelepiped in the present embodiment.

The frame body 16 includes an opening 16a. Specifically, the frame body 16 includes a side surface 16b that extends in a direction intersecting the horizontal direction. The side surface 16b forms at least a portion of the outward-facing surface on the +X side of the apparatus body 1A. The opening 16a is disposed in the side surface 16b. The side surface 16b is a side surface disposed downstream of the discharge opening in the discharge direction of the sheet S formed with an image being discharged from the discharge opening of the apparatus body 1A. From the side of the side surface 16b of the image forming apparatus 1, the user can replenish the sheets S by accessing the sheet housing portion 300 and can obtain the sheet S discharged from the discharge opening. Thus, the side surface 16b can be referred to as the front surface (front face) of the apparatus body 1A.

In the present embodiment, the cartridges 70y, 70m, 70c, and 70k are installed and removed from the rotary body 90 via the opening 16a while being supported by the trays 80y to 80k. In other words, the user can install and remove the cartridges 70y to 70k from the rotary body 90 via the trays 80y to 80k.

The opening 16a is disposed in the side surface 16b of the frame body 16 running substantially parallel with the rotation axis 90C of the rotary body 90. Thus, in the case of replacing the cartridge 70, the cartridge 70 passes through the opening 16a in a direction intersecting (preferably, orthogonal to) the rotation axis 90C.

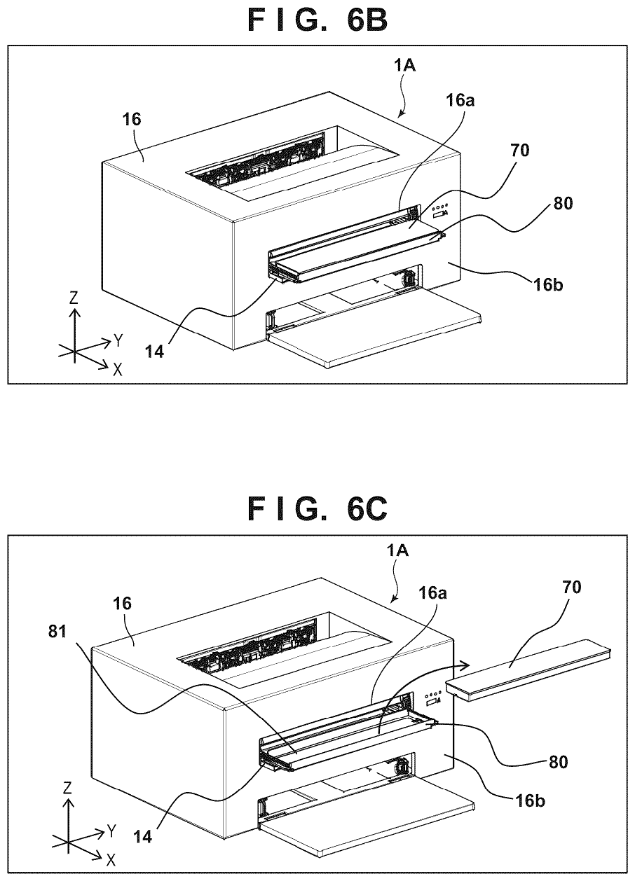

The image forming apparatus 1 includes a door 14 covering the opening 16a of the frame body 16. The door 14 is an opening and closing member that can be moved between a closed position (see also FIG. 6A) covering the opening 16a and an open position (see also FIGS. 6B and 6C) exposing the opening 16a.

As described above, in the present embodiment, the cartridge 70 is configured to be detachably installed in the rotary body 90 via the tray 80. Thus, the cartridge 70 can be stably installed and removed from the rotary body 90.

Specifically, the cartridge 70 can be replaced by the user by an operation of removing/installing the cartridge 70 from/on the tray 80 configured to be movable with respect to the rotary body 90 (that is, the apparatus body 1A). As a comparative example, in a case where a cartridge is replaced by the user directly inserting or removing the cartridge from the apparatus body, the user would need to insert the cartridge up to a predetermined installed position inside the apparatus body. In the present embodiment, the tray 80 can be moved, with the cartridge 70 supported thereon, so that the cartridge 70 is moved to the installed position. Thus, the user can replace the cartridge 70 with the simple operation of placing the cartridge 70 on the tray 80. This improves ease-of-use.

Note that the cartridge 70 has an elongated shape with the long side direction corresponding to the Y direction parallel with the rotation axis 90C of the rotary body 90. In other words, the dimensions of the cartridge 70 in the long side direction are greater than the height and the width in the cross section orthogonal to the long side direction. In this manner, the opening 16a is disposed at the side surface 16b of the frame body 16 running substantially parallel with the long side direction (Y direction) of the cartridge 70, allowing the cartridge 70 to pass through the opening 16a with the shortest movement distance when the elongated cartridge 70 is handled. For example, this makes replacing the cartridge 70 easy compared to a case where the cartridge 70 is inserted or removed via an opening in a side surface of one of the sides (+Y side or −Y side) of the frame body 16 in the long side direction of the cartridge 70.

The rotary body 90 can rotate about the rotation axis 90C and assume a replacement posture that allows any of the cartridges 70y to 70k to be removed from the rotary body 90. The posture that allows the cartridge 70y to be removed is referred to as a yellow replacement posture. The posture that allows the cartridge 70m to be removed is referred to as a magenta replacement posture. The posture that allows the cartridge 70c to be removed is referred to as a cyan replacement posture. The posture that allows the cartridge 70k to be removed is referred to as a black replacement posture.

FIG. 4A illustrates a cross section of the rotary body 90 in the developing posture state (specifically, the yellow developing posture). FIG. 4B illustrates a cross section of the rotary body 90 in the replacement posture (specifically, the black replacement posture).

As illustrated in FIGS. 4A and 4B, the four trays 80y to 80k are installed in the rotary body 90. Each tray 80y to 80k holds the respective cartridge 70y to 70k. In the state illustrated in FIGS. 4A and 4B, the trays 80y to 80k and the cartridges 70y to 70k are housed inside the rotary body 90. This state can be referred to as a state in which the cartridges 70y to 70k are installed in the developing units 50y, 50m, 50c, and 50k.

In a state where the cartridge 70 is at the installed position with respect to the developing frame body 53, the discharge opening 71b faces the receiving opening 53b as illustrated in FIG. 3. In this state, the cartridge 70 is configured to supply toner to the developing side containing portion 53a via the receiving opening 53b (containing frame body opening).

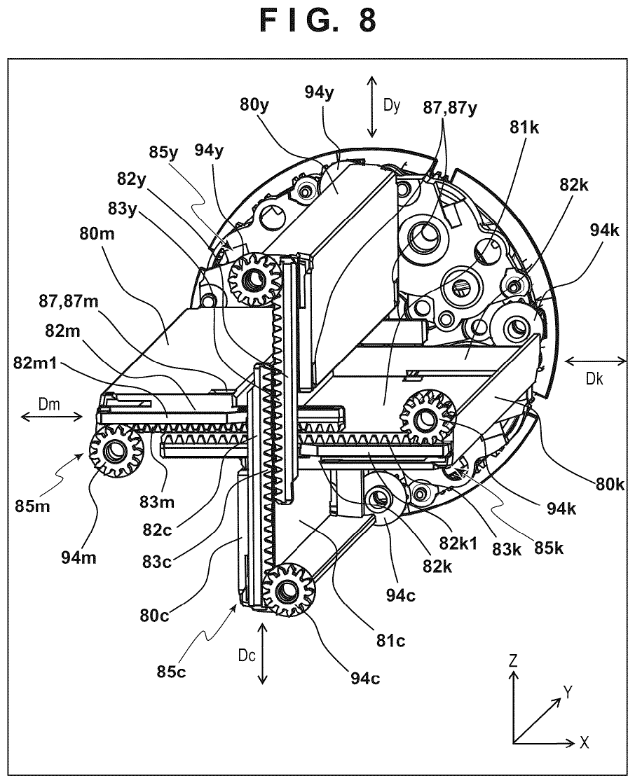

The apparatus body 1A includes a moving device 85 configured to move the cartridge 70 from the installed position to the retracted position with respect to the rotary body 90 (specifically, the developing frame body 53 of the developing unit 50). The moving device 85 will be described below using FIG. 8 and the like. In the present embodiment, the plurality of moving devicees 85y to 85k corresponding to the plurality of cartridges 70y to 70k are disposed in the rotary body 90. The trays 80y to 80k can be referred to as a part of the moving devicees 85y to 85k.

In the present embodiment, the cartridge 70k containing the black toner is larger in size than the cartridges 70y to 70c containing the yellow toner, the magenta toner, and the cyan toner and can contain a larger amount of toner.

Specifically, the length of the black cartridge 70k in a first radial direction with respect to the rotation axis 90C of the rotary body 90 is greater than the length of the magenta cartridge 70m in a second radial direction. Here, the first radial direction is the direction of the rotational radius of the rotary body 90 (radial direction of an imaginary circle centered on the rotation axis 90C) and the direction in which the cartridge 70k extends with respect to the rotation axis 90C as seen from the direction aligned with the rotation axis 90C. The second radial direction is the direction of the rotational radius of the rotary body 90 and the direction in which the cartridge 70m extends with respect to the rotation axis 90C as seen from the direction aligned with the rotation axis 90C. In a similar manner, the length of the black cartridge 70k in the first radial direction is greater than the length of the cartridges 70y and 70c in the radial direction corresponding to the other cartridges 70y and 70c.

Thus, the tray 80k holding the black cartridge 70k is larger in size than the trays 80y to 80c holding the other cartridges 70y, 70m, and 70c. In other words, the four cartridges 70y to 70k and trays 80y to 80k of different sizes are disposed in the rotary body 90.

Here, the rotational drive of the rotary body 90 will now be described using FIG. 5. As illustrated in FIG. 5, disk gears 92L and 92R are formed at either end portion of the rotary body 90. Also, rotary drive gears 93L and 93R are connected in a manner allowing for drive transmission at either end portion of a swing shaft 91. Here, the driving force of the motor M1 is transmitted to the rotary drive gear 93R via the drive transmission mechanism. Next, the rotary body 90 is rotationally driven by the driving force being transmitted to the disk gears 92L and 92R via the rotary drive gears 93L and 93R.

Also, the rotary body 90 is supported in a manner allowing it to swing about the swing shaft 91. The rotary body 90 is biased by a non-illustrated biasing member in the anticlockwise direction illustrated in FIGS. 4A and 4B centered on the swing shaft 91. This direction can be referred to as the direction in which the developing rollers 51y to 51k move toward the photosensitive drum 2. As a result, in a state in which the rotary body 90 is in the developing posture, each of the developing rollers 51y to 51k is in contact with the photosensitive drum 2.

As illustrated in FIG. 5, rotary cams 90eL and 90eR are provided on either end portion of the rotary body 90. When the rotary body 90 rotates in the clockwise direction as illustrated in FIGS. 4A and 4B about the rotation axis 90C, the rotary cams 90eL and 90eR come into contact with a roller 96 (FIGS. 4A and 4B) supported on the frame body 16. Then, it moves in the clockwise direction as illustrated in FIGS. 4A and 4B about the swing shaft 91. This direction can be referred to as the direction in which the developing rollers 51y to 51k move away from the photosensitive drum 2. Also, the direction can be referred to as the direction in which the rotary body 90 moves toward the opening 16a of the frame body 16 and the door 14.

In this manner, when the rotary body 90 rotates and switches from the developing posture to the replacement posture, the rotary body 90 swings about the swing shaft 91. In a state in which the rotary body 90 is in the replacement posture, the developing roller 51 is separated from the photosensitive drum 2.

As illustrated in FIG. 4B, in the black replacement posture, the cartridge 70k is stopped at a position facing the opening 16a provided in the side surface 16b of the apparatus body 1A and the door 14. From this state, when the tray 80k is slid from the installed position in the developing unit 50k to outside of the rotary body 90, the user can replace the cartridge 70k.

### Cartridge Replacement Operation

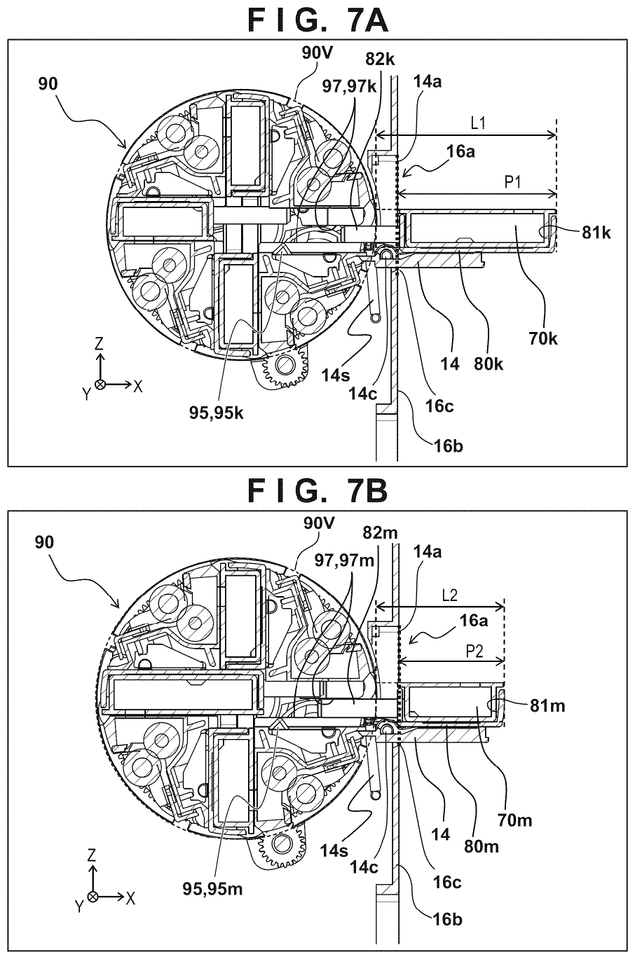

The cartridge replacement operation will now be described using FIGS. 4A, 6A to 6C, and 7A and 7B. FIGS. 6A to 6C are appearance views of the apparatus body 1A. FIGS. 7A and 7B are cross-sectional views of the rotary body 90 and the area therearound at the time of cartridge replacement. Note that FIGS. 7A and 7B are cross-sectional views of the apparatus along an imaginary plane perpendicular to the rotation axis 90C of the rotary body 90.

FIG. 6A illustrates the external appearance of the apparatus body 1A during an image forming operation and when in a standby state. During an image forming operation refers to being in an execution period of a sequence of operations of the image forming apparatus 1 from when the sheet S is supplied to after an image is formed on the sheet and the sheet S is discharged as a finished product. A standby state refers to a state in which the image forming operation can start if the image forming apparatus 1 receives an image forming instruction (printing instruction) and a state of waiting for an image forming instruction from the user. As illustrated in FIG. 6A, during an image forming operation and when in the standby state, the door 14 is in a closed state.

FIG. 6B illustrates the external appearance of the apparatus body 1A at the time of cartridge replacement. At the time of cartridge replacement, the door 14 is in an open state, and the tray 80 and the cartridge 70 are moved to the outside of the apparatus body 1A.

The cartridge 70 can be moved between the installed position and the retracted position away from the installed position with respect to the developing frame body 53 of the developing unit 50. In a state where the cartridge 70 is at the installed position with respect to the developing frame body 53, the discharge opening 71b faces the receiving opening 53b as illustrated in FIG. 3. As illustrated in FIGS. 4A and 4B, in a state with the cartridge 70 at the installed position, the rotary body 90 is configured to rotate about the rotation axis 90C and be put in the developing posture or the replacement posture.

Cartridge replacement will now be described. First, when the user issues to the image forming apparatus 1 an instruction to replace the cartridge 70, the rotary body 90 rotates and stops at the replacement posture of the cartridge 70 to be replaced. In other words, the image forming apparatus 1 rotates the rotary body 90 so that the cartridge 70 to be replaced is at the replacement posture. At the replacement posture, the tray 80 supporting the cartridge 70 to be replaced faces the opening 16a of the frame body 16 of the apparatus body 1A.

For example, the rotary body 90 of FIG. 4A is at the yellow developing posture where the yellow developing roller 51y faces the photosensitive drum 2. At this time, the black cartridge 70k and the tray 80k may not face the opening 16a and the door 14. It is sufficient that the opening 16a is large enough for each cartridge 70 to individually pass through. When the rotary body 90 is rotated a predetermined angle in the clockwise direction of the diagram from the yellow developing posture, as illustrated in FIG. 4B, the black cartridge 70k and the tray 80k face the opening 16a and the door 14.

Here, “the tray 80 facing the opening 16a” means that the tray 80 is at a position where it can be moved outside of the apparatus body 1A via the opening 16a. In other words, in a case where the tray 80 faces the opening 16a, with the movement mechanism described below, the tray 80 is moved outward in the direction of the rotational radius of the rotary body 90, allowing the tray 80 and the cartridge 70 supported by the tray 80 to project outside of the apparatus body 1A. In FIG. 4A, none of the trays 80y to 80k are facing the opening 16a. In FIG. 4B, only the black tray 80k is facing the opening 16a, and the other trays 80y to 80c are not facing the opening 16a.

When the rotary body 90 is positioned in the replacement posture, the tray 80 supporting the cartridge 70 to be replaced is moved toward the outside of the apparatus body 1A by the motor M2. Accordingly, the cartridge 70 to be replaced moves from the installed position to the retracted position with respect to the rotary body 90. Also, as illustrated in FIGS. 6A, 7A and 7B, the tray 80 and the cartridge 70 to be replaced supported by the tray 80 project outside of the apparatus body 1A through the opening 16a.

Specifically, the tray 80 can be moved from a stored position to a removal position with respect to the rotary body 90. The stored position is a position where the tray 80 is stored inside the rotary body 90. The removal position is a position (removable position, replaceable position) where the tray 80 projects outside of the rotary body 90 and the cartridge 70 can be removed from the tray 80. An example of the stored position is the position of the trays 80y to 80k in FIGS. 4A and 4B. An example of the removal position is the position of the tray 80 in FIGS. 6B and 6C, the tray 80k in FIG. 7A, and the tray 80m in FIG. 7B.

When the tray 80 is at the stored position, the cartridge 70 installed in the tray 80 is located at the installed position. When the tray 80 is at the removal position, the cartridge 70 installed in the tray 80 is located at the retracted position.

Here, as illustrated in FIGS. 7A and 7B, the rotary body 90 includes a protrusion portion 95 for holding the tray 80 in the stored position and holding the cartridge 70 in the installed position. As illustrated in FIG. 8, the tray 80 is provided with a recess portion 87 that engages with the protrusion portion 95. In FIGS. 7A and 7B, the protrusion portions 95k and 95m corresponding to the trays 80k and 80m are illustrated, and in FIG. 8, the recess portions 87y and 87m of the trays 80y and 80m are illustrated. However, the protrusion portions 95 and the recess portions 87 are provided for each trays 80y to 80k.

When the protrusion portion 95 engages with the recess portion 87 of the tray 80, the tray 80 is locked in the rotary frame body 90f. Accordingly, the tray 80 stays in the stored position even if the rotary body 90 rotates, and the cartridge 70 is prevented from moving from the installed position. Note that in a case where the tray 80 is moved by a movement apparatus described below between the stored position and the removal position, the tray 80 can move by moving over the protrusion portion 95.

In the present embodiment, the door 14 is rotatably supported on the apparatus body 1A. As illustrated in FIG. 7A, the door 14 is biased from an open position toward a closed position by a spring 14s. The spring 14s is a tension spring, for example, and biases the door 14 to cause a moment in the anticlockwise direction in FIG. 7A centered at a support shaft 14c of the door 14.

When the tray 80 pushes the door 14, the door 14 is put in an open state (the state of FIG. 6B). This state can also be referred to as a state in which the tray 80 is supported by the door 14. By at least a portion of the tray 80 projecting outside of the apparatus body 1A being supported by the door 14, the cartridge 70 can be more stably supported.

Note that the door 14 is configured to come into contact with a portion (for example, a lower edge 16c of the opening 16a) of the frame body 16 of the apparatus body 1A in the open position and to not turn downward further than the open position. When the tray 80 is put back inside the apparatus body 1A from the outside, the door 14 is returned to a closed position by the biasing force of the spring 14s.

The cartridge 70 is detachably held in the tray 80. Thus, as illustrated in FIG. 6C, the user can remove the cartridge 70 from the tray 80 and perform the task (replacement task) of installing a new cartridge 70. Note that in the case of replacing a plurality of the cartridges 70, the operations described above can be repeated to perform the replacement task.

FIGS. 7A and 7B are cross-sectional views of the rotary body 90 and the area therearound at the time of cartridge replacement. FIG. 7A illustrates the state at the time when the black cartridge 70k is replaced. FIG. 7B illustrates the state at the time when the magenta cartridge 70m is replaced.

The image forming apparatus 1 includes the moving device 85 (FIG. 8) that moves the cartridge 70 from the installed position to the retracted position. In the present embodiment, the moving device 85 can be said to include the tray 80.

Even when the cartridge 70 is in the retracted position, the tray 80 is in a state of being connected to the rotary body 90 (state of being supported by the rotary body 90). To facilitate the operation of removing the cartridge 70 from the rotary body 90, the cartridge 70 preferably projects as far out from the rotary body 90 as possible at the retracted position. Since the cartridge 70 is configured to be detachably installed in the rotary body 90 via the tray 80, even if the cartridge 70 projects far out from the rotary body 90, the cartridge 70 can be stably supported by the tray 80.

The movement direction of the cartridge 70 when the cartridge 70 moves from the installed position to the retracted position is referred to as the retraction direction. In the present embodiment, the retraction direction of the cartridge 70 is a direction intersecting the direction of the rotation axis 90C (Y direction). Thus, as illustrated in FIGS. 7A and 7B, when seen from the direction of the rotation axis 90C (Y direction), the retraction direction of the cartridge 70 is the direction orthogonal to the direction of the rotation axis 90C (Y direction). Also, the retraction direction of the cartridge 70 can be referred to as the outward direction in direction of the rotational radius of the rotary body 90 (direction away from the rotation axis 90C).

As illustrated in FIGS. 7A and 7B, for the user to perform the operation of removing the cartridge 70 from the rotary body 90, it is preferable that at least a portion of the cartridge 70 projects out from the rotary body 90 when removing the cartridge 70. In the present embodiment, when the cartridge 70 is at the retracted position, the entire cartridge 70 projects out from the rotary body 90.

When the rotary body 90 rotates about the rotation axis 90C, the rotation path of the rotary body 90 can be said to match the circumscribed circle (an imaginary circle 90V indicated by the dashed line in FIGS. 7A and 7B) of the rotary body 90 centered on the rotation axis 90C. When the cartridge 70 is at the retracted position, half or more of the length of the cartridge 70 in the retraction direction preferably is located outside of the rotation path of the rotary body 90. In other words, half or more of the entire length of the cartridge is preferably located outside of the rotation path of the rotary in the movement direction of the cartridge from the installed position to the retracted position when the cartridge is at the retracted position, as seen from the rotation axis direction of the rotary. Also, in the present embodiment, as illustrated in FIGS. 7A and 7B, when the cartridge 70 is at the retracted position, the entire cartridge 70 is located outside of the rotation path (the imaginary circle 90V) of the rotary body 90.

Also, to make it easy for the user to grip the cartridge 70, at least a portion of the cartridge 70 is preferably located outside of the image forming apparatus 1 (outside of the apparatus body 1A) when the cartridge 70 is at the retracted position. Here, “outside of the apparatus” refers to the space outside of the image forming apparatus 1 (outside of the apparatus body 1A) when the image forming apparatus 1 is used in an operation of forming an image on the sheet S, for example.

In the present embodiment, the outward-facing surface of the apparatus body 1A is formed by the outward-facing surface of the frame body 16. In other words, “outside of the apparatus” can refer to the outside of the frame body 16. Accordingly, a state in which at least a portion of the cartridge 70 is outside of the apparatus can refer to a state in which at least a portion of the cartridge 70 projects from the opening 16a of the frame body 16 of the apparatus body 1A toward the outside of the frame body 16.

In the present embodiment, when the door 14 is in the closed position, the opening 16a of the frame body 16 of the apparatus body 1A is covered by the door 14. Also, a portion of the outward-facing surface of the apparatus body 1A is formed by an outward-facing surface 14a of the door 14 in the closed position. In this case, “outside of the apparatus” refers to outward from the outward-facing surface 14a of the door 14 in the closed position. In other words, when the position of the outward-facing surface 14a of the door 14 in the closed position is an outward-facing position and the cartridge 70 is at the retracted position, at least a portion of the cartridge 70 is located outside of the apparatus body 1A outward from the outward-facing position.

In other words, at least a portion of the cartridge 70 is located in space outside of the apparatus body 1A even if the door 14 were to be put in the closed position. Also, at least a portion of the cartridge 70 is located on the downstream side of the outward-facing position in the retraction direction of the cartridge 70.

Also, with the side surface 16b provided with the opening 16a defined as the front surface of the apparatus body 1A, at least a portion of the cartridge 70 can project further to the front surface side than the outward-facing surface on the front surface side of the apparatus body 1A when the cartridge 70 is at the retracted position. In this case, the user can access the cartridge 70 from the front surface side of the image forming apparatus, make the task of replacing the cartridge 70 easier.

Note that when the cartridge 70 is at the retracted position, half or more of the length of the cartridge 70 in the retraction direction is preferably located outside of the apparatus. In other words, half or more of the entire length of the cartridge 70 is preferably located outside of the body frame in the movement direction of the cartridge 70 from the installed position to the retracted position when the cartridge 70 is at the retracted position, as seen from the rotation axis direction of the rotary. Also, when the cartridge 70 is at the retracted position, the entire cartridge 70 is more preferably located outside of the apparatus.

The tray 80 is provided with a cartridge holding portion 81 (see FIGS. 3 and 6C) that holds the cartridge 70. The cartridge holding portion 81 is an installation portion where the cartridge 70 is installed. When the tray 80 is at the removal position, the entire cartridge holding portion 81 is preferably located outside of the rotation path of the rotary body 90 in the retraction direction. When the tray 80 is at the removal position, half or more of the length of the cartridge holding portion 81 is preferably located outside of the apparatus in the retraction direction.

Here, as described above, the cartridge 70k and the tray 80k is larger in size than the other cartridges 70y to 70c and the trays 80y to 80c. Thus, as illustrated in FIGS. 7A and 7B, in the present embodiment, the movement amount of the tray 80 when replacing the cartridge changes to match the size of the cartridge 70.

Specifically, as illustrated in FIG. 7A, the movement distance when the tray 80k moves from the stored position to the removal position is L1. The movement distance when the tray 80m moves from the stored position to the removal position is L2. FIG. 7B illustrates a state in which the cartridge 70m and the tray 80m have been moved. However, the movement distance when the trays 80y and 80c move from the stored position to the removal position is also L2. At this time, L1 is greater than L2.

Also, as illustrated in FIG. 7A, in a state in which the tray 80k is at the removal position and the cartridge 70k is at the retracted position, the cartridge 70k projects outside of the apparatus by a distance P1 from the outward-facing surface of the apparatus body 1A. In the present embodiment, the tray 80k also projects outside of the apparatus by the distance P1 from the outward-facing surface of the apparatus body 1A.

Also, as illustrated in FIG. 7B, in a state in which the tray 80m is at the removal position and the cartridge 70m is at the retracted position, the cartridge 70m projects outside of the apparatus by a distance P2 from the outward-facing surface of the apparatus body 1A. In the present embodiment, the tray 80m also projects outside of the apparatus by the distance P2 from the outward-facing surface of the apparatus body 1A. Note that the cartridges 70y and 70c also project outside of the apparatus by the distance P2 from the outward-facing surface of the apparatus body 1A. The distance P1 is greater than the distance P2.

Regarding the cartridges 70y to 70c that are smaller in size compared to the cartridge 70k, in terms of strength, it is preferable that the distance P2 that they project outside of the apparatus at the retracted position is less than the distance P1 that the cartridge 70k projects outside of the apparatus at the retracted position. The reason is as follows. When the cartridge 70 is located at the retracted position, at least a portion of the cartridge 70 projects outside of the rotation path of the rotary body 90 or outside of the apparatus from the outward-facing surface of the apparatus body 1A. At this time, the tray 80 supports the weight of the cartridge 70 supported by the rotary body 90 in a cantilevered state. Thus, making the distance P2 of the cartridges 70y to 70c projecting outside of the apparatus at the retracted position shorter can reduce the load applied to the trays 80y to 80c and a guide portion 97 of the rotary body 90 supporting the trays 80y to 80k. Also, since the cartridges 70y to 70c are smaller in size compared to the cartridge 70k, even if the distance P2 is less than the distance P1, the ease of the task of replacing the cartridge from the trays 80y to 80c can be maintained.

### Tray Arrangement Inside Rotary

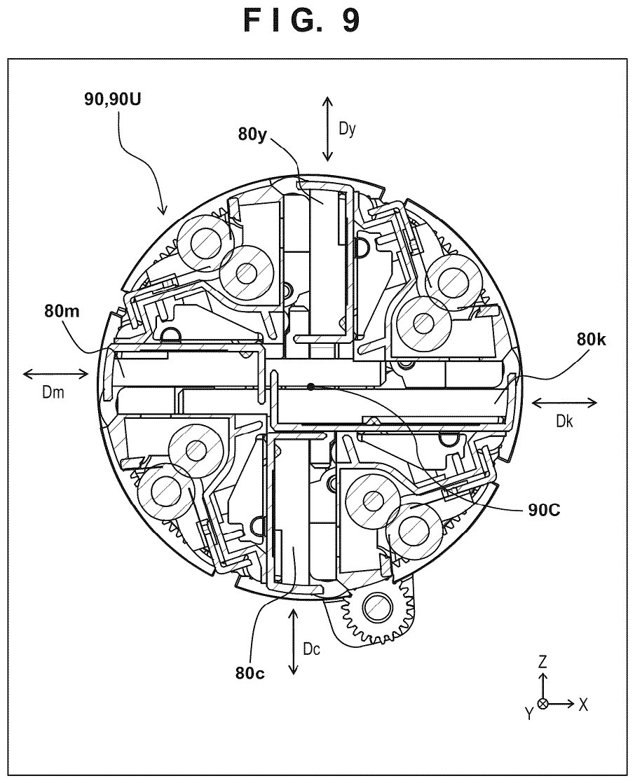

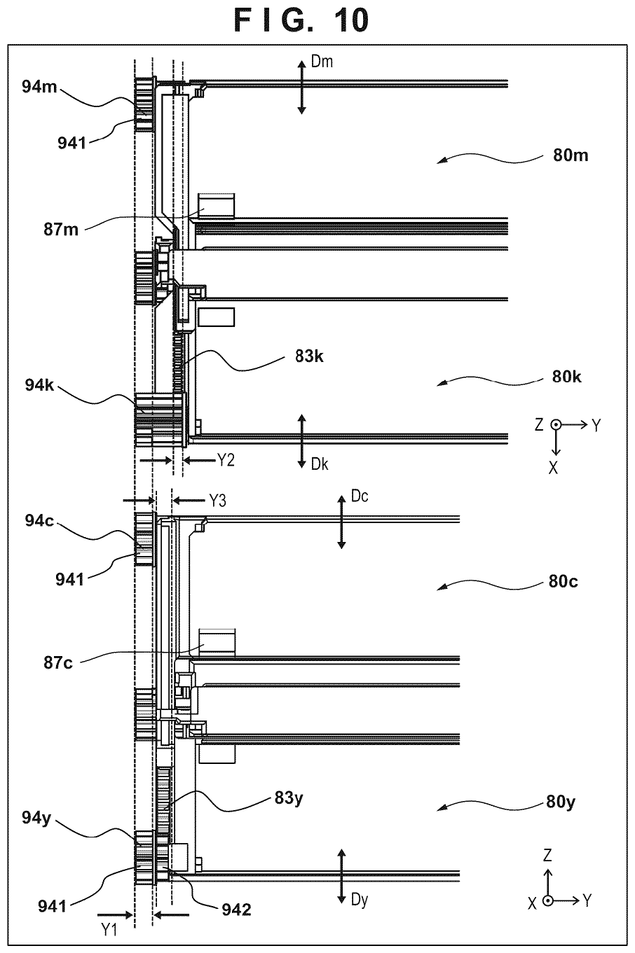

The arrangement of the trays 80y to 80k inside the rotary body 90 will now be described with reference to FIGS. 8, 9, and 10. FIG. 8 is a perspective view illustrating the arrangement of the trays 80y to 80k inside the rotary body 90. FIG. 9 is a cross-sectional view illustrating the arrangement of the trays 80y to 80k inside the rotary body 90. FIG. 10 is a diagram illustrating the arrangement of members at one end side in the Y direction of the trays 80y to 80k. Note that FIG. 9 illustrates a cross section of the rotary body 90 along an imaginary plane perpendicular to the rotation axis 90C of the rotary body 90. Also, the upper half portion of FIG. 10 illustrates the rotary body 90 and the trays 80m and 80k of FIG. 8 as seen from the upper right side (+Z direction) of FIG. 8, and the lower half portion of FIG. 10 illustrates the rotary body 90 and the trays 80c and 80y of FIG. 8 as seen from the left side (−X direction) of FIG. 8.

As illustrated in FIG. 8, each tray 80y to 80k is provided with the cartridge holding portion 81y to 81k and a guided portion 82y to 82k.

The cartridges 70y to 70k are installed in the cartridge holding portions 81y to 81k. Each cartridge holding portion 81y to 81k holds at least a portion of the installed cartridge 70y to 70k.

The guided portion 82y to 82k is provided at each end portion of the tray 80y to 80k on either side of the cartridge holding portion 81y to 81k in the Y direction. The guided portions 82y to 82k are members with an elongated shape in a direction orthogonal to the rotation axis of the rotary body 90.

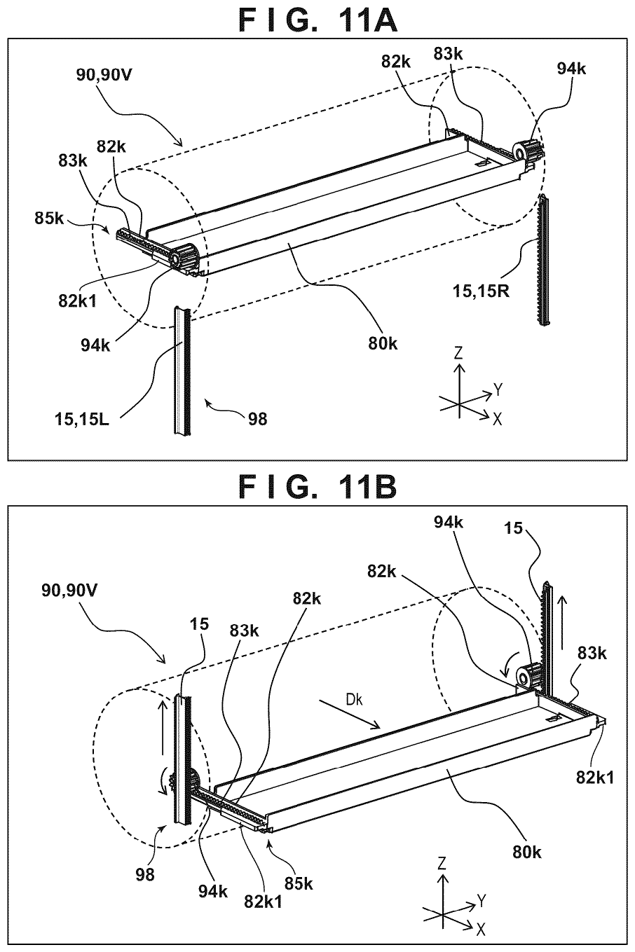

In the present embodiment, a reinforcement rib 82k1 is formed in a portion of the guided portion 82k in a movement direction Dy of the tray 80k, and a reinforcement rib 82m1 is formed in a portion of the guided portion 82 m in a movement direction Dm of the tray 80m (see FIGS. 11A and 11B). The reinforcement ribs 82k1 and 82m1 project outward in the Y direction from the guided portions 82k and 82m provided on both ends of the trays 80k and 80m in the Y direction and have an elongated rib-like shape (ridge) in the movement directions Dy and Dm of the trays 80k and 80m. The rigidity of the guided portions 82k and 82m is improved by the reinforcement ribs 82k 1 and 82m1.

Note that the length of the reinforcement ribs 82m1 and 82k1 is restricted so to avoid the guided portions 82y and 82c, but in a case where there is no interference with the guided portions 82y and 82c, the reinforcement ribs 82m1 and 82k 1 may be provided along the entire length of the guided portions 82m and 82k. Reinforcement ribs may be added to the guided portions 82y and 82c. Also, in a case where the rigidity of the guided portions 82m and 82k is sufficient, the reinforcement ribs 82m1 and 82k1 may not be provided.

A rack portion 83y to 83k (rack gear) is formed in the guided portion 82y to 82k. Also, a pinion gear 94y to 94k is rotatably supported inside the rotary body 90. The pinion gear 94y to 94k meshes with the rack portion 83y to 83k in a manner allowing drive transmission.

The rack portion 83y to 83k and the pinion gear 94y to 94k are a portion of the moving device 85y to 85k configured to move the cartridge 70y to 70k from the installed position to the retracted position. Also, the rack portion 83y to 83k and the pinion gear 94y to 94k can be referred to as a portion of a driven apparatus driven by the driving device 98 of the apparatus body 1A. The pinion gear 94y to 94k can be referred to as a rotary body (rotating member) that rotates to move the tray 80y to 80k with respect to the rotary body 90.

The pinion gear 94y to 94k and the rack portion 83y to 83k function as a driven unit for the moving device 85y to 85k of the rotary body 90 to receive the driving force from the driving device 98 of the apparatus body 1A.

The rotary body 90 includes the guide portion 97 (see FIGS. 7A and 7B) that engages with the guided portions 82y to 82k. FIG. 7A illustrates the guide portion 97 (97k) that engages with the guided portion 82k of the tray 80k, and FIG. 7B illustrates the guide portion 97 (97m) that engages with the guided portion 82m of the tray 80m. The rotary body 90 is provided with a similar guide portion that engages with the guided portions 82y and 82c of the trays 80y and 80c. Also, FIGS. 7A and 7B illustrate the guide portions 97 provided on one side (+Y direction) of the rotary body 90 in the Y direction, but similar guide portions 97 are provided on the other side (−Y direction) of the rotary body 90 in the Y direction.

When the tray 80 is moved between the stored position and the removal position, for at least a portion of the movement range, the guide portion 97 guides the movement direction of the tray 80 while maintaining an engaged state with the guided portion 82. In the present embodiment, for the entire movement range between the stored position and the removal position of the tray 80k, the guide portion 97 maintains an engaged state with the guided portion 82k. Also, in the present embodiment, for the entire movement range between the stored position and the removal position of the tray 80m, the guide portion 97 maintains an engaged state with the guided portion 82m.

As illustrated in FIGS. 8 and 9, the four trays 80y to 80k are arranged overlapping one another inside the rotary body 90 as will be described in detail below.

When the pinion gear 94y to 94k rotates, the rack portion 83y to 83k and the tray 80y to 80k move with respect to the rotary body 90. As illustrated in FIG. 9, the four trays 80y to 80k are arranged with the movement directions being directions rotated 90 degrees with respect to the rotary body 90. Thus, the tray 80y and the tray 80c, the tray 80m and the tray 80k are respectively held in a manner allowing for sliding movement in substantially the same direction (parallel direction). The movement direction when each tray 80y to 80k slides in this manner is restricted by the engagement between the guided portions 82y to 82k and the guide portions 97 described above.

Note that the trays 80y to 80k move outside of the apparatus via the opening 16a. When each tray 80y to 80k moves outside of the apparatus from the opening 16a, the movement direction of each tray is substantially the same direction (parallel).

As illustrated in FIG. 9, in a movement direction Dk of the tray 80k, the range in which the tray 80k is disposed overlaps with the range in which the tray 80y is disposed and the range in which the tray 80c is disposed. Also, in the movement direction Dk of the tray 80k, the range in which the tray 80k is disposed overlaps the rotation axis 90C of the rotary body 90. In other words, the cartridge 70k supported in the cartridge holding portion 81k of the tray 80k can be said to overlap (FIG. 4B) the rotation axis 90C of the rotary body 90.

Also, in the movement direction Dm of the tray 80m, the range in which the tray 80m is disposed is offset to not overlap with the range in which the tray 80y is disposed and the range in which the tray 80c is disposed. Also, in the movement direction Dy of the tray 80y, the range in which the tray 80y is disposed is offset to not overlap with the range in which the tray 80m is disposed and the range in which the tray 80k is disposed. In a similar manner, in a movement direction Dc of the tray 80c, the range in which the tray 80c is disposed is offset to not overlap with the range in which the tray 80m is disposed and the range in which the tray 80k is disposed.

The positional relationship between the trays 80 can be represented as follows. As seen from the movement direction Dy of the tray 80y, the tray 80y and the tray 80k overlap, but the tray 80y and the tray 80m do not overlap. As seen from the movement direction Dm of the tray 80m, the tray 80m and the tray 80k overlap, but the tray 80m and the trays 80y and 80c do not overlap. As seen from the movement direction Dc of the tray 80c, the tray 80c and the tray 80k overlap, but the tray 80c and the tray 80m do not overlap.

Here, two elements (members, components, units, and the like) overlapping as seen from a specific direction means that the projection region of one element and the projection region of the other element at least partially overlap in a case where the elements are perpendicularly projected on an imaginary plane perpendicular to this direction.

As illustrated in FIGS. 8 and 10, in the direction of the rotation axis 90C (Y direction), the range in which the rack portion 83m and the guided portion 82m are disposed and the range in which the rack portion 83k and the guided portion 82k are disposed at least partially overlap. Thus, compared to an arrangement in which the rack portion 83m and the guided portion 82m do not overlap with the rack portion 83k and the guided portion 82k, in the Y direction, the rack portions 83m and 83k and the guided portions 82m and 82k can be arranged while saving space.

In the direction of the rotation axis 90C (Y direction), the range in which the rack portion 83y and the guided portion 82y are disposed and the range in which the rack portion 83c and the guided portion 82c are disposed at least partially overlap. Thus, compared to an arrangement in which the rack portion 83y and the guided portion 82y do not overlap with the rack portion 83c and the guided portion 82c, in the Y direction, the rack portions 83y and 83c and the guided portions 82y and 82c can be arranged while saving space.

The meshing position of the rack portion 83 and the pinion gear 94k will now be described using FIG. 10. The upper half portion of FIG. 10 illustrates the meshing position of the rack portion 83k and the pinion gear 94k. The lower half portion of FIG. 10 illustrates the meshing position of the rack portion 83y and the pinion gear 94y.

In the direction of the rotation axis 90C of the rotary body 90 (Y direction), in a region Y1 in the diagram, the driving force transmitted from the motor M2 (FIG. 2) functioning as a drive source to the transmission device described below is transmitted to the pinion gears 94y to 94k. In a region Y2 in the diagram in the Y direction, the pinion gear 94k meshes with the rack portion 83k in a manner allowing for drive transmission. In a region Y3 in the diagram in the Y direction, the pinion gear 94y meshes with the rack portion 83y in a manner allowing for drive transmission. Note that the rack portion 83m meshes with the pinion gear 94m (FIG. 8) in a manner allowing for drive transmission in the same region Y2 as the rack portion 83k. The rack portion 83c meshes with the pinion gear 94c (FIG. 8) in a manner allowing for drive transmission in the same region Y3 as the rack portion 83y.

Here, the region Y2 and the region Y3 are located at different positions in the Y direction (offset in the Y direction). Also, the region Y1 is located at a different position in the Y direction to the region Y2 and the region Y3. In other words, the region Y1 is offset from the region Y2 and the region Y3 in the Y direction.

Also, the range in which the rack portion 83y is disposed and the range in which the rack portion 83c is disposed at least partially overlap in the movement direction of the rack portion 83y (movement direction Dy of the tray 80y) when the cartridges 70y and 70c are at the installed position. In the present embodiment, since the movement directions Dy and Dc of the trays 80y and 80c are substantially the same direction (parallel), in the movement direction Dc of the tray 80c, the range in which the rack portion 83y is disposed and the range in which the rack portion 83c is disposed at least partially overlap. Thus, the teeth surface of the rack portion 83y and the teeth surface of the rack portion 83c face one another in a direction (left-and-right direction of FIG. 8) orthogonal to the movement directions Dy and Dc of the rack portions 83y and 83c when the cartridges 70y and 70c are at the installed position.

Also, the range in which the rack portion 83m is disposed and the range in which the rack portion 83k is disposed at least partially overlap in the movement direction of the rack portion 83m (movement direction Dm of the tray 80m) when the cartridges 70m and 70k are at the installed position. In the present embodiment, since the movement directions Dm and Dk of the trays 80m and 80k are substantially the same direction (parallel), in the movement direction Dk of the tray 80k, the range in which the rack portion 83m is disposed and the range in which the rack portion 83k is disposed at least partially overlap. Thus, the teeth surface of the rack portion 83m and the teeth surface of the rack portion 83k face one another in a direction (up-and-down direction of FIG. 8) orthogonal to the movement directions Dm and Dk of the rack portions 83m and 83k when the cartridges 70m and 70k are at the installed position.

Also, the rack portion 83y overlaps the rack portion 83m and the rack portion 83k as seen in the direction of the rotation axis 90C (Y direction). The rack portion 83m overlaps the rack portion 83y and the rack portion 83c when seen in the direction of the rotation axis 90C (Y direction). The rack portion 83c overlaps the rack portion 83m and the rack portion 83k when seen in the direction of the rotation axis 90C (Y direction). The rack portion 83k overlaps the rack portion 83y and the rack portion 83c when seen in the direction of the rotation axis 90C (Y direction). In other words, the range in which the rack portion 83k is disposed and the range in which the rack portion 83y is disposed do not overlap in the rotation axis direction of the rotary (Y direction). Also, the rack portion 83k and the rack portion 83y overlap as seen in the rotation axis direction of the rotary (Y direction) when the cartridge 70k is at the installed position and the cartridge 70y is at the installed position.

In this manner, since the positions where the rack portions 83k and 83m are disposed is different from the positions where the rack portions 83y and 83c are disposed in the Y direction, the rack portions 83y and 83c and the rack portions 83m and 83k can be disposed overlapping as seen in the Y direction.

Accordingly, space saving can be achieved when arranging the four trays inside the rotary body 90, and the rotary body 90 can be made a smaller size in the direction of the rotational radius. In other words, by arranging the rack portions 83 to not overlap as seen in the Y direction while making the movement distances of the trays 80y to 80k equal to that of the present embodiment, the area required to arrange the four rack portions is increased as seen in the Y direction. Compared to such a configuration, by offsetting the position in the Y direction of the plurality of rack portions 83 and overlapping the rack portions 83 in the Y direction, the arrangement area of the rack portions 83 can be reduced as seen in the Y direction.

Also, in the present embodiment, the four rack portions 83y to 83k are formed into pairs of two and arranged at offset positions in the Y direction. In other words, in the rotation axis direction of the rotary (Y direction), the ranges in which the rack portion 83k and the rack portion 83m are disposed overlap, and the ranges in which the rack portion 83y and the rack portion 83c are disposed overlap. Also, in the Y direction, the range in which the rack portion 83k and the rack portion 83m are disposed and the range in which the rack portion 83y and the rack portion 83c are disposed do not overlap. Accordingly, compared to a configuration in which the four rack portions 83y to 83k have positions offset in the Y direction, the size of the rotary body 90 in the Y direction can be reduced.

### Tray Movement Configuration

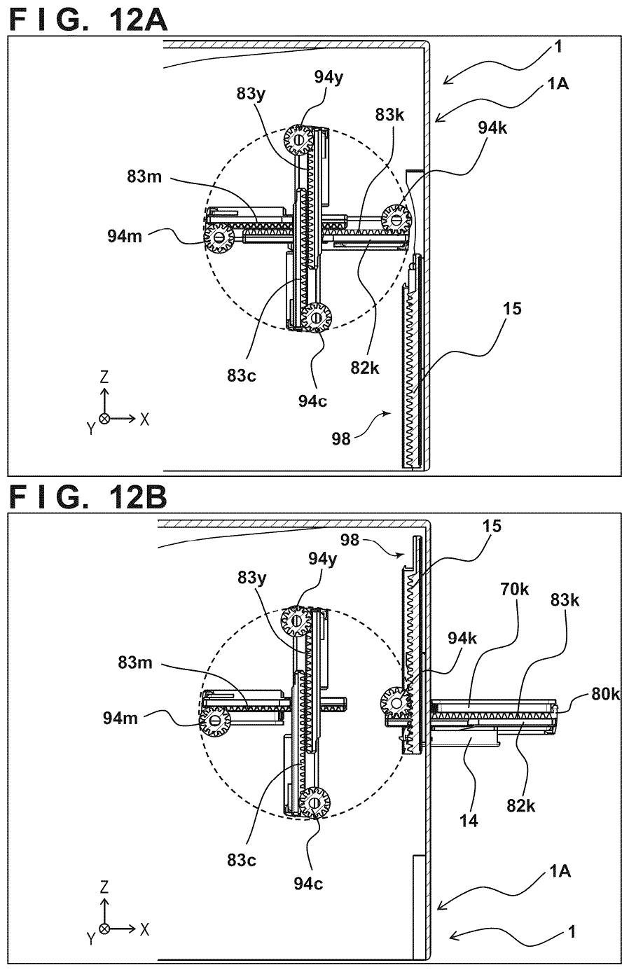

A configuration relating to the movement of the trays 80y to 80k disposed inside the rotary body 90 will now be described using FIGS. 11A, 11B, 12A, and 12B. FIGS. 11A and 11B are perspective views illustrating a configuration relating to the movement of the tray 80k. FIGS. 12A and 12B are cross-sectional views illustrating a configuration relating to the movement of the tray 80k.

In the present embodiment, the trays 80y to 80k are each driven by the driving force of the motor M2 being transmitted to the pinion gears 94y to 94k via the driving racks 15L and 15R functioning as a transmission device. Here, a configuration in which the tray 80k moves with respect to the rotary body 90 will be described, but the configuration for moving the trays 80y to 80c with respect to the rotary body 90 are substantially similar to the configuration for moving the tray 80k and thus will not be described.

FIG. 11A illustrates a state in which the tray 80k is located inside the rotary body 90 (in other words, a state in which the cartridge 70k is installed in the developing unit 50k). In other words, FIG. 11A illustrates a state in which the tray 80k is at the stored position, which corresponds to a state in which the cartridge 70k is at the installed position with respect to the developing frame body 53k (FIG. 4A). FIG. 11B illustrates a state in which the tray 80k has moved by sliding outside of the rotary body 90. In other words, FIG. 11B illustrates a state in which the tray 80k is at the removal position, which corresponds to a state in which the cartridge 70k is at the retracted position with respect to the developing frame body 53k (FIG. 4B).

The apparatus body 1A according to the present embodiment includes the driving racks 15L and 15R functioning as the drive gears that drive the pinion gears 94. Each driving rack 15 is driven by the motor M2 via a non-illustrated drive transmission mechanism.

As described above, the two rack portions 83k are formed at both end portions of the tray 80k in the Y direction. The pinion gears 94k and the driving racks 15L and 15R are disposed in sets of two at positions corresponding to the rack portion 83k at both end portions. In a case where there is no need to distinguish between the driving racks 15L and 15R, the driving racks 15L and 15R are referred to collectively as the “driving rack 15”.

In other words, the rack portion 83 according to the present embodiment is configured as a rack gear pair, and the pinion gear 94 according to the present embodiment is configured as a pinion gear pair. The rack gear pair and the pinion gear pair are disposed at a first and second end side of the support member (tray 80) in the Y direction in the present embodiment, but may be disposed at different positions.

One of the rack gear pair meshes with one of the pinion gear pair, and the other of the rack gear pair meshes with the other of the pinion gear pair. At least one of the pinion gear pair is driven by the driving rack 15L. In the present embodiment, both of the pinion gear pair are simultaneously driven by the driving racks 15L and 15R. Accordingly, the tray 80 is made less likely to rotate and the cartridge 70 can be stably moved.

Note that the driving force may be input to only one of the pinion gear pair using only the driving rack 15L. In this case, for example, the pinion gear pair may be connected via a shaft or the like, and the driving force from the driving rack 15L may be transmitted from the one of the pinion gear pair that receives the driving force from the driving rack 15L to the other of the pinion gear pair. This configuration can reduce the size of the apparatus and simplify the apparatus due to omitting the driving rack 15R and a configuration for moving the driving rack 15R.

The tray 80k is supported in a manner allowing for sliding movement in a direction parallel with the guided portion 82k (in other words, the movement direction Dk) with respect to the rotary body 90. The driving rack 15 is supported in a manner allowing for sliding movement in a direction intersecting the movement direction Dk of the tray 80k with respect to the apparatus body 1A. The driving rack 15 is configured to slide (move back and forth) with respect to the apparatus body 1A. The movement direction of the driving rack 15 according to the present embodiment is a direction orthogonal to both the movement direction Dk of the tray 80k and the direction of the rotation axis 90C of the rotary body 90 (Y direction).

The tray inserting or removing operation for sliding the tray 80k between the stored position and the removal position will now be described using FIGS. 11A and 11B. The tray inserting or removing operation of the tray 80k is performed via the motor M2 (FIG. 2), a non-illustrated drive transmission mechanism, the driving rack 15, the pinion gear 94k, and the rack portion 83k.

First, the tray inserting or removing operation when removing the cartridge 70k from the rotary body 90 (tray removing operation) will be described. In a state before the tray removing operation has started, the driving rack 15 is located below the position where it meshes with the pinion gear 94k (FIG. 11A). Also, as described above, in the cartridge 70k replacement operation, the rotary body 90 is in the replacement posture (FIG. 4B) for the cartridge 70k.

When the tray removing operation starts, the driving rack 15 slides in the upward direction of the apparatus body 1A via the driving force of the motor M2. As the driving rack 15 moves, the driving rack 15 meshes with the pinion gear 94k, and the pinion gear 94k is rotationally driven.

As illustrated in FIG. 11B, by rotationally driving the pinion gear 94k in the arrow direction in the diagram, the driving force is input to the rack portion 83k meshed with the pinion gear 94k. In this manner, the tray 80k is pushed to the outside of the apparatus and moves from the stored position to the removal position with respect to the rotary body 90. The movement direction of the tray 80k at this time is guided to align with the predetermined movement direction Dk by the engagement between the guided portion 82k and the guide portion 97k (FIG. 7A) of the rotary body 90. As a result of the tray 80k being moved from the stored position to the removal position, the cartridge 70k is moved from the installed position to the retracted position with respect to the developing unit 50k.

In a state in which the tray 80k is located at the removal position and the cartridge 70k is located at the retracted position, the user can install or remove the cartridge 70k from the tray 80k.

The tray inserting or removing operation when installing the cartridge 70 in the rotary body 90 (tray inserting operation) is performed via reversing the process of the tray removing operation. In a state before the tray inserting operation has started, the driving rack 15 is located above the position where it meshes with the pinion gear 94k. When the operation starts, the driving rack 15 slides in the downward direction of the apparatus body 1A via the driving force of the motor M2. Here, the rotation direction of the motor M2 in the tray inserting operation is the opposite direction as in the tray removing operation. As the driving rack 15 moves, the driving rack 15 meshes with the pinion gear 94, and the pinion gear 94k is rotationally driven.

By rotationally driving the pinion gear 94k in the opposite direction to the arrow in FIG. 11B, the driving force is input to the rack portion 83k meshed with the pinion gear 94k. In this manner, the tray 80k is inserted inside the apparatus and moves from the removal position to the stored position with respect to the rotary body 90. The movement direction of the tray 80k is guided to align with the movement direction Dk (opposite direction to the arrow in FIG. 11B) by the engagement between the guided portion 82k and the guide portion 97k (FIG. 7A) of the rotary body 90. As a result of the tray 80k being moved from the removal position to the stored position, the cartridge 70k is moved from the retracted position to the installed position with respect to the developing unit 50k.

Here, the movement of the black tray 80k and cartridge 70k has been described. However, the movement of the other trays 80y to 80c and cartridges 70y to 70c is performed via a similar mechanism. In other words, the driving racks 15 transmit drive to the pinion gears 94y to 94c in the replacement positions for the respective cartridges.

The driving device 98 for driving the moving device 85 provided in the rotary body 90 is configured by the motor M2 provided in the apparatus body 1A and the transmission device including the driving racks 15 and the drive transmission mechanism.

As described above, in the present embodiment, the plurality of moving devicees 85y to 85k corresponding to the plurality of cartridges 70y to 70k are disposed in the rotary body 90. The driving device 98 of the apparatus body 1A is a common driving device that drives the plurality of moving devicees 85k to 85y of the rotary body 90.

Also, in the present embodiment, the drive target of the driving device 98 switches via the rotation of the rotary body 90. In other words, the driving device according to the present embodiment includes the driving racks 15 functioning as transmission members that transmit the driving force of the drive source. The driving device can assume a state in which the transmission member engages with the pinion gear 94k in a manner allowing for drive transmission and a state in which the transmission member engages with the pinion gear 94m in a manner allowing for drive transmission. Also, the driving device can assume a state in which the driving device is separated from the pinion gear 94k and the pinion gear 94m.

As described above, the pinion gears 94y to 94k are supported by the rotary body 90. Thus, when the rotary body 90 rotates, preferably, the meshing between the pinion gears 94y to 94k and the driving racks 15 is released.

FIG. 12A illustrates a state (stored position state) in which the tray 80k is located inside the rotary body 90. FIG. 12B illustrates a state (removal position state) in which the tray 80k is moved outside of the rotary body 90.

As illustrated in FIG. 12A, when the tray 80k is located inside the rotary body 90, the driving rack 15 is located at a lower portion inside the apparatus body 1A. At this time, the driving rack 15 is retracted from the pinion gear 94k. Thus, the rotary body 90 can be rotated without hindering the driving rack 15. Specifically, the driving rack 15 can be retracted outside of the rotation path of the rotary body 90 indicated by a broken line in FIGS. 12A and 12B.

As described above, by rotationally driving the motor M2 in the forward and reverse direction, the tray 80 installed in the rotary body 90 can be moved from the stored position to the removal position and from the removal position to the stored position with respect to the rotary body 90. In other words, the driving device according to the present embodiment can not only drive each movement apparatus of the rotary to move the cartridge from the installed position to the retracted position but also can drive each movement apparatus to move the cartridge from the retracted position to the installed position.

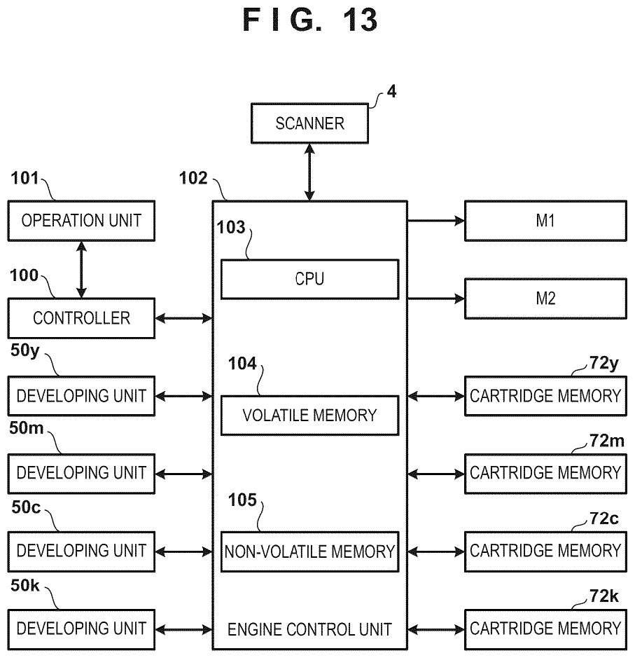

Next, the operation of the image forming apparatus 1 when a replacement instruction has been issued for the cartridge 70 will be described. FIG. 13 illustrates a control configuration of the image forming apparatus 1. A controller 100 controls the entire image forming apparatus 1. For example, the controller 100 is configured to communicate with a non-illustrated host computer via a network. The host computer may be any information processing apparatus with a communication function such as a personal computer, a tablet, a smartphone, and the like. When the controller 100 receives a print job from the host computer, the controller 100 transmits the image data of the image to be printed to an engine control unit 102 and causes the engine control unit 102 to perform image formation.

An operation unit 101 provides a user interface for the user to operate the image forming apparatus 1. For example, the operation unit 101 may be a touch panel. When the user operates the touch panel, one from among the cartridges 70y, 70m, 70c, and 70k can be designated, and an instruction for replacing the designated cartridge 70 can be sent to the controller 100. Note that hereinafter, the cartridge 70 from among the cartridges 70y, 70m, 70c, and 70k that is to be replaced is referred to as the “target cartridge”. Also, the tray 80 where the target cartridge is installed is referred to as the “target tray”.

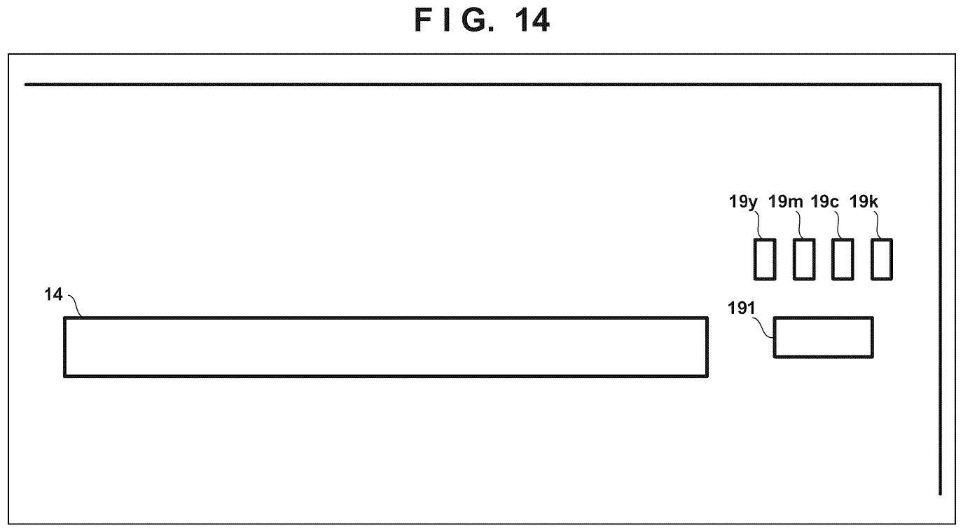

Also, the operation unit 101 may include one or more buttons. FIG. 14 illustrates an example in which the operation unit 101 includes buttons. Note that FIG. 14 illustrates an example in which the buttons are provided at or near the door 14 of the frame body 16, for example. Buttons 19y, 19m, 19c, and 19k are buttons for designating the target cartridge from among the cartridges 70y, 70m, 70c, and 70k. A button 191 is a button for inputting a replacement instruction for the target cartridge. For example, by pressing the button 191 after designating the target cartridge by pressing one from among the buttons 19y, 19m, 19c, and 19k, the user can send an instruction to the controller 100 for replacing the target cartridge. Note that FIG. 14 is an example in which the operation unit 101 includes buttons, but the configuration of the operation unit 101 is not limited thereto.

Also, the controller 100 may be configured to receive a replacement instruction for the cartridge 70 from the host computer. When a replacement instruction is input, the controller 100 notifies the engine control unit 102 of the target cartridge and issues a replacement instruction for the target cartridge.

The engine control unit 102 controls forming an image on the sheet S by controlling the members described using FIGS. 1 to 12B. The engine control unit 102 includes a CPU 103, which is a processor, a volatile memory 104, and a non-volatile memory 105. The CPU 103 controls forming an image on the sheet S and the like by executing a control program stored in the non-volatile memory 105. At this time, the CPU 103 stores temporary information in the volatile memory 104. The non-volatile memory 105 stores various types of control data used by the CPU 103 in the control. The CPU 103 may include one or more processors. Also, in a different configuration, in addition to or instead of the CPU 103, an application specific integrated circuit (ASIC) may be used.

Note that in FIG. 13, only the members controlled by the engine control unit 102 that are required in the description of the embodiment are illustrated, and other members are omitted. Specifically, the scanner 4, that forms an electrostatic latent image on the photosensitive drum 2, the developing units 50y, 50m, 50c, and 50k, that develop the electrostatic latent image formed on the photosensitive drum 2, and the motors M1 and M2 are illustrated in FIG. 13. Note that the motor M1 is a drive source of the rotary body 90. Also, the motor M2 is a drive source of the driving racks 15 for moving the trays 80 between the stored position and the removal position.

Also, in the present embodiment, the cartridges 70y, 70m, 70c, and 70k are provided with cartridge memory 72y, 72m, 72c, and 72k, which are non-volatile memory devices. Hereinafter, the cartridge memory 72y, 72m, 72c, and 72k are collectively referred to as the cartridge memory 72. The engine control unit 102 is configured to be able to access the cartridge memory 72 provided in the cartridge 70 in a case where the cartridge 70 is at the installed position.

The cartridge memory 72 provided in the cartridge 70 stores information indicating whether or not the cartridge 70 is provided by a subscription service. Also, the cartridge memory 72 provided in the cartridge 70 stores information indicating an initial value T₀ of the remaining amount of toner, the toner amount (hereinafter referred to as a supply amount Tₛᵤₚ) to be supplied to the developing unit 50 in one supply, a toner remaining amount T inside the cartridge 70 at the current time, and the like.

As described above, in the image forming apparatus 1, toner is supplied to the developing unit 50 from the cartridge 70 in a time period in which the cartridge 70 is located above the developing unit 50 within the time period of one rotation of the rotary body 90. In the present specification, “one supply” may be defined as supply via one rotation of the rotary body 90. Thus, when the rotary body 90 rotates n number of times (n being an integer of 1 or more), supply is performed n number of times. In this case, the supply amount Tₛᵤₚ corresponds to the decreased amount of the toner remaining amount of the cartridge 70 after one rotation of the rotary body 90.

Note that the toner amount supplied from the cartridge 70 to the developing unit 50 may be different depending on how the rotary body 90 is rotated one time. For example, while developing of an electrostatic latent image is being performed using toner of a certain color (first color), the rotation of the rotary body 90 is stopped at the developing posture for the cartridge 70 containing the first color toner. When the developing of the first color ends, to perform developing of the next color (second color), the rotation is driven until the rotary body 90 is put in the developing posture for the cartridge 70 containing the second color toner. In this manner, the rotary body 90 is not rotationally driven at a constant speed and is intermittently rotationally driven. Thus, the amount of toner supplied from the cartridge 70 to the developing unit 50 may be different depending on the rotationally driven time period and the non-rotationally-driven time period. Also, the toner amount supplied to the developing unit 50 may change depending on the rotational speed of the rotary body 90. Thus, in the present embodiment, the supply amount Tₛᵤₚ may be defined as the toner amount supplied from the cartridge 70 to the developing unit 50 after one rotation of the rotary body 90 using a predetermined mode. Here, one rotation of the rotary body 90 using a predetermined mode means one rotation of the rotary body 90 according to a predefined rotational speed and a predetermined rotational drive stopping timing and stopping period.

Also, even in the time period in which the cartridge 70 is located above the developing unit 50, the amount of toner supplied from the cartridge 70 to the developing unit 50 may be different depending on the relative position (direction) of the cartridge 70 with respect to the developing unit 50. For example, when the developing unit 50 is located at a predetermined position with respect to the cartridge 70, the amount of toner supplied to the developing unit 50 is a maximum amount. In a case where the maximum amount is a much larger amount than the toner amount supplied to the developing unit 50 when the developing unit 50 is located at another position, the predetermined value can be defined as the “supply position”. In this case, “one supply” may be also defined as the supply when the cartridge 70 passes the supply position via rotation of the rotary body 90.

Note that, for example, in a case where the engine control unit 102 can electrically control the opening and closing of the receiving opening 53b via a non-illustrated sealing member that covers the receiving opening 53b of the developing unit 50, the engine control unit 102 can control the supply by controlling the receiving opening 53b. In other words, the engine control unit 102 can supply toner to the developing unit 50 by controlling the sealing member and putting the receiving opening 53b in an open state only in a time period in which the cartridge 70 is above the developing unit 50 and located in a direction of a predetermined range with respect to the developing unit. “One supply” in this case may be defined as supply that is performed from when the receiving opening 53b is put in an open state by the engine control unit 102 until the receiving opening 53b is put in a closed state.

The engine control unit 102 manages the toner remaining amount T of the cartridge 70 by updating the toner remaining amount T of the cartridge 70 to show a reduction corresponding to the supply amount Tₛᵤₚ, when the engine control unit 102 performs one supply from the cartridge 70. Note that the initial value of the current toner remaining amount T is T₀.

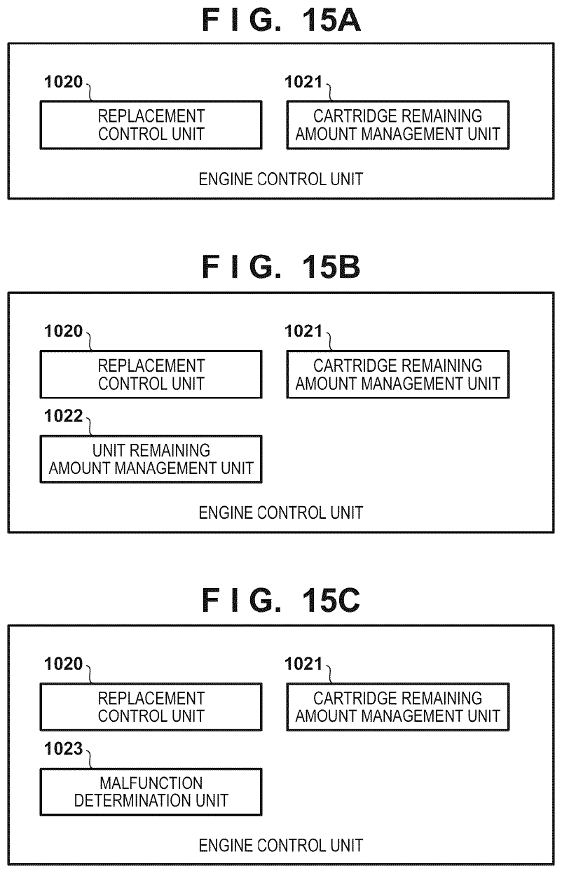

FIG. 15A illustrates functional blocks of the engine control unit 102 according to the present embodiment, and the functional blocks illustrated in FIG. 15A are implemented by the CPU 103 executing a control program. A cartridge remaining amount management unit 1021 manages the toner remaining amount T of each cartridge 70 as described above. A replacement control unit 1020 controls the replacement processing for the cartridge 70.

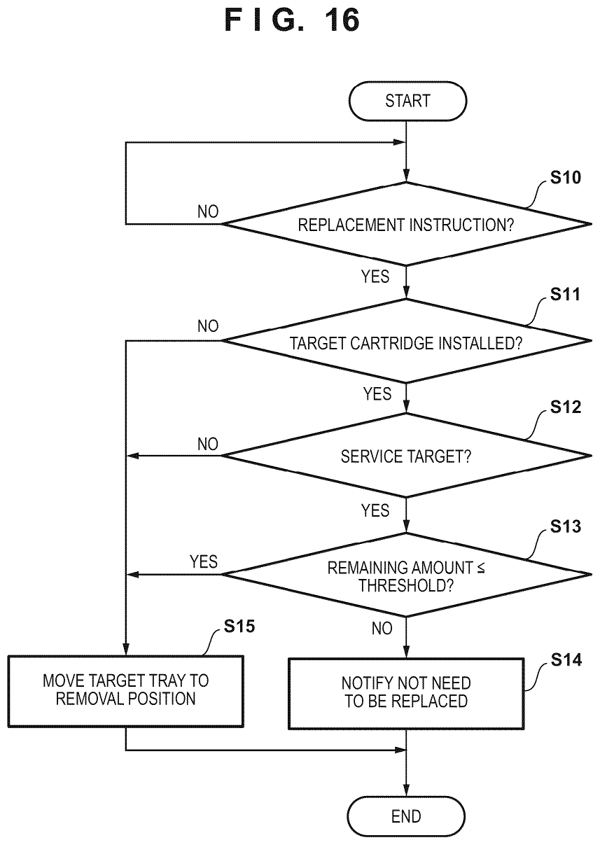

FIG. 16 is a flowchart of the processing executed by the replacement control unit 1020 according to the present embodiment. In step S10, the replacement control unit 1020 waits until there is an instruction to replace the cartridge 70 from the controller 100. When there is a replacement instruction, in step S11, the replacement control unit 1020 determines whether the target cartridge is installed in the target tray. For example, in a case where the replacement control unit 1020 can access the cartridge memory 72 of the target cartridge, the replacement control unit 1020 may determine that the target cartridge is installed in the target tray. In another configuration, a non-illustrated sensor may be used to determine whether or not the target cartridge is installed in the target tray. In another configuration, a flag that is set to a first state in a case where the target cartridge is installed in the target tray and a second state in a case where it is not installed can be provided to determine whether or not the target cartridge is installed in the target tray.

In a case where the target cartridge is not installed in the target tray, in step S15, the replacement control unit 1020 controls the motor M1 and the motor M2 to move the target tray to the removal position. As a result, the user can install the cartridge 70 in the target tray.

However, in step S11, in a case where the target cartridge is installed in the target tray, in step S12, the replacement control unit 1020 accesses the cartridge memory 72 of the target cartridge to obtain information indicating whether or not the target cartridge is provided by a subscription service. In a case where the target cartridge is not provided by a subscription service, in step S15, the replacement control unit 1020 executes replacement processing for the target cartridge. Replacement processing includes processing to rotate the rotary body 90 so as to be put in the replacement posture for the target cartridge, and processing to move the target tray from the stored position to the removal position. Note that the position of the target cartridge in the replacement posture may be referred to as a first position, and the position of the target cartridge at the retracted position may be referred to as a second position.

On the other hand, in a case where the target cartridge is provided by a subscription service, in step S13, the replacement control unit 1020 compares the toner remaining amount of the target cartridge and a threshold. The threshold, for example, is stored in the cartridge memory 72 of the target cartridge or the non-volatile memory 105 of the engine control unit 102. In a case where the toner remaining amount of the target cartridge is equal to or less than the threshold, in step S15, the replacement control unit 1020 executes replacement processing. In other words, the replacement control unit 1020 allows the target cartridge to be replaced and moves the target tray to the removal position. On the other hand, in a case where the toner remaining amount of the target cartridge is greater than the threshold, in step S14, the replacement control unit 1020 does not execute the replacement processing and instead notifies the controller 100 that the target cartridge does not need to be replaced. In other words, in a case where the toner remaining amount of the target cartridge is greater than the threshold, the replacement control unit 1020 does not allow the target cartridge to be replaced. The threshold is a reference value set in advance for determining whether to allow for the replacement of the cartridge 70 provided by a subscription service. The threshold can be 0 or a value greater than 0.

In a case where the controller 100 is notified that the target cartridge does not need to be replaced from the engine control unit 102, the controller 100 executes notification processing to notify the user that the target cartridge does not need to be replaced. For example, the controller 100 may display that the target cartridge does not need to be replaced on the operation unit 101, which is a touch panel. Alternatively, the operation unit 101 may be provided with an LED for indicating that replacement is not needed, and the controller 100 may notify the user that the target cartridge does not need to be replaced by causing the LED to emit light. Also, in a case where a replacement instruction is input from the host computer, the controller 100 may execute processing for displaying that the target cartridge does not need to be replaced on the display of the host computer.

In the present embodiment, the cartridge remaining amount management unit 1021 manages the toner remaining amount T of the cartridge 70 on the basis of the supply amount Tₛᵤₚ stored in the cartridge memory 72 of the cartridge 70. However, the method of managing the toner remaining amount T of the cartridge 70 is not limited to a method based on the supply amount Tₛᵤₚ. For example, as described below, by applying an AC voltage across the developing roller 51 and the supplying roller 52 of the developing unit 50, the toner remaining amount inside the developing unit 50 can be measured. Accordingly, by setting the increase of the toner remaining amount inside the developing unit 50 to the supply amount Tₛᵤₚ, the cartridge remaining amount management unit 1021 can manage the toner remaining amount T of the cartridge 70. Also, using a method similar to that for measuring the toner remaining amount inside the developing unit 50, the cartridge remaining amount management unit 1021 can also measure the toner remaining amount T inside the cartridge 70 for management.

Note that in the flowchart of FIG. 16, in a case where the target cartridge is provided by a subscription service and the toner remaining amount of the target cartridge is greater than the threshold, the replacement control unit 1020 does not allow the target cartridge to be replaced. However, in another configuration, irrespective of whether or not the target cartridge is provided by a subscription service, replacement of the target cartridge is not allowed in a case where the toner remaining amount of the target cartridge is greater than the threshold. This configuration can prevent the replacement of a cartridge with a toner remaining amount greater than the threshold.

Also, in another configuration, instead of the information indicating whether the cartridge 70 is provided by the subscription service, predetermined information indicating whether to allow replacement in a case where the toner remaining amount is greater than the threshold can be stored in the cartridge memory 72 of the cartridge 70. In this case, if the predetermined information indicates that replacement is not allowed in a case where the toner remaining amount is greater than the threshold, the replacement control unit 1020 does not allow replacement when the toner remaining amount of the target cartridge is greater than the threshold and allows replacement when the toner remaining amount is equal to or less than the threshold. However, if the predetermined information does not indicate that replacement is not allowed in a case where the toner remaining amount is greater than the threshold, the replacement control unit 1020 allows replacement irrespective of the toner remaining amount of the target cartridge.

As described above, in the present embodiment, in a case where there is an instruction to replace the cartridge 70 (target cartridge), the replacement control unit 1020 performs control of whether or not to execute replacement processing for replacing the target cartridge on the basis of the information relating to the target cartridge. For example, the information relating to the target cartridge may be the toner remaining amount of the target cartridge. In this case, the replacement control unit 1020 executes the replacement processing in a case where the toner remaining amount of the target cartridge is equal to or less than the threshold, and does not execute the replacement processing in the other case. This configuration can prevent the unnecessary replacement of the cartridge 70 with a large remaining amount of toner.

Also, the information relating to the target cartridge may be information indicating the toner remaining amount of the target cartridge and the predetermined information stored in the cartridge memory 72 of the target cartridge. Here, the predetermined information may be information indicating whether or not to allow replacement irrespective of the toner remaining amount of the target cartridge 70. In a case where the predetermined information indicates to allow replacement irrespective of the toner remaining amount of the cartridge 70, the replacement control unit 1020 executes the replacement processing in response to an replacement instruction for the target cartridge. On the other hand, in a case where the predetermined information indicates to determine whether or not to allow replacement depending on the toner remaining amount of the cartridge 70, the replacement control unit 1020 performs control for whether or not to execute the replacement processing on the basis of the toner remaining amount of the target cartridge. With this configuration, the condition for allowing or not allowing replacement can be changed per cartridge 70.

For example, the predetermined information may be information indicating whether the cartridge 70 is provided by a subscription service. In this case, in a case where the predetermined information indicates that the cartridge 70 is provided by the subscription service, the replacement control unit 1020 determines whether to allow or not allow replacement depending on the toner remaining amount of the target cartridge. On the other hand, in a case where the predetermined information does not indicate that the cartridge 70 is provided by the subscription service, the replacement control unit 1020 allows replacement of the target cartridge irrespective of the toner remaining amount of the target cartridge. With this configuration, for the cartridge 70 obtained by a user that is not related to the subscription service, the user can freely replace the cartridge 70 on the basis of a user determination.

Note that in a case where replacement is not allowed, the replacement control unit 1020 executes processing to notify (report to) the user that the target cartridge does not need to be replaced. On the other hand, in a case where replacement is allowed, the replacement control unit 1020 executes the replacement processing. As described above, the replacement processing includes processing to move the target cartridge at the first position to the second position. The first position is the position of the target cartridge in the replacement posture, and at this time, the entire target cartridge is located inside the frame body 16 of the image forming apparatus 1. The second position is the position moved to from the first position in the radial direction of the rotary body 90, and at this time, at least a portion of the target cartridge is located outside of the frame body 16 of the image forming apparatus 1. Note that when there is a replacement instruction for the target cartridge, if the target cartridge is not at the first position, the replacement control unit 1020 rotates the rotary body 90 so that the position of the target cartridge is the first position.

### Second Embodiment

Next, a second embodiment will be described, focusing on the points that differ from the first embodiment. FIG. 15B illustrates functional blocks of the engine control unit 102 according to the present embodiment. The replacement control unit 1020 and the cartridge remaining amount management unit 1021 are similar to those in the first embodiment. A unit remaining amount management unit 1022 manages a toner remaining amount D inside the developing unit 50.

An example of management of the toner remaining amount D inside the developing unit 50 by the unit remaining amount management unit 1022 will be described below. The engine control unit 102, at the time of image formation, transmits a laser drive signal for driving the laser of the scanner 4 to the scanner 4. The laser drive signal, for example, is a pulse width modulation signal (PWM). While the laser drive signal is at the high level, the scanner 4 emits laser light to expose the photosensitive drum 2, while the laser drive signal is at the low level, the scanner 4 does not emit laser light and thus the photosensitive drum 2 is not exposed. Note that toner adheres to the region of the photosensitive drum 2 exposed by the laser light, and toner does not adhere to the region of the photosensitive drum 2 that is not exposed by the laser light. Thus, by counting the number of pulses corresponding to the number of high levels of the laser drive signal in the time period during which the laser light is emitted at the photosensitive drum 2, a toner consumption amount C used in image formation can be determined. The unit remaining amount management unit 1022 determines the toner consumption amount C used in image formation in this manner.

The unit remaining amount management unit 1022 can manage the toner remaining amount D inside the developing unit 50 by increasing the toner remaining amount D inside the developing unit 50 by the supply amount Tₛᵤₚ, when one supply is performed from the cartridge 70 to the developing unit 50, and decreasing the toner remaining amount D inside the developing unit 50 by the toner consumption amount C each time image formation is performed. Note that the initial value of the toner remaining amount D inside the developing unit 50 is 0, for example.

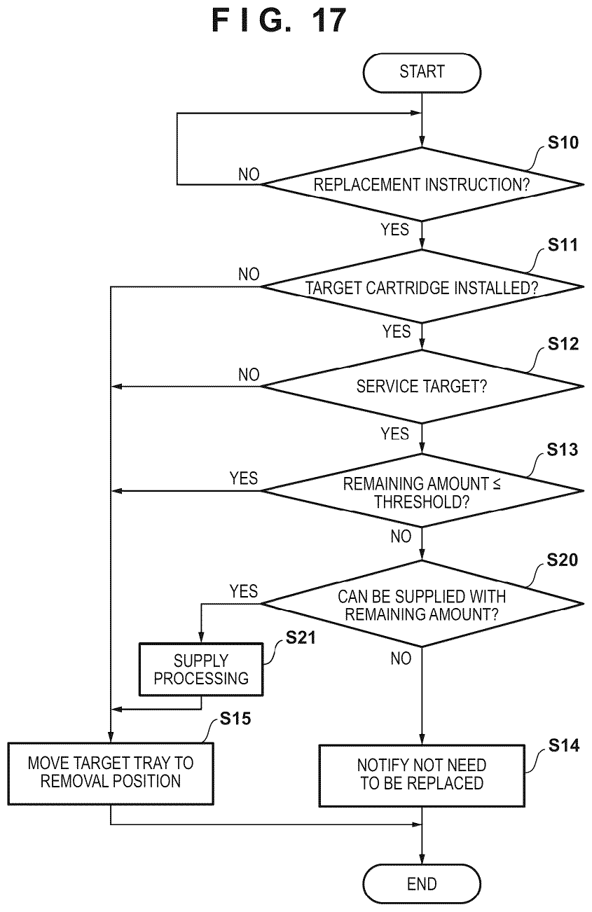

FIG. 17 is a flowchart of the processing executed by the replacement control unit 1020 according to the present embodiment. Note that processing steps in the flowchart that are similar to processing in the first embodiment illustrated in FIG. 16 are given the same step number and the description thereof is omitted. In step S13, in a case where the toner remaining amount of the target cartridge is greater than the threshold, in step S20, the replacement control unit 1020 determines whether or not the developing unit 50 can be supplied with all of the toner remaining in the target cartridge. For example, information indicating a maximum amount Dₘₐₓ of toner that can be contained in each developing unit 50 is stored in advance in the non-volatile memory 105 of the engine control unit 102. The replacement control unit 1020 compares the toner remaining amount T of the target cartridge, and a suppliable amount Dₐᵥₗ, which is obtained by subtracting the toner remaining amount D of the developing unit 50 from the maximum amount Dₘₐₓ that can be contained in the developing unit 50 which is to be supplied with toner by the target cartridge. If the suppliable amount Dₐᵥₗ is equal to or greater than the toner remaining amount T, the replacement control unit 1020 can determine that the developing unit 50 can be supplied with all of the toner remaining in the target cartridge. Otherwise, the replacement control unit 1020 can determine that all cannot be supplied.

In a case where the replacement control unit 1020 determines that the developing unit 50 can be supplied with all of the toner remaining in the target cartridge, in step S21, the replacement control unit 1020 causes all of the toner remaining in the target cartridge to be supplied to the developing unit 50. In other words, the replacement control unit 1020 rotates the rotary body 90 until all of the toner remaining in the target cartridge is supplied to the developing unit 50. Thereafter, in step S15, the replacement control unit 1020 moves the target tray to the removal position. On the other hand, in a case where the replacement control unit 1020 determines that the developing unit 50 cannot be supplied with all of the toner remaining in the target cartridge, in step S14, the replacement control unit 1020 notifies the user that replacement is unnecessary.

Note that in some cases it may take time for the developing unit 50 to be supplied with all of the toner remaining in the target cartridge, depending on the toner remaining amount of the target cartridge. Thus, in a possible configuration, the replacement control unit 1020 estimates the amount of time required to supply the developing unit 50 with all of the toner remaining in the target cartridge and sends a query to the user in a case where the estimated amount of time (estimated time) is greater than a predetermined amount of time. In other words, the replacement control unit 1020 presents to the user that the supply processing will take more time than the predetermined amount of time or presents the estimated time required for supply processing and prompts the user to input whether or not to continue replacement of the target cartridge. In a case where the user inputs in the operation unit 101 a selection to continue the replacement of the target cartridge, in step S21, the replacement control unit 1020 executes the supply processing. On the other hand, in a case where the user inputs in the operation unit 101 a selection to cancel the replacement of the target cartridge, the replacement control unit 1020 ends the processing of FIG. 17. Note that the estimated time can be estimated on the basis of the toner remaining amount T of the target cartridge, the supply amount Tₛᵤₚ of one supply, and the amount of time required for one rotation of the rotary body 90.

Also, in a possible configuration, in a case where the amount of time for the supply processing is greater than the predetermined amount of time even if supply is determined to be possible in step S20, in step S14, the user is notified that replacement is unnecessary without the user being queried.

Note that the unit remaining amount management unit 1022 obtains the toner remaining amount D of the developing unit 50 on the basis of the supply amount Tₛᵤₚ of one supply and toner consumption amount C of image formation. However, the unit remaining amount management unit 1022 can be configured to measure the toner remaining amount D of the developing unit 50. Specifically, the supplying roller 52 of the developing unit 50 has a configuration provided with a urethane sponge layer made of open cells around a core metal with electrical conductivity. The capacitance between the core metal (electrode) of the supplying roller 52 and the core metal (electrode) of the developing roller 51 increases and decreases depending on the amount of toner contained in the urethane sponge layer of the supplying roller 52. Thus, by measuring the capacitance between the supplying roller 52 and the developing roller 51, the toner remaining amount D of the developing unit can be estimated. Note that the capacitance between the supplying roller 52 and the developing roller 51 can be measured by applying an AC voltage to the supplying roller 52 and detecting the voltage induced in the developing roller 51 in a state where the supplying roller 52 and the developing roller 51 are separated.

Note that when there is a large amount of toner at or near the supplying roller 52, a capacitance of greater than that of the toner amount contained inside the sponge layer of the supplying roller 52 is detected, causing a decrease in the capacitance measurement accuracy. Thus, in a possible configuration, when measuring the capacitance between the supplying roller 52 and the developing roller 51 of the developing unit 50, the rotary body 90 is rotated so that the developing roller 51 is located directly beneath the supplying roller 52. In this manner, the capacitance between the supplying roller 52 and the developing roller 51 can be measured with good accuracy due to the toner at or near the supplying roller 52 dropping down due to gravity. Note that in a possible configuration, instead of the supplying roller 52 and the developing roller 51 being used as the two electrodes for measuring the capacitance, two electrodes may be provided for dedicated use in measuring the toner remaining amount of the developing unit 50.

As illustrated in FIG. 17, in step S20, it is determined that the developing unit 50 can be supplied with all of the toner remaining in the target cartridge. However, in another configuration, it may be determined that the developing unit 50 can be supplied so that the amount of toner remaining in the target cartridge is equal to or less than the threshold used in the determination of step S13.

According to the present embodiment described above, when there is a replacement instruction, the replacement control unit 1020 allows replacement of the target cartridge in a case where the developing unit 50 can be supplied so that the toner remaining amount of the target cartridge becomes equal to or less than the threshold even if the toner remaining amount of the target cartridge is greater than the threshold. In this case, the replacement control unit 1020 executes the replacement processing after the supply processing and the toner remaining amount of the target cartridge is made equal to or less than the threshold. With configuration, the cartridge 70 with more toner remaining amount than the threshold can be prevented from being replaced, and the frequency of the cartridge 70 not being replaced at the replacement timing of the user can be reduced.

Also, the replacement control unit 1020 can be configured to not allow replacement if it is determined that the amount of time required for the supply processing is greater than the predetermined amount of time, even in a case where the remaining amount of toner contained in the target cartridge can be made equal to or less than the threshold by executing the supply processing. In another possible configuration, the user can be made to select whether or not execute the supply processing in a case where the remaining amount of toner contained in the target cartridge can be made equal to or less than the threshold by executing the supply processing. With this configuration, the time period from when the user issues an instruction to replace the cartridge 70 to when the user can replace the cartridge 70 being extended can be prevented.

### Third Embodiment

Next, a third embodiment will be described, focusing on the points that differ from the first embodiment. FIG. 15C illustrates functional blocks of the engine control unit 102 according to the present embodiment. The replacement control unit 1020 and the cartridge remaining amount management unit 1021 are similar to those in the first embodiment. A malfunction determination unit 1023 determines whether or not the cartridge 70 is malfunctioning.

For example, the malfunction determination unit 1023 obtains the toner remaining amount D inside the developing unit 50 as described in the second embodiment by measuring the capacitance between the supplying roller 52 and the developing roller 51. In a case where the toner remaining amount T of the cartridge 70 is greater than a predetermined amount, if the cartridge 70 is supplied while located above the developing unit 50, the capacitance will change. Thus, even if the toner remaining amount T of the cartridge 70 is greater than the predetermined amount, in a case where the capacitance before and after supply is not different, the malfunction determination unit 1023 determines that there is a high possibility that the discharge opening 71b of the cartridge 70 is malfunctioning. Note that the predetermined amount may be determined on the basis of the toner amount that gives rise to a change in the capacitance between the supplying roller 52 and the developing roller 51.

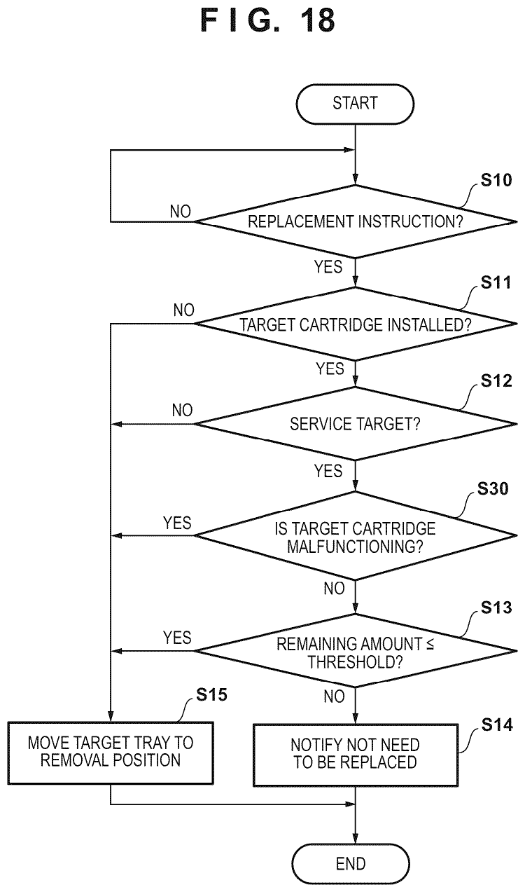

FIG. 18 is a flowchart of the processing executed by the replacement control unit 1020 according to the present embodiment. Note that processing steps in the flowchart that are similar to processing in the first embodiment illustrated in FIG. 16 are given the same step number and the description thereof is omitted.

In a case where the target cartridge is provided by a subscription service (Yes in step S12), in step S30, the replacement control unit 1020 obtains the determination result of the malfunctioning of the target cartridge by the malfunction determination unit 1023. In a case where the malfunction determination unit 1023 determines that the target cartridge is malfunctioning, the replacement control unit 1020 allows replacement of the target cartridge and advances the processing to step S15. On the other hand, in a case where the malfunction determination unit 1023 does not determine that the target cartridge is malfunctioning, the replacement control unit 1020 advances the processing to step S13 and determines whether or not to allow replacement of the target cartridge on the basis of the toner remaining amount T of the target cartridge.

According to the present embodiment described above, the malfunction determination unit 1023 determines whether the target cartridge is malfunctioning. In a case where it is determined that the target cartridge is malfunctioning, by allowing replacement of the target cartridge irrespective of the toner remaining amount of the target cartridge, the target cartridge that is possibly malfunctioning can be replaced at any timing. Note that in the second embodiment as in the present embodiment, in a case where it is determined that there is a possibility of the target cartridge malfunctioning, replacement of the target cartridge may be allowed irrespective of the toner remaining amount of the target cartridge.

### Other Examples

Note that each embodiment has been described using the rotary-type image forming apparatus 1. However, the present invention is not limited to the image forming apparatus 1 being a rotary type and can be applied to an image forming apparatus in which toner is supplied with a cartridge containing the toner installed in the body and replacement processing is required when removing the cartridge. The replacement processing is any processing that must be executed by the image forming apparatus to enable the user to replace a cartridge and, for example, includes moving the cartridge installed in the image forming apparatus to a predetermined position.

Also, each embodiment has been described using the image forming apparatus 1 that can form a color image. However, the present invention can be applied to an image forming apparatus that can only form a monochrome image.

As described above, according to these embodiments, the unnecessary replacement of a cartridge can be prevented.

### Fourth Embodiment

Next, the fourth to sixth embodiments according to the present disclosure will be described.

### Example of Detecting Tray State

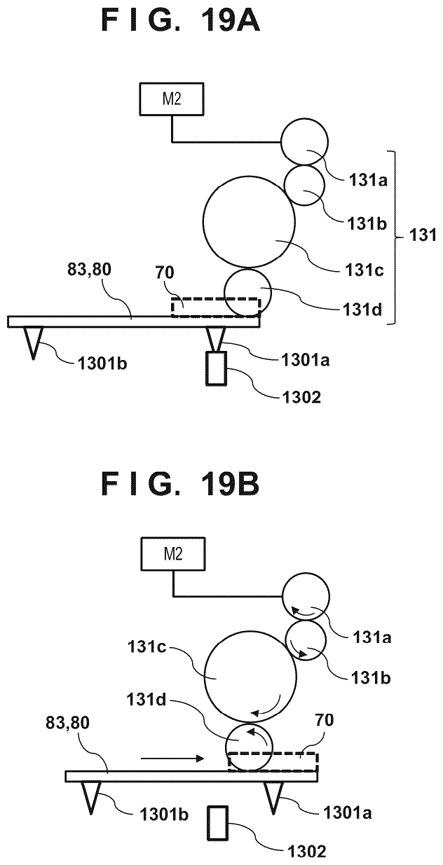

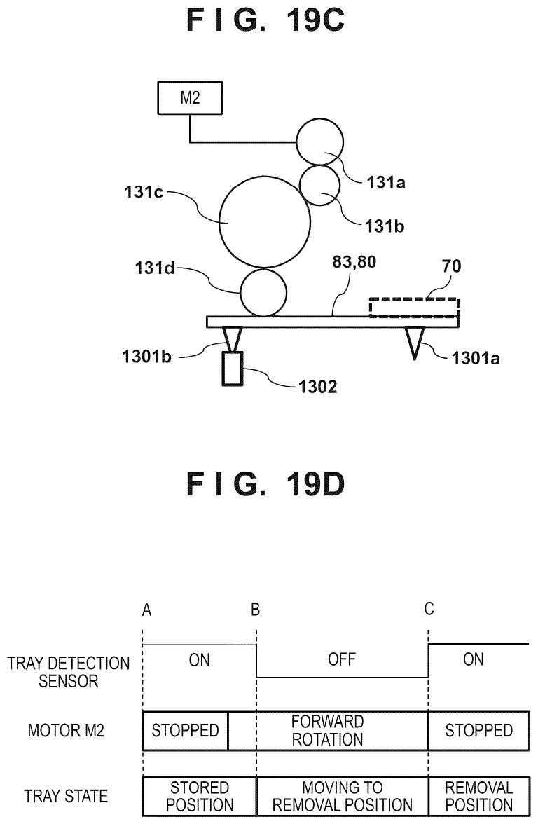

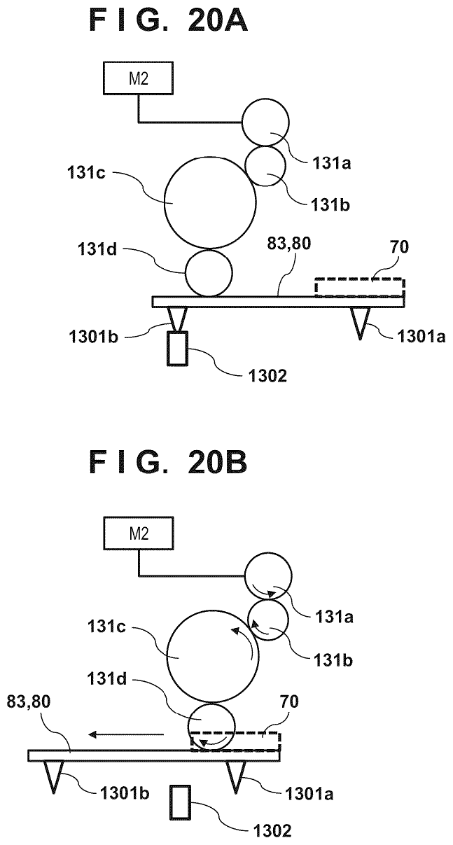

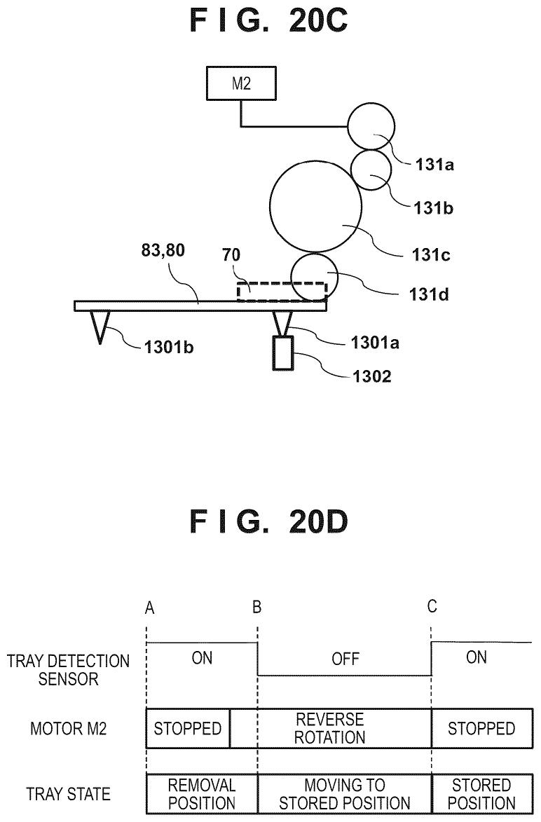

An example of detecting the state (tray state) of the tray 80 when the tray 80 is moved between the stored position and the removal position will now be described with reference to FIGS. 19A to 19D and FIGS. 20A to 20D. FIGS. 19A to 19D illustrate examples of detecting the tray state when the tray 80 is moved from the stored position to the removal position, and FIGS. 20A to 20D illustrate examples of detecting the tray state when the tray 80 is moved from the removal position to the stored position. FIGS. 19A to 19C illustrate a state in which the tray 80 is located at the stored position, a state in which the tray 80 is moving toward the removal position, and a state in which the tray 80 is located at the removal position. FIGS. 20A to 20C illustrate a state in which the tray 80 is located at the removal position, a state in which the tray 80 is moving toward the stored position, and a state in which the tray 80 is located at the stored position. FIGS. 19D and 20D illustrate the output of a tray detection sensor 1302, the operation state of the motor M2, and the tray state.

In the image forming apparatus 1 according to the present embodiment, as described above, the motor M2 is used as a drive source, and gears 131 (131a, 131b, 131c, and 131d) are connected to the motor M2 to transmit the driving force of the motor M2. The gears 131 are connected to the rack portion 83 of the tray 80 and transmit the driving force of the motor M2 to the rack portion 83. Thus, when the motor M2 is rotationally driven, the tray 80 can be moved between the stored position and the removal position. Also, by moving the tray 80 when the cartridge 70 is installed in the tray 80, the cartridge 70 can be moved between the installed position and the retracted position.

The image forming apparatus 1 is provided with the tray detection sensor 1302 at or near the tray 80. The tray detection sensor 1302 is configured of a photointerruptor, for example. The photointerruptor includes a light-emitting element that outputs light and a light-receiving element that receives light incorporated inside a single package and functions to detect a detection target object by the light between the light-emitting element and the light-receiving element being blocked by the object. The tray detection sensor 1302 is configured to detect the tray 80. For such a configuration, sensor flags 1301a and 1301b for blocking the light from the light-emitting element to the light-receiving element of the tray detection sensor 1302 are provided on the side surface of the tray 80. Note that the arrangement of the tray detection sensor 1302 and the sensor flags 1301a and 1301b illustrated in FIGS. 19A to 19C and FIGS. 20A to 20C is merely an example.

As illustrated in FIGS. 19A and 19C and FIGS. 20A and 20C, the tray detection sensor 1302 is configured to output an ON signal when the light from the light-emitting element to the light-receiving element is blocked by either the sensor flag 1301a or 1301b. Also, as illustrated in FIG. 19B and FIG. 20B, the tray detection sensor 1302 is configured to output an OFF signal when the light from the light-emitting element to the light-receiving element is not blocked by either the sensor flag 1301a or 1301b.

In this manner, the tray detection sensor 1302 according to the present example is configured to output an ON signal when the tray 80 is at the stored position or the removal position and output an OFF signal when the tray 80 is moving between the stored position and the removal position. By the tray 80 being moved, the output of the tray detection sensor 1302 is changed. Also, the movement direction of the tray 80 is determined by the rotation direction of the motor M2. Accordingly, the tray state (state at the stored position, state moving to the removal position, state at the removal position, or state moving to the stored position) can be determined on the basis of the rotation direction of the motor M2 and the output of the tray detection sensor 1302.

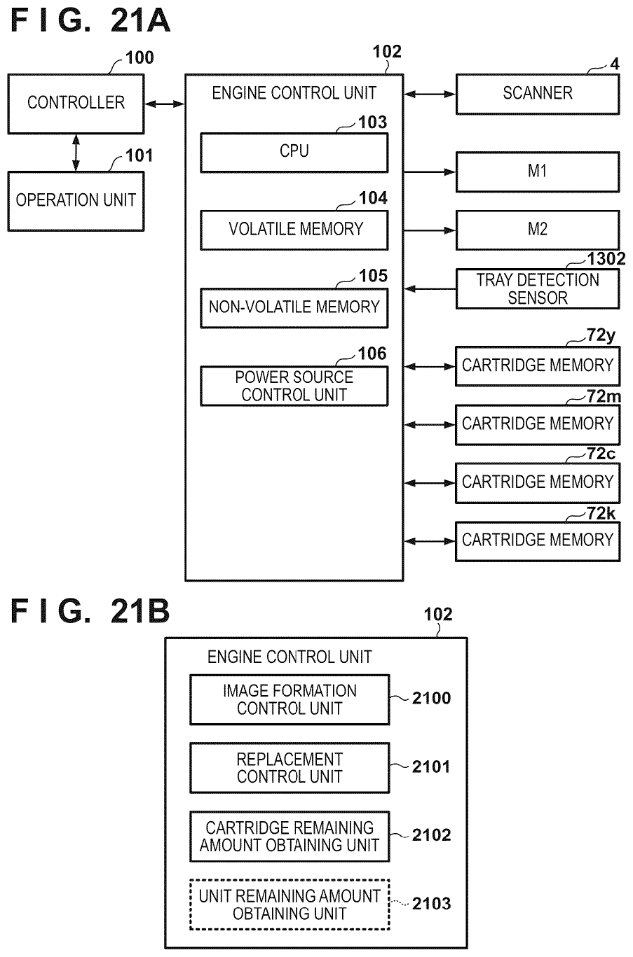

An example of detecting the tray state of the tray 80 when the tray 80 is moved from the stored position to the removal position will now be described using FIGS. 19A to 19D. As illustrated in FIG. 19A, in a case where the tray 80 located at the stored position is moved from the stored position to the removal position, the engine control unit 102 (replacement control unit 1021) of FIGS. 21A and 21B described below starts driving the rotation (forward rotation) in the clockwise direction as illustrated in FIG. 19A of the motor M2. When the rotational (forward rotation) drive of the motor M2 is started, as illustrated in FIG. 19B, the tray 80 starts moving toward the removal position. Accordingly, as illustrated in FIG. 19D, the output of the tray detection sensor 1302 changes from the ON signal to the OFF signal. The engine control unit 102 determines that the tray 80 is in a state of moving from the stored position to the removal position on the basis of the change in the output of the tray detection sensor 1302.

Thereafter, while the motor M2 is continued to be rotational (forward rotation) driven, as illustrated in FIG. 19D, the output of the tray detection sensor 1302 changes from the OFF signal to the ON signal. The engine control unit 102 determines that the tray 80 has reached the removal position on the basis of the change in the output of the tray detection sensor 1302 and stops the motor M2.

An example of detecting the tray state of the tray 80 when the tray 80 is moved from the removal position to the stored position will now be described using FIGS. 20A to 20D. As illustrated in FIG. 20A, in a case where the tray 80 located at the removal position is moved from the removal position to the stored position, the engine control unit 102 (replacement control unit 1021) starts driving the rotation (reverse rotation) in the anticlockwise direction of the motor M2 as illustrated in FIG. 20A. When the rotational (reverse rotation) drive of the motor M2 is started, as illustrated in FIG. 20B, the tray 80 starts moving toward the stored position. Accordingly, as illustrated in FIG. 20D, the output of the tray detection sensor 1302 changes from the ON signal to the OFF signal. The engine control unit 102 determines that the tray 80 is in a state of moving from the removal position to the stored position on the basis of the change in the output of the tray detection sensor 1302.

Thereafter, while the motor M2 is continues to be rotationally (reverse rotation) driven, as illustrated in FIG. 20D, the output of the tray detection sensor 1302 changes from the OFF signal to the ON signal. The engine control unit 102 determines that the tray 80 has reached the stored position on the basis of the change in the output of the tray detection sensor 1302 and stops the motor M2.

The engine control unit 102 (replacement control unit 1021) stores the tray information including the tray state determination result in the non-volatile memory 105. The tray information stored in the non-volatile memory 105 is also stored while the image forming apparatus 1 is in a powered OFF state. Thus, even after the image forming apparatus 1 is turned to a powered ON state from a powered OFF state, the state of the tray 80 can be known on the basis of the tray information stored in the non-volatile memory 105.

### Configuration Relating to Cartridge Replacement

Next, the configuration relating to cartridge replacement in the image forming apparatus 1 will be described. FIG. 21A illustrates an example of the control configuration of the image forming apparatus 1. The controller 100 controls the entire image forming apparatus 1. For example, the controller 100 is configured to communicate with a non-illustrated host computer via a network. The host computer may be any information processing apparatus with a communication function such as a personal computer, a tablet, a smartphone, and the like. When the controller 100 receives a print job from the host computer, the controller 100 transmits the image data of the image to be printed to the engine control unit 102 and causes the engine control unit 102 to perform image formation based on the image data.

The operation unit 101 provides a user interface for the user to operate the image forming apparatus 1. For example, the operation unit 101 may be a touch panel. By operating the touch panel, the user can designate one from among the cartridges 70y, 70m, 70c, and 70k, and make an instruction for replacing the designated cartridge 70 to the controller 100. Also, the operation unit 101 may include one or more buttons. In this case, for example, the operation unit 101 may include a button for designating the cartridge to be replaced from among the cartridges 70y, 70m, 70c, and 70k and a button for sending an instruction to the controller 100 for replacement of the designated cartridge. Such buttons may be provided at or near the door 14 of the frame body 16.

In this manner, the controller 100 is configured to receive a replacement instruction for the cartridge 70 via the operation unit 101. The controller 100 may also be configured to receive a replacement instruction for the cartridge 70 from the host computer. When a replacement instruction for the cartridge 70 is received, the controller 100 notifies the engine control unit 102 of the cartridge to be replaced and issues a cartridge replacement instruction.

The engine control unit 102 controls the members described using FIGS. 1 to 12A and 12B to control forming an image on the sheet S. The engine control unit 102 includes the CPU 103 which is a processor, the volatile memory 104, and the non-volatile memory 105. The CPU 103 controls forming an image on the sheet S and the like by executing a control program stored in the non-volatile memory 105. At this time, the CPU 103 stores temporary information in the volatile memory 104. The non-volatile memory 105 stores various types of control data used by the CPU 103 in the control. The CPU 103 may include one or more processors. Also, in a different configuration, in addition to or instead of the CPU 103, the engine control unit 102 may use an application specific integrated circuit (ASIC).

Note that in FIG. 21A, only the members controlled by the engine control unit 102 that are required in the description of the embodiment are illustrated, and other members are omitted. Specifically, the scanner 4 that forms an electrostatic latent image on the photosensitive drum 2, the motor M1, and the motor M2 are illustrated in FIG. 21A. Note that the motor M1 is a drive source of the rotary body 90. Also, the motor M2 is a drive source of the driving racks 15 (for moving the trays 80 between the stored position and the removal position).

In the present embodiment, the cartridges 70y, 70m, 70c, and 70k are provided with the cartridge memory 72y, 72m, 72c, and 72k, which are non-volatile memory devices. Hereinafter, the cartridge memory 72y, 72m, 72c, and 72k are collectively referred to as the cartridge memory 72. The engine control unit 102 is configured to be able to access the cartridge memory 72 provided in the cartridge 70 in a case where the cartridge 70 is at the installed position. Also, the cartridge memory 72 stores information indicating the initial value T₀ of the remaining amount of toner, the toner amount (hereinafter referred to as the supply amount Tₛᵤₚ) to be supplied to the developing unit 50 in one supply, the toner remaining amount T inside the cartridge 70 at the current time, and the like.

A power source control unit 106 controls the power supply to each member (device) included in the image forming apparatus 1. The power source control unit 106 may be constituted by one or more processors or may be constituted by an ASIC.

FIG. 21B illustrates an example of the functional configuration of the engine control unit 102. In the present embodiment, the functional blocks illustrated in the same diagram are implemented by the CPU 103 executing a control program. Note that at least a portion of the functional blocks illustrated in the same diagram may be implemented by an ASIC. The engine control unit 102 includes an image formation control unit 2120, a replacement control unit 2121, and a cartridge remaining amount obtaining unit 2122. Also, in a case where the engine control unit 102 is configured to manage the toner remaining amount inside the developing unit 50, the engine control unit 102 further includes a unit remaining amount obtaining unit 2123.

By the image formation control unit 2120 controlling the operations of the various types of members (for example, the scanner 4, the developing unit 50, the fixing device 40, and the like) relating to the image forming operation, the image forming operation of the image forming apparatus 1 is controlled. The image formation control unit 2120 forms an image on the sheet S on the basis of the image data received from the controller 100.

The replacement control unit 2121 controls the processing relating to replacement of the cartridge 70. By controlling the motor M1, the replacement control unit 2121 performs rotation control of the rotary body 90, and by controlling the motor M2, the replacement control unit 2121 performs movement control of the tray 80. Also, the replacement control unit 2121 determines (detects) the state of the tray 80 (state at the stored position, state of moving to the removal position, state at the removal position, or state of moving to the stored position) on the basis of the output of the tray detection sensor 1302. The replacement control unit 2121 stores the tray information including the determination result of the state of the tray 80 in the non-volatile memory 105.

The cartridge remaining amount obtaining unit 2122 is configured to obtain and manage the toner remaining amount T inside each cartridge 70. In the present embodiment, the cartridge remaining amount obtaining unit 2122 functions as an example of an obtaining unit that obtains the toner remaining amount inside the cartridges. The cartridge remaining amount obtaining unit 2122 manages the toner remaining amount T inside the cartridge 70 at the current time by updating the toner remaining amount T of the cartridge 70 to show a reduction corresponding to the supply amount Tₛᵤₚ, when one supply from the cartridge 70 to the developing unit 50 is performed. Note that the initial value of the toner remaining amount T is T₀. The cartridge remaining amount obtaining unit 2122 manages the toner remaining amount T inside each cartridge 70 with the toner remaining amount T stored in the corresponding cartridge memory 72.

Here, “one supply” from the cartridge 70 to the developing unit 50 may be defined as follows. In the image forming apparatus 1 according to the present embodiment, toner is supplied to the developing unit 50 from the cartridge 70 in a time period in which the cartridge 70 is located above the developing unit 50 within the time period of one rotation of the rotary body 90. In the present specification, “one supply” may be defined as supply via one rotation of the rotary body 90. Thus, when the rotary body 90 rotates n number of times (n being an integer of 1 or more), supply is performed n number of times. In this case, the supply amount Tₛᵤₚ corresponds to the decreased amount of the toner remaining amount of the cartridge 70 after one rotation of the rotary body 90.

Note that the toner amount supplied from the cartridge 70 to the developing unit 50 may be different depending on how the rotary body 90 is rotated one time. For example, while developing of an electrostatic latent image is being performed using toner of a certain color (first color), the rotation of the rotary body 90 is stopped at the developing posture for the cartridge 70 containing the first color toner. When the developing of the first color ends, to perform developing of the next color (second color), the rotation is driven until the rotary body 90 is put in the developing posture for the cartridge 70 containing the second color toner. In this manner, the rotary body 90 is not rotationally driven at a constant speed and is intermittently rotationally driven. Thus, the amount of toner supplied from the cartridge 70 to the developing unit 50 may be different depending on the rotationally driven time period and the non-rotationally-driven time period. Also, the toner amount supplied to the developing unit 50 may change depending on the rotational speed of the rotary body 90. Thus, in the present embodiment, the supply amount Tₛᵤₚ may be defined as the toner amount supplied from the cartridge 70 to the developing unit 50 after one rotation of the rotary body 90 using a predetermined mode. Here, one rotation of the rotary body 90 using a predetermined mode means one rotation of the rotary body 90 according to a predefined rotational speed and a predetermined rotational drive stopping timing and stopping period.

Also, even in the time period in which the cartridge 70 is located above the developing unit 50, the amount of toner supplied from the cartridge 70 to the developing unit 50 may be different depending on the relative position (direction) of the cartridge 70 with respect to the developing unit 50. For example, when the developing unit 50 is located at a predetermined position with respect to the cartridge 70, the amount of toner supplied to the developing unit 50 is a maximum amount. In a case where the maximum amount is a much larger amount than the toner amount supplied to the developing unit 50 when the developing unit 50 is located at another position, the predetermined value can be defined as the “supply position”. In this case, “one supply” may be also defined as the supply when the cartridge 70 passes the supply position via rotation of the rotary body 90.

Note that, for example, in a case where the engine control unit 102 can electrically control the opening and closing of the receiving opening 53b via a non-illustrated sealing member that covers the receiving opening 53b of the developing unit 50, the engine control unit 102 can control the supply by controlling the receiving opening 53b. In other words, the engine control unit 102 can supply toner to the developing unit 50 by controlling the sealing member and putting the receiving opening 53b in an open state only in a time period in which the cartridge 70 is above the developing unit 50 and located in a direction of a predetermined range with respect to the developing unit. “One supply” in this case may be defined as supply that is performed from when the receiving opening 53b is put in an open state by the engine control unit 102 until the receiving opening 53b is put in a closed state.

The unit remaining amount obtaining unit 2123 is configured to obtain and manage the toner remaining amount D inside the developing unit 50. The toner remaining amount D inside the developing unit 50 is managed by the unit remaining amount obtaining unit 2123 as follows, for example. The engine control unit 102, at the time of image formation, transmits a laser drive signal for driving the laser of the scanner 4 to the scanner 4. The laser drive signal, for example, is a pulse width modulation signal (PWM). While the laser drive signal is at the high level, the scanner 4 emits laser light and exposes the photosensitive drum 2, while the laser drive signal is at the low level, the scanner 4 does not emit laser light and thus the photosensitive drum 2 is not exposed. Note that toner adheres to the region of the photosensitive drum 2 exposed by the laser light, and toner does not adhere to the region of the photosensitive drum 2 that is not exposed by the laser light. Thus, by counting the number of pulses corresponding to the number of high levels of the laser drive signal in the time period during which the laser light is emitted at the photosensitive drum 2, a toner consumption amount C used in image formation can be determined. The unit remaining amount obtaining unit 2123 determines the toner consumption amount C using in image formation in this manner.

The unit remaining amount obtaining unit 2123 can manage the toner remaining amount D inside the developing unit 50 by increasing the toner remaining amount D inside the developing unit 50 by the supply amount Tₛᵤₚ, when one supply is performed from the cartridge 70 to the developing unit 50 and decreasing the toner remaining amount D inside the developing unit 50 by the toner consumption amount C each time image formation is performed. Note that the initial value of the toner remaining amount D inside the developing unit 50 is 0, for example.

Also, the unit remaining amount obtaining unit 2123 may be configured to manage the toner remaining amount D by measuring the toner remaining amount D of the developing unit 50. For example, by measuring the capacitance between the supplying roller 52 and the developing roller 51, the toner remaining amount D of the developing unit 50 can be estimated. The capacitance between the supplying roller 52 and the developing roller 51 can be measured by applying an AC voltage to the supplying roller 52 and detecting the voltage induced in the developing roller 51 in a state where the supplying roller 52 and the developing roller 51 are separated. Alternatively, two electrodes provided for dedicated use in measuring the toner remaining amount D of the developing unit 50 can be provided, and the toner remaining amount D of the developing unit 50 can be measured on the basis of the capacitance between the two electrodes determined by applying a voltage across the two electrodes.

### Cartridge Movement Control

Next, in the present embodiment, movement control of the cartridge 70 performed by the replacement control unit 2121 (CPU 103) of the engine control unit 102 will be described.

When a replacement instruction is received from the controller 100, the replacement control unit 2121 (CPU 103) performs movement control to move the cartridge 70 to be replaced installed in the rotary body 90 to the retracted position. The replacement instruction is input by the user via the operation unit 101, for example. In the present embodiment, the replacement instruction is an example of a movement instruction for the cartridge 70 for moving the cartridge 70 to the retracted position. In a case where a replacement instruction is received, first, the replacement control unit 2121 executes processing to rotate the rotary body 90 so that the rotary body 90 is put in the replacement posture for the cartridge 70 to be replaced. The replacement control unit 2121 further executes processing to move the cartridge 70 from the installed position to the retracted position by moving the tray 80 in which the cartridge 70 to be replaced is installed from the stored position to the removal position. After the rotation of the motor M2 has started, if the replacement control unit 2121 detects that the tray 80 has arrived at the removal position on the basis of the output of the tray detection sensor 1302, the replacement control unit 2121 stops the motor M2.

In this manner, the replacement control unit 2121 moves the cartridge 70 to the retracted position. Accordingly, the user can remove the cartridge 70 from the tray 80 and perform the task (replacement task) of installing a new cartridge 70. Note that the installed position is the position of the target cartridge when the rotary body 90 is at the replacement posture and may be referred to as the first position inside of the rotary body 90. Also, the retracted position may be referred to as the second position outside of the rotary body 90 where that cartridge 70 can be replaced. In this manner, in the case of a cartridge replacement instruction, the replacement control unit 2121 executes movement processing to move the cartridge 70 stored in the rotary body 90 from the installed position (first position) inside of the rotary body 90 to the retracted position (second position) outside of the rotary body 90 where the cartridge 70 can be replaced.

After the replacement task is complete, for example, the user operates the operation unit 101 to notify of the completion of the replacement task. The controller 100 transmits the replacement task completion notification to the engine control unit 102 (replacement control unit 2121). When the replacement task completion notification is received, the replacement control unit 2121 performs movement control to move the cartridge 70 located at the retracted position to the installed position. The replacement control unit 2121 executes processing to move the cartridge 70 from the retracted position to the installed position by moving the tray 80 in which the post-replacement cartridge 70 is installed from the removal position to the stored position. After the rotation of the motor M2 has started, if the replacement control unit 2121 detects that the tray 80 has arrived at the stored position on the basis of the output of the tray detection sensor 1302, the replacement control unit 2121 stops the motor M2.

In this manner, the replacement control unit 2121 moves the cartridge 70 to the installed position. Accordingly, the replacement of the cartridge 70 based on the replacement instruction can be completed.

In the present embodiment, when it is detected that replacement of the cartridge 70 is required on the basis of the toner remaining amount T of the cartridge 70, the replacement control unit 2121 executes the movement processing to move the cartridge 70 to the retracted position (second position) even if there has not been an instruction to replace the cartridge 70. As described above, the toner remaining amount T is detected (managed) by the cartridge remaining amount obtaining unit 2122. For example, when the toner remaining amount T of the cartridge 70 is equal to or less than a threshold (in other words, when it is detected that replacement of the cartridge 70 is required), the replacement control unit 2121 executes movement processing to move the cartridge 70 to the retracted position even if there has not been an instruction to replace the cartridge 70. The movement processing may be executed in a similar manner as to when there is an instruction to replace the cartridge 70. Note that the threshold of the toner remaining amount T may be set to 0. In this case, what is detected is the toner remaining amount T becoming 0.

In this manner, when the cartridge 70 is moved to the retracted position, the cartridge 70 and the tray 80 are put in a state projecting outside of the apparatus body 1A via the opening 16a. This makes it easier for the user to recognize the need to replace the cartridge 70. Thus, the downtime from when the task of replacing the cartridge 70 is completed by the user to when an image can be formed can be reduced, and stress on the user due to being unable to use the image forming apparatus 1 can be reduced.

### Processing Procedure

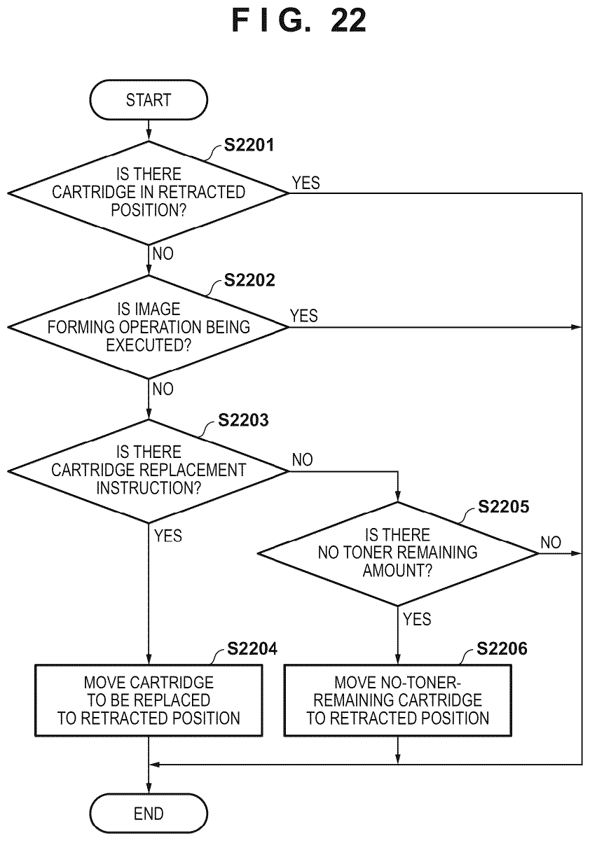

FIG. 22 is a flowchart illustrating an example of the process of the movement control of the cartridge 70 executed by the image forming apparatus 1 according to the present embodiment. The processing according to the present process is executed repeatedly (for example, periodically) while the image forming apparatus 1 is activated.

In step S2201, the CPU 103 determines whether or not the cartridge 70 is located at the retracted position on the basis of the tray information stored in the non-volatile memory 105. In a case where the tray 80 is located at the removal position, this means that one of the cartridges 70 is located at the retracted position. Thus, in a case where the tray information indicates that the tray 80 is located at the removal position, the CPU 103 determines that the cartridge 70 is located at the retracted position and ends the processing according to the present process. On the other hand, in a case where the tray information indicates that the tray 80 is located at the stored position, the CPU 103 determines that the cartridge 70 is not located at the retracted position (at the installed position) and advances the processing to step S2202.

In step S2202, the CPU 103 determines whether or not an image forming operation is currently being executed. In a case where an image forming operation is currently being executed, the CPU 103 ends the processing according to the present process. In a case where an image forming operation is not currently being executed, the CPU 103 advances the processing to step S2203. Accordingly, the image forming apparatus 1 is configured to execute the processing of step S2203 onward on the condition that the image forming apparatus 1 is in a state in which processing to move the cartridge 70 to the retracted position is executable. Note that, for example, if the image forming apparatus 1 is not in a state in which processing to move the cartridge 70 to the retracted position is executable, such as when a preparation operation for image formation is being executed, the CPU 103 does not proceed the processing to step S2203 and may end the processing according to the present process. In other words, the CPU 103 may proceed the processing from step S2202 to step S2203 in response to the image forming apparatus 1 entering a state in which the processing to move the cartridge 70 to the retracted position is executable.

In step S2203, the CPU 103 determines whether or not a replacement instruction for the cartridge 70 has been received. In a case where a replacement instruction has been received for any of the cartridges 70, the CPU 103 advances the processing to step S2204. In step S2204, the CPU 103 executes the movement processing to move the cartridge 70 to be replaced to the retracted position according to the replacement instruction. The movement processing includes processing to rotate the rotary body 90 to the replacement posture for the cartridge 70 to be replaced and processing to move the tray 80 in which the cartridge 70 to be replaced is installed from the stored position to the removal position. By the tray 80 being moved from the stored position to the removal position, the cartridge 70 can be moved from the installed position to the retracted position. When the movement processing for the cartridge 70 is complete, the CPU 103 ends the processing according to the present process.

Also, in a case where a replacement instruction for the cartridge 70 has not been received, the CPU 103 advances the processing from step S2203 to step S2205. In step S2205, the CPU 103 determines whether or not there is a cartridge with no amount of toner remaining (empty) from among the plurality of cartridges 70 installed in the rotary body 90. The toner remaining amount T of each cartridge 70 is managed by the cartridge remaining amount obtaining unit 2122. Here, the no-toner-remaining (empty) state of the cartridge 70 indicates a state in which the toner required for image formation cannot be supplied from the cartridge 70 to the developing unit 50. For example, in a case where the toner remaining amount T of the cartridge 70 is equal to or less than a threshold, the cartridge 70 is determined to be a no-toner-remaining cartridge. The threshold is set to a toner remaining amount at which the toner required for image formation cannot be supplied from the cartridge 70 to the developing unit 50. Note that the no-toner-remaining state may include a state in which the toner remaining amount of the cartridge 70 is 0.

In a case where the CPU 103 determines that a no-toner-remaining cartridge is not present, the CPU 103 ends the processing according to the present process. In a case where the CPU 103 determines that a no-toner-remaining cartridge is present, the CPU 103 advances the processing from step S2205 to step S2206.

Here, in a case where toner remains inside the corresponding developing unit 50 even if the cartridge 70 is in a no-toner-remaining state, image formation may be executable. Thus, in a modified example of the processing according to the present process, the CPU 103 may execute the following processing, for example. Specifically, in a case where the CPU 103 determines that a no-toner-remaining cartridge is present, the CPU 103 may proceed the processing from step S2205 to step S2206 on the condition that the developing unit 50 is in a no-toner-remaining (empty) state (the toner remaining amount T is equal to or less than a threshold). Note that the toner remaining amount T inside the developing unit 50 is managed by the unit remaining amount obtaining unit 2123. Also, the threshold used in determining the toner remaining amount T of the cartridge 70 may be referred to as a first threshold, and the threshold used in determining the toner remaining amount T inside the developing unit 50 may be referred to as a second threshold.

In step S2206, the CPU 103 executes the movement processing to move the no-toner-remaining cartridge 70 to the retracted position. As described above, the movement processing includes processing to rotate the rotary body 90 to the replacement posture for the cartridge 70 to be processed and processing to move the tray 80 in which the cartridge 70 to be processed is installed from the stored position to the removal position. Note that in a case where a plurality of the cartridges 70 are targets of the movement processing, the CPU 103 executes the movement processing for moving to the retracted position for any of the cartridges.

When the movement processing for the cartridge 70 is complete, the CPU 103 ends the processing according to the present process. In a case where it is not desired that the cartridge 70 is continuously held at the retracted position after being moved to the retracted position, the CPU 103 may execute processing to return the cartridge 70 to the installed position (move from the retracted position to the installed position) after a predetermined amount of time has elapsed after the cartridge 70 is moved to the retracted position.

As described above, the image forming apparatus 1 according to the present embodiment includes the rotary body 90 (rotary) that can rotate. The rotary body 90 includes the developing unit 50 that develops an electrostatic latent image formed on the photosensitive drum 2 (photosensitive member) using toner supplied from the cartridge 70. The moving device 85 is configured to move the cartridge 70 between the installed position where the cartridge 70 is located inside the rotary body 90 and the retracted position where the cartridge 70 is located outside the rotary body 90. The cartridge remaining amount obtaining unit 2122 obtains the toner remaining amount T inside the cartridge 70. In a case where a movement instruction (replacement instruction) for the cartridge 70 is received, the replacement control unit 2121 (engine control unit 102) executes movement processing to control the moving device 85 to move the cartridge 70 from the installed position to the retracted position. In a case where the obtained result of the cartridge remaining amount obtaining unit 2122 satisfies a predetermined condition, the replacement control unit 2121 further executes movement processing for the cartridge 70 even if a movement instruction for the cartridge 70 has not been received. For example, when the toner remaining amount T obtained by the cartridge remaining amount obtaining unit 2122 is equal to or less than a threshold, the replacement control unit 2121 executes movement processing for the cartridge 70 even if a movement instruction for the cartridge 70 has not been received.

In this manner, in the present embodiment, even in a case where there is not a replacement instruction for the cartridge 70 from the user, processing is executed to move the cartridge 70 (for example, the no-toner-remaining cartridge 70) for which an obtained result for the toner remaining amount T satisfies a predetermined condition, to the retracted position. This makes it easier for the user to recognize the need to replace the cartridge 70. Thus, the downtime until the task of replacing the cartridge 70 is completed by the user and image formation is possible can be reduced, and stress on the user due to being unable to use the image forming apparatus 1 can be reduced.

### Modified Example of Fourth Embodiment

Note that the replacement control unit 2121 may be configured to execute processing to move the tray 80 from the stored position to the removal position (move the cartridge 70 from the stored position to the retracted position) on the condition that a state in which image formation is unexecutable is detected, without limiting to using, as a condition, a state of the cartridge 70 in which there is no toner remaining. This makes it easier for the user to recognize that the image forming apparatus 1 cannot execute image formation.

For example, in a case where it is detected that the cartridge 70 is not installed (is uninstalled) in the image forming apparatus 1 (rotary body 90), the replacement control unit 2121 may execute processing to move the tray 80 corresponding to the uninstalled cartridge 70 from the stored position (position corresponding to the installed position) to the removal position (position corresponding to the retracted position) even if an instruction to move the cartridge 70 has not been received (there is no replacement instruction for the cartridge 70). This allows the user to immediately recognize that the image forming apparatus 1 cannot execute image formation due to the cartridge 70 not being installed.

In the example described above, a sensor for detecting if the cartridge 70 is not installed in the image forming apparatus 1 (rotary body 90) may be provided inside the image forming apparatus 1. In this case, the CPU 103 detects if the cartridge 70 is not installed in the image forming apparatus 1 (rotary body 90) on the basis of the output of the sensor. Alternatively, the CPU 103 may detect if the cartridge 70 is not installed in the image forming apparatus 1 (rotary body 90) on the basis of information being unable to be obtained from the cartridge memory 72 of the cartridge 70.

### Fifth Embodiment

The image forming apparatus 1 according to the fourth embodiment is configured to execute processing to move the no-toner-remaining cartridge 70 to the retracted position even in a case where the user has not issued a replacement instruction for the cartridge 70. In this case, if the cartridge 70 is continuously held at the retracted position (the tray 80 is continuously held at the removal position), there is a possibility of a malfunction occurring in the operation of the image forming apparatus 1 due to dust and similar dirt particles entering into the apparatus via the opening 16a.

In the fifth embodiment, such a malfunction is prevented by configuring the image forming apparatus 1 to hold the no-toner-remaining cartridge 70 at the installed position until an image formation instruction is received. Also, by configuring the image forming apparatus 1 so that the cartridge 70 is moved to the retracted position at the timing of when an image formation instruction is received, it can be made easier for the user to recognize the need to replace the cartridge 70, as in the fourth embodiment. The differences from the fourth embodiment will be focused on in the following description.

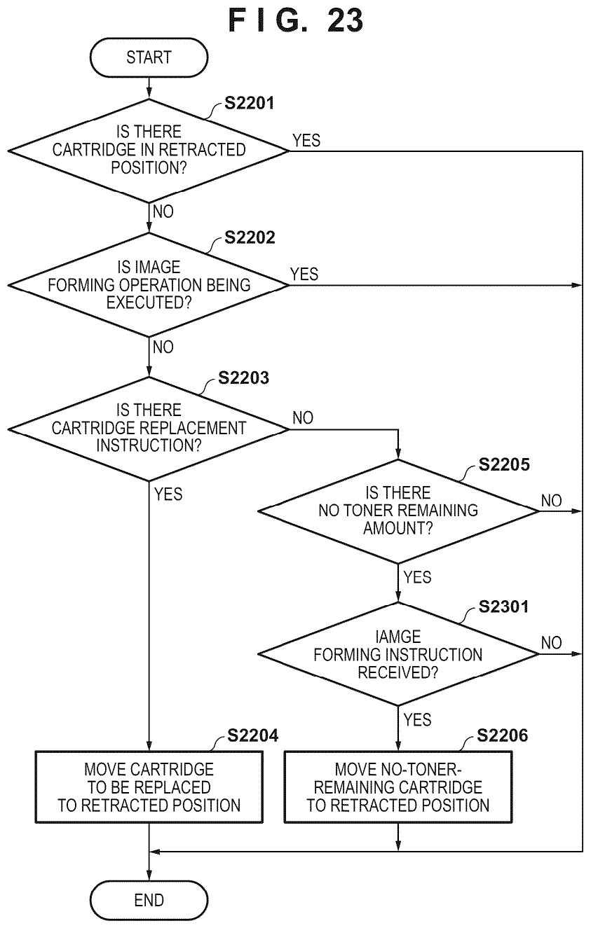

FIG. 23 is a flowchart illustrating an example of the process of the movement control of the cartridge 70 executed by the image forming apparatus 1 according to the present embodiment. The processing according to the present process is executed repeatedly (for example, periodically) while the image forming apparatus 1 is activated. The process of FIG. 23 is different from the process of FIG. 22 according to the fourth embodiment in that step S2301 is added between step S2205 and step S2206.

In the present embodiment, in step S2205, in a case where the CPU 103 determines that a no-toner-remaining cartridge is present, the CPU 103 advances the processing to step S2301. Note that as described above, in a case where the CPU 103 determines that a no-toner-remaining cartridge is present, the CPU 103 may proceed the processing to step S2301 on the condition that the developing unit 50 is in a no-toner-remaining (empty) state (the toner remaining amount T is equal to or less than a threshold).

In step S2301, the CPU 103 determines whether or not an image formation instruction (printing instruction) has been received from the controller 100. In a case where an image formation instruction has not been received from the controller 100, the CPU 103 ends the processing according to the present process. On the other hand, in a case where an image formation instruction has been received from the controller 100, the CPU 103 advances the processing to step S2206.

In step S2206, the CPU 103 executes the movement processing to move the no-toner-remaining cartridge 70 to the retracted position as in the fourth embodiment. When the movement processing for the cartridge 70 is complete, the CPU 103 ends the processing according to the present process. In a case where it is not desired that the cartridge 70 is continuously held at the retracted position after being moved to the retracted position, the CPU 103 may execute processing to return the cartridge 70 to the installed position after a predetermined amount of time has elapsed after the cartridge 70 is moved to the retracted position.

As described above, in the image forming apparatus 1 according to the present embodiment, when the toner remaining amount T obtained by the cartridge remaining amount obtaining unit 2122 becomes equal to or less than the threshold, the replacement control unit 2121 executes the movement processing of the cartridge 70 (moves the cartridge 70 in a no-toner-remaining state to the retracted position) in response to the image formation instruction being received even if a movement instruction (replacement instruction) for the cartridge 70 has not been received. In other words, in this manner, the replacement control unit 2121 continuously holds the cartridge 70 at the retracted position. This can reduce the possibility of dust and similar dirt particles entering into the apparatus via the opening 16a and can achieve making the need for replacement of the cartridge 70 more recognizable for the user. Thus, the downtime from when the task of replacing the cartridge 70 is completed by the user to when an image can be formed can be reduced, and stress on the user due to being unable to use the image forming apparatus 1 can be reduced.

Note that as in the modified example of the fourth embodiment, in a case where it is detected that the cartridge 70 is not installed in the image forming apparatus 1 (rotary body 90), processing may be executed to move the tray 80 in which the cartridge 70 is not installed from the stored position to the removal position.

### Sixth Embodiment

In the sixth embodiment, the image forming apparatus 1 is configured so that, when transitioning to a sleep state, control is performed to move the cartridge 70 from the retracted position to the installed position (move the tray 80 from the removal position to the stored position). In this manner, if the cartridge 70 is continuously held at the retracted position (the tray 80 is continuously held at the removal position) during the sleep state, dust and similar dirt particles entering into the apparatus via the opening 16a can be prevented. Also, in a case where the cartridge 70 moved to the retracted position according to a movement instruction (replacement instruction) for the cartridge 70 is moved to the installed position upon the transition to the sleep state, the image forming apparatus 1 is configured to again move the cartridge 70 to the retracted position when the image forming apparatus 1 is restored from the sleep state. Accordingly, the user is able to immediately perform the task of replacing the cartridge 70 after the image forming apparatus 1 is restored from the sleep state. The differences between the fourth embodiment will be focused on in the following description.

The image forming apparatus 1 according to the present embodiment includes a low power mode (sleep mode) as an operation mode. In the sleep mode, by stopping the supply of power to the devices (for example, a motor or similar actuator and a sensor) used in an image forming operation, the image forming apparatus 1 is transitioned to the sleep state. In the sleep state, the power consumption of the image forming apparatus 1 is less than when in a normal mode (non-sleep mode). The image forming apparatus 1 operating in a normal mode, for example, transitions from the normal mode to the sleep mode in a case where a predetermined amount of time has elapsed since an operation of the operation unit 101 has been performed while in a standby state in which no image forming operation is performed.

In the image forming apparatus 1 according to the present embodiment, the power source control unit 106 controls the supply of power to each device inside the image forming apparatus 1 to control the transition to the sleep mode (sleep state) and the restoration from the sleep mode (sleep state). Note that in the sleep state, the CPU 103 stops the supply of power to the volatile memory 104 and the non-volatile memory 105 to thus stop the operations of these devices.

### Sleep Transition Control

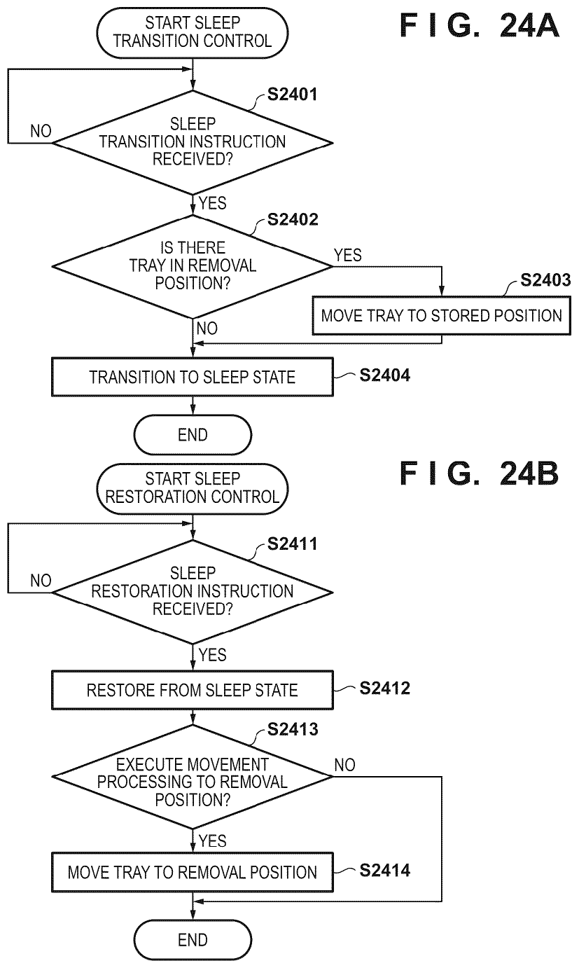

FIG. 24A is a flowchart illustrating an example of the process of the sleep transition control performed by the image forming apparatus 1 according to the present embodiment. The processing according to the process in FIG. 24A is executed while the image forming apparatus 1 is in the standby state.

In step S2401, the CPU 103 determines whether or not a sleep transition instruction has been received from the controller 100 in the standby state and advances the processing to step S2402 in response to the reception of a sleep transition instruction. After the reception of a sleep transition instruction, in step S2402, the CPU 103 determines whether or not the tray 80 is located at the stored position on the basis of the tray information stored in the non-volatile memory 105. In a case where the CPU 103 determines that the tray 80 is not located at the stored position (located at the removal position), the CPU 103 advances the processing to step S2403. In a case where the CPU 103 determines that the tray 80 is located at the stored position, the CPU 103 advances the processing to step S2404.

In step S2403, the CPU 103 (replacement control unit 2121) executes the movement processing to move the tray 80 from the removal position to the stored position. At this time, the CPU 103 includes, in the tray information, information indicating that the tray 80 was located at the removal position (the cartridge 70 was located at the retracted position) before the transition to the sleep state and stores this in the non-volatile memory 105. When the processing to move the tray 80 to the stored position is complete, the CPU 103 advances the processing to step S2404.

Note that, relating to the tray 80 located at the removal position, the CPU 103 according to the present embodiment stores, in the non-volatile memory 105, information indicating whether or not the tray 80 has been moved to the removal position (the cartridge 70 has been moved to the retracted position) according to a replacement instruction. This information is included in the tray information and stored in the non-volatile memory 105 in response to a replacement instruction for the cartridge 70 being input to the operation unit 101 by the user.

In step S2404, the CPU 103 instructs the power source control unit 106 to transition to sleep mode. The power source control unit 106 controls the supply of power to each device inside the image forming apparatus 1 according to the instruction from the CPU 103 and transitions the image forming apparatus 1 to the sleep mode. When the transition to sleep mode is complete, the power source control unit 106 ends the processing according to the present process.

In this manner, the image forming apparatus 1 operates so that, in a case where the image forming apparatus 1 is transitioned to the sleep state, the sleep state is transitioned to after the tray 80 located at the removal position is moved to the stored position. This can prevent the operation of the image forming apparatus 1 malfunctioning due to dust or similar dirt particles entering inside the apparatus via the opening 16a while the image forming apparatus 1 is in the sleep state.

### Sleep Restoration Control

FIG. 24B is a flowchart illustrating an example of the process of the sleep restoration control performed by the image forming apparatus 1 according to the present embodiment. The processing according to the process in FIG. 24B is executed while the image forming apparatus 1 is in the sleep state.

In step S2411, the power source control unit 106 determines whether or not a sleep restoration instruction has been received from the controller 100 and advances the processing to step S2412 in response to the reception of a sleep restoration instruction. In step S2412, after the reception of the sleep restoration instruction, the power source control unit 106 controls the supply of power to each device inside the image forming apparatus 1 to restore the image forming apparatus 1 from the sleep mode (sleep state).

Thereafter, in step S2413, the CPU 103 determines whether or not to execute the movement processing to move the tray 80 from the stored position to the removal position on the basis of the tray information stored in the non-volatile memory 105. Specifically, the CPU 103 determines to execute the movement processing in a case where the tray information includes information indicating that the tray 80 was located at the removal position before transition to the sleep state and indicating that the movement of the tray 80 to the removal position was performed in accordance with a replacement instruction. The CPU 103 advances the processing to step S2414 according to the determination. On the other hand, in a case where the tray information stored in the non-volatile memory 105 does not include information indicating this, the CPU 103 determines not to execute the movement processing and ends the processing according to the present process.

In step S2414, the CPU 103 executes the movement processing to move the tray 80 from the stored position to the removal position. When the processing to move the tray 80 to the removal position is complete, the processing according to the present process ends.

As described above, the image forming apparatus 1 according to the present embodiment operates so that the tray 80 is returned from the stored position to the removal position upon restoration from the sleep state in a case where the tray 80 was located at the removal position on the basis of a movement instruction (replacement instruction) for the cartridge 70 before transition to the sleep state. Accordingly, the user is able to immediately perform the task of replacing the cartridge 70 after the image forming apparatus 1 is restored from the sleep state.

Note that the image forming apparatus 1 according to the present embodiment executes the movement processing to move the tray 80 from the removal position to the stored position (move the cartridge 70 from the retracted position to the installed position) upon transition to the sleep state. However, similar processing may be executed upon transition to a powered OFF state, for example. Also, the image forming apparatus 1 may operate so that the tray 80 is returned from the stored position to the removal position upon restoration from the powered OFF state in a case where the tray 80 was located at the removal position on the basis of a movement instruction (replacement instruction) for the cartridge 70 before transition to the powered OFF state.

Also, the image forming apparatus 1 according to the present embodiment may operate so that the tray 80 is returned from the stored position to the removal position upon restoration from the sleep state irrespective of whether or not there was a movement instruction (replacement instruction) for the cartridge 70 before transition to the sleep state. In other words, in a case where the tray information indicates that the tray 80 was located at the removal position (the cartridge 70 was located at the retracted position) before the transition to the sleep state, the image forming apparatus 1 determines to execute the movement processing (step S2413) and executes the movement processing to move the tray 80 from the stored position to the removal position (step S2414). In this manner, by moving the tray 80 to the removal position after restoration from the sleep state (moving the cartridge 70 to the retracted position), the need for replacement of the cartridge 70 can be made easier for the user to recognize when using the image forming apparatus 1.

### Seventh Embodiment

Next, the seventh and eighth embodiments according to the present disclosure will be described.

### Configuration relating to Cartridge Replacement

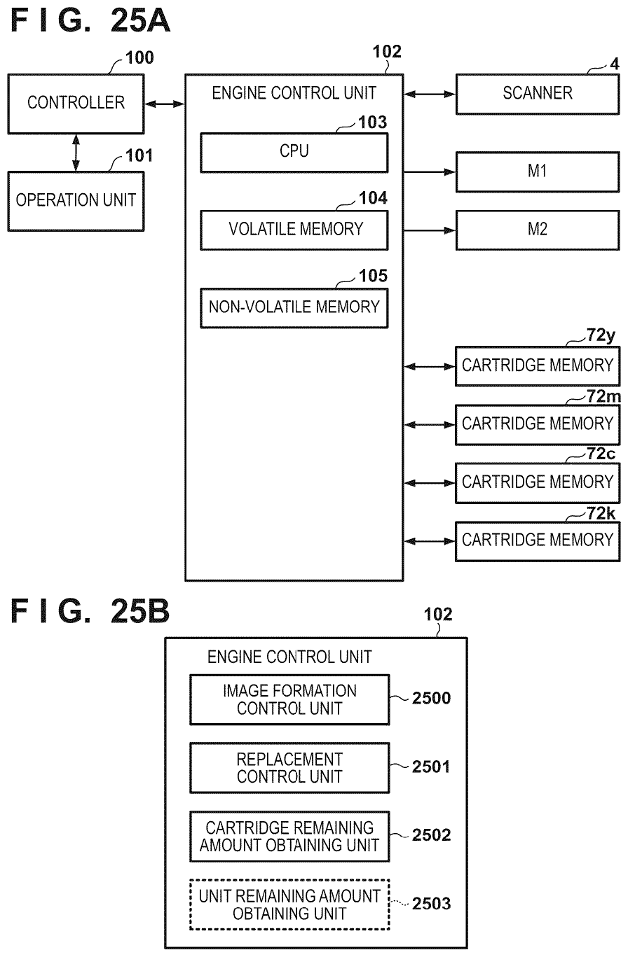

The configuration relating to cartridge replacement in the image forming apparatus 1 will now be described with reference to FIGS. 25A and 25B. FIG. 25A illustrates an example of the control configuration of the image forming apparatus 1. The controller 100 controls the entire image forming apparatus 1. For example, the controller 100 is configured to communicate with a non-illustrated host computer via a network. The host computer may be any information processing apparatus with a communication function such as a personal computer, a tablet, a smartphone, and the like. When the controller 100 receives a print job from the host computer, the controller 100 transmits the image data of the image to be printed to the engine control unit 102 and causes the engine control unit 102 to perform image formation based on the image data.

The operation unit 101 provides a user interface for the user to operate the image forming apparatus 1. For example, the operation unit 101 may be a touch panel. By operating the touch panel, the user can designate one from among the cartridges 70y, 70m, 70c, and 70k, and make an instruction for replacing the designated cartridge 70 to the controller 100. Also, the operation unit 101 may include one or more buttons. In this case, for example, the operation unit 101 may include a button for designating the cartridge to be replaced from among the cartridges 70y, 70m, 70c, and 70k and a button for sending an instruction to the controller 100 for replacement of the designated cartridge. Such buttons may be provided at or near the door 14 of the frame body 16.

In this manner, the controller 100 is configured to receive a replacement instruction for the cartridge 70 via the operation unit 101. The controller 100 may also be configured to receive a replacement instruction for the cartridge 70 from the host computer. When a replacement instruction for the cartridge 70 is received, the controller 100 notifies the engine control unit 102 of the cartridge to be replaced and issues a cartridge replacement instruction. In the present embodiment, the replacement instruction is an example of a movement instruction for the cartridge 70 for moving the cartridge 70 to the retracted position.

The engine control unit 102 controls the members described using FIGS. 1 to 12A and 12B to control forming an image on the sheet S. The engine control unit 102 includes the CPU 103 which is a processor, the volatile memory 104, and the non-volatile memory 105. The CPU 103 controls forming an image on the sheet S and the like by executing a control program stored in the non-volatile memory 105. At this time, the CPU 103 stores temporary information in the volatile memory 104. The non-volatile memory 105 stores various types of control data used by the CPU 103 in the control. The CPU 103 may include one or more processors. Also, in a different configuration, in addition to or instead of the CPU 103, the engine control unit 102 may use an application specific integrated circuit (ASIC).

Note that in FIG. 25A, only the members controlled by the engine control unit 102 that are required in the description of the embodiment are illustrated, and other members are omitted. Specifically, the scanner 4 that forms an electrostatic latent image on the photosensitive drum 2, the motor M1, and the motor M2 are illustrated in FIG. 25A. Note that the motor M1 is a drive source of the rotary body 90. Also, the motor M2 is a drive source of the driving racks 15 (for moving the trays 80 between the stored position and the removal position).

In the present embodiment, the cartridges 70y, 70m, 70c, and 70k are provided with the cartridge memory 72y, 72m, 72c, and 72k, which are non-volatile memory devices. Hereinafter, the cartridge memory 72y, 72m, 72c, and 72k are collectively referred to as the cartridge memory 72. The engine control unit 102 is configured to be able to access the cartridge memory 72 provided in the cartridge 70 in a case where the cartridge 70 is at the installed position. Also, the cartridge memory 72 stores information indicating the initial value T₀ of the remaining amount of toner, the toner amount (hereinafter referred to as the supply amount Tₛᵤₚ) to be supplied to the developing unit 50 in one supply, the toner remaining amount T inside the cartridge 70 at the current time, and the like.

FIG. 25B illustrates an example of the functional configuration of the engine control unit 102. In the present embodiment, the functional blocks illustrated in the same diagram are implemented by the CPU 103 executing a control program. Note that at least a portion of the functional blocks illustrated in the same diagram may be implemented by an ASIC. The engine control unit 102 includes an image formation control unit 2500, a replacement control unit 2501, and a cartridge remaining amount obtaining unit 2502. Also, in the image forming apparatus 1 according to the eighth embodiment described below, the engine control unit 102 further includes a unit remaining amount obtaining unit 2503.

By the image formation control unit 2500 controlling the operations of the various types of members (for example, the scanner 4, the developing unit 50, the fixing device 40, and the like) relating to the image forming operation, the image forming operation of the image forming apparatus 1 is controlled. The image formation control unit 2500 forms an image on the sheet S on the basis of the image data received from the controller 100.

The replacement control unit 2501 controls the processing relating to replacement of the cartridge 70. By controlling the motor M1, the replacement control unit 2501 performs rotation control of the rotary body 90, and by controlling the motor M2, the replacement control unit 2501 performs movement control of the tray 80. During execution of an image forming operation, since the image formation control unit 2500 needs to rotate the rotary body 90 and move the developing rollers 51y, 51m, 51c, and 51k in order to the developing position, replacement of the cartridge 70 cannot be performed. Thus, the image formation control unit 2500 transmits a notification to the replacement control unit 2501 indicating that rotation (posture transition) of the rotary body 90 is allowed in response to the completion of the image forming operation. When the notification is received from the image formation control unit 2500, the replacement control unit 2501 can rotate the rotary body 90 for processing relating to replacement of the cartridge 70.

The cartridge remaining amount obtaining unit 2502 is configured to obtain and manage the toner remaining amount T inside each cartridge 70. In the present embodiment, the cartridge remaining amount obtaining unit 2502 functions as an example of an obtaining unit that obtains the toner remaining amount inside the cartridges. The cartridge remaining amount obtaining unit 2502 manages the toner remaining amount T inside the cartridge 70 at the current time by updating the toner remaining amount T of the cartridge 70 to reduce the toner remaining amount T by the supply amount Tₛᵤₚ, when one supply from the cartridge 70 to the developing unit 50 is performed. Note that the initial value of the toner remaining amount T is T₀. The cartridge remaining amount obtaining unit 2502 manages the toner remaining amount T inside each cartridge 70 with the toner remaining amount T stored in the corresponding cartridge memory 72.

Here, “one supply” from the cartridge 70 to the developing unit 50 may be defined as follows. In the image forming apparatus 1 according to the present embodiment, toner is supplied to the developing unit 50 from the cartridge 70 in a time period in which the cartridge 70 is located above the developing unit 50 within the time period of one rotation of the rotary body 90. In the present specification, “one supply” may be defined as supply via one rotation of the rotary body 90. Thus, when the rotary body 90 rotates n number of times (n being an integer of 1 or more), supply is performed n number of times. In this case, the supply amount Tₛᵤₚ corresponds to the decreased amount of the toner remaining amount of the cartridge 70 after one rotation of the rotary body 90.

Note that the toner amount supplied from the cartridge 70 to the developing unit 50 may be different depending on how the rotary body 90 is rotated one time. For example, while developing of an electrostatic latent image is being performed using toner of a certain color (first color), the rotation of the rotary body 90 is stopped at the developing posture for the cartridge 70 containing the first color toner. When the developing of the first color ends, to perform developing of the next color (second color), the rotation is driven until the rotary body 90 is put in the developing posture for the cartridge 70 containing the second color toner. In this manner, the rotary body 90 is not rotationally driven at a constant speed and is intermittently rotationally driven. Thus, the amount of toner supplied from the cartridge 70 to the developing unit 50 may be different depending on the rotationally driven time period and the non-rotationally-driven time period. Also, the toner amount supplied to the developing unit 50 may change depending on the rotational speed of the rotary body 90. Thus, in the present embodiment, the supply amount Tₛᵤₚ may be defined as the toner amount supplied from the cartridge 70 to the developing unit 50 after one rotation of the rotary body 90 using a predetermined mode. Here, one rotation of the rotary body 90 using a predetermined mode means one rotation of the rotary body 90 according to a predefined rotational speed and a predetermined rotational drive stopping timing and stopping period.

Also, even in the time period in which the cartridge 70 is located above the developing unit 50, the amount of toner supplied from the cartridge 70 to the developing unit 50 may be different depending on the relative position (direction) of the cartridge 70 with respect to the developing unit 50. For example, when the developing unit 50 is located at a predetermined position with respect to the cartridge 70, the amount of toner supplied to the developing unit 50 is a maximum amount. In a case where the maximum amount is a much larger amount than the toner amount supplied to the developing unit 50 when the developing unit 50 is located at another position, the predetermined value can be defined as the “supply position”. In this case, “one supply” may be also defined as the supply when the cartridge 70 passes the supply position via rotation of the rotary body 90.

Note that, for example, in a case where the engine control unit 102 can electrically control the opening and closing of the receiving opening 53b via a non-illustrated sealing member that covers the receiving opening 53b of the developing unit 50, the engine control unit 102 can control the supply by controlling the receiving opening 53b. In other words, the engine control unit 102 can supply toner to the developing unit 50 by controlling the sealing member and putting the receiving opening 53b in an open state only in a time period in which the cartridge 70 is above the developing unit 50 and located in a direction of a predetermined range with respect to the developing unit. “One supply” in this case may be defined as supply that is performed from when the receiving opening 53b is put in an open state by the engine control unit 102 until the receiving opening 53b is put in a closed state.

### Processing Procedure

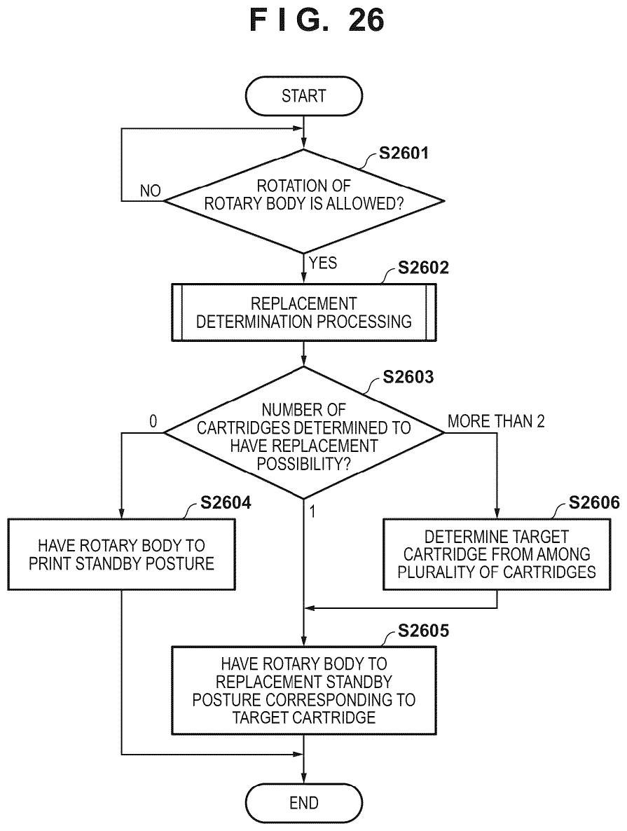

FIG. 26 is a flowchart illustrating an example of the process of posture control of the rotary body 90 relating to cartridge replacement in the image forming apparatus 1 according to the present embodiment. The processing according to the present process is executed in a period in which a toner image has not been formed on the photosensitive drum 2 and is executed, for example, in response to the completion of the formation of a toner image based on a print job.

In step S2601, the CPU 103 (replacement control unit 2501) determines whether or not rotation of the rotary body 90 (posture transition) is allowed. As described above, when the image forming operation is complete, a notification indicating that rotation (posture transition) of the rotary body 90 is allowed is sent from the image formation control unit 2500 to the replacement control unit 2501. In this manner, rotation of the rotary body 90 is allowed, and the rotary body 90 can be rotated for the processing relating to replacement of the cartridge 70. When rotation of the rotary body 90 is allowed, the CPU 103 (replacement control unit 2501) advances the processing to step S2602.

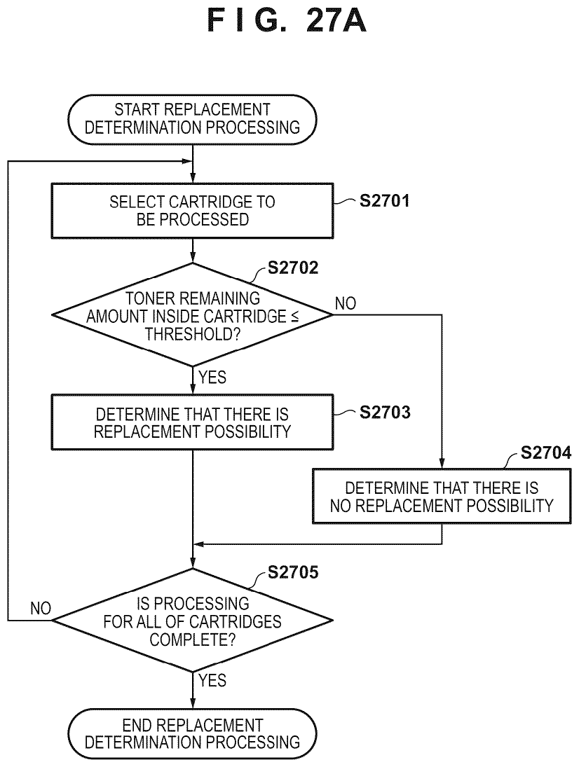

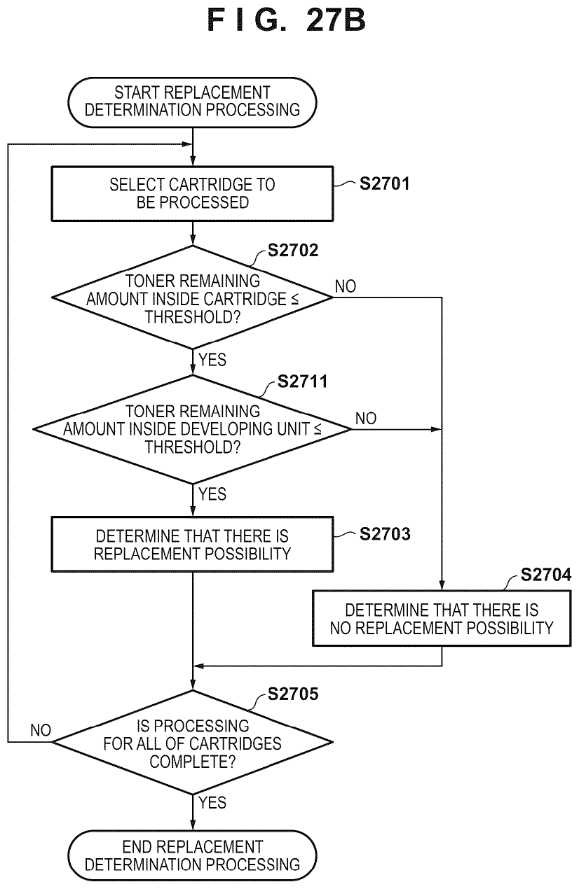

Next, in step S2602, the CPU 103 (replacement control unit 2501) executes replacement determination processing to determine, from among the plurality of cartridges 70, a cartridge that has a possibility of being replaced by the user before the next image formation instruction is received from the controller 100. In the present embodiment, the CPU 103 executes the replacement determination processing via the process illustrated in FIG. 27A.

First, in step S2701, the CPU 103 selects the plurality of cartridges 70 one at a time in order as the cartridge to be processed (selected cartridge). Next, in step S2702, the CPU 103 compares the toner remaining amount of the selected cartridge and the threshold managed by the cartridge remaining amount obtaining unit 2502. The threshold, for example, is stored in the cartridge memory 72 of the cartridge 70 to be determined or the non-volatile memory 105 of the engine control unit 102.

In a case where the toner remaining amount is equal to or less than the threshold, the CPU 103 advances the processing from step S2702 to step S2703. In step S2703, the CPU 103 generates a determination result indicating the possibility of replacement for the selected cartridge (or high replacement possibility) and advances the processing to step S2705. On the other hand, in a case where the toner remaining amount is not equal to or less than the threshold (greater than the threshold), the CPU 103 advances the processing from step S2702 to step S2704. In step S2704, the CPU 103 generates a determination result indicating no possibility of replacement for the selected cartridge (or low replacement possibility) and advances the processing to step S2705.

In step S2705, in a case where the processing for all of the plurality of cartridges 70 is complete, the CPU 103 ends the replacement determination processing and advances the processing to step S2603. On the other hand, in a case where the cartridge 70 for which processing is not complete remains, the CPU 103 returns the processing to step S2701 and selects the next cartridge 70 to be processed to repeat the processing described above for all of the cartridges 70 (the four cartridges 70).

After the replacement determination processing is complete, in step S2603, in a case where the number of cartridges 70 determined to have a replacement possibility is zero (none of the cartridges 70 have been determined to have replacement possibility), the CPU 103 advances the processing to step S2604. In step S2604, the CPU 103 controls the motor M1 and rotates the rotary body 90 to prepare for reception of the next image formation instruction and to put the rotary body 90 is a predetermined print standby posture. When the rotary body 90 rotates to the print standby posture and stops, the CPU 103 ends the processing according to the present process.

The print standby posture of the rotary body 90 is a standby posture for starting an image forming operation when the engine control unit 102 receives the next image formation instruction from the controller 100. For example, the print standby posture is predetermined as the developing posture initially assumed by the rotary body 90 (in other words, the yellow developing posture) in the case of forming a color image. Alternatively, the print standby posture may be set as the cyan replacement posture (replacement posture for the cartridge 70c), which is the closest replacement posture to the yellow developing posture in the arrow direction (clockwise direction) of FIG. 1 in order to prevent wear on the developing roller 51.

Also, in a case where the number of cartridges 70 determined to have a replacement possibility is one, the CPU 103 advances the processing from step S2603 to step S2605. In this case, the CPU 103 sets the one cartridge 70 determined to have a replacement possibility as the cartridge (target cartridge) that is the target of the processing of step S2605. In step S2605, the CPU 103 executes processing to rotate the rotary body 90 to approach the replacement posture of the target cartridge and rotate the rotary body 90 until it is in the replacement standby posture (in other words, processing to move the target cartridge to the replacement standby position).

The replacement standby posture corresponding to the target cartridge corresponds to the posture of the rotary body 90 in a case where the target cartridge is located at the replacement standby position. The replacement standby position is predetermined as the position where the target cartridge is at standby in preparation for replacement of the target cartridge to be instructed by the user. In other words, the replacement standby posture is predetermined as the posture where the rotary body 90 is at standby in preparation for replacement of the target cartridge to be instructed by the user (a movement instruction for the target cartridge to be received).

In the present embodiment, for example, the replacement standby position corresponding to the movement destination of the target cartridge in step S2605 is set as the replacement position for replacing the target cartridge. In other words, the replacement standby posture corresponding to the target cartridge is set as the replacement posture for the target cartridge. The replacement position corresponds to the position of the cartridge 70 when the rotary body 90 assumes the replacement posture for replacing the cartridge 70 to be replaced. In a case where there is an instruction to replace the cartridge 70 at the replacement position, the CPU 103 executes processing to control the motor M2 and move the tray 80 in which the cartridge 70 is installed from the stored position to the removal position. Accordingly, the cartridge 70 can be moved from the installed position to the retracted position so that the cartridge 70 can be replaced. As in the present example, by the cartridge 70 with a replacement possibility being put on standby in advance at the replacement position before there is a replacement instruction from the user, the user can perform the replacement task with a short waiting time from when the replacement instruction is issued.

Also, the replacement standby position may be set to a position that is different from the replacement position described above. In other words, the replacement standby posture corresponding to the target cartridge may be set to a posture that is different from the replacement position of the target cartridge. The replacement standby position may be set so that the rotation angle of the rotary body 90 for moving the target cartridge to the replacement position (rotating the rotary body 90 to the replacement posture for the target cartridge) can be further decreased, in a case where there is an instruction to replace the target cartridge. For example, the replacement standby position may be set to a position where the rotation angle of the rotary body 90 for moving the target cartridge to the replacement position is equal to or less than a predetermined angle. At the time of cartridge replacement, in a case where the rotary body 90 can be rotated in both directions (the arrow direction in FIG. 1 and the reverse direction), the predetermined angle may be set to 90 degrees, for example. Also, at the time of cartridge replacement, in a case where the rotary body 90 can only be rotated in one direction (only the arrow direction in FIG. 1), the predetermined angle may be set to 90 degrees or 180 degrees, for example.

In a case where there is an instruction to replace the cartridge 70 at the replacement standby position, the CPU 103 executes processing to control the motor M1 and rotate the rotary body 90 to move the target cartridge from the replacement standby position to the replacement position. Also, the CPU 103 executes processing to control the motor M2 and move the tray 80 in which the cartridge 70 is installed from the stored position to the removal position. Accordingly, the cartridge 70 can be moved from the installed position to the retracted position so that the cartridge 70 can be replaced. As in the present example, by the cartridge 70 with a replacement possibility being put on standby in advance at the replacement standby position before there is a replacement instruction from the user, the rotation angle of the rotary body 90 for replacing the cartridge can be decreased. In this manner, the user can perform the replacement task in a short waiting time from when the replacement instruction is issued.

In step S2605, the CPU 103 controls the motor M1 and rotates the rotary body 90 to move the target cartridge to the replacement standby position. In other words, the CPU 103 rotates the rotary body 90 to approach the replacement posture for the target cartridge and rotates the rotary body 90 until it is in the replacement standby posture. When the target cartridge is stopped at the replacement standby position (the rotary body 90 stops at the replacement standby posture), the CPU 103 ends the processing according to the present process.

Also, in a case where the number of cartridges 70 determined to have a replacement possibility is two or more, the CPU 103 advances the processing from step S2603 to step S2606. In step S2606, the CPU 103 executes processing to determine the target cartridge to set as the target of the processing to move to the replacement standby position from among the two or more (plurality of) cartridges 70 with a replacement possibility (in other words, to determine which replacement standby posture corresponding to which cartridge from among the plurality of cartridges 70 to put the rotary body 90 in).

In the present embodiment, in a case where there is a replacement instruction for all of the plurality of cartridges 70 with a replacement possibility, replacement of the target cartridge (cartridge standing by at the replacement standby position) is first performed. Thereafter, replacement of each cartridge 70 is performed in the arrival order of the cartridges 70 to be replaced at the replacement position as the rotary body 90 rotates. Here, in the determination processing of step S2606, the target cartridge is determined from among the plurality of cartridges 70 so that the total rotation angle of the rotary body 90 when replacement is performed for all of the plurality of cartridges 70 with a replacement possibility is made the minimum. Specifically, so as to minimize the total rotation angle of the rotary body 90 when the rotation of the rotary body 90 is started at the replacement standby posture corresponding to one of the plurality of cartridges and the rotary body 90 is rotated to sequentially arrive at each replacement posture corresponding to the plurality of cartridges, the CPU 103 determines which standby posture corresponding to which cartridge from among the plurality of cartridges to put the rotary body 90 in.

As described above, in this example it is assumed that the replacement standby position is set to the replacement position. For example, in a case where the rotary body 90 is at the replacement posture (FIG. 4B) of the cartridge 70k, the cartridge 70k is at the replacement position. In a case where the rotary body 90 is rotated from the replacement posture in the arrow direction (clockwise direction) of FIG. 1, each time the rotary body 90 is rotated 90 degrees, the replacement positions of the cartridges 70y, 70m, 70c, and 70k are reached in this order. For this example, let's assume that it is determined that the three cartridges 70y, 70m, and 70k have a replacement possibility. In the case of replacing all of the three cartridges, if the cartridge 70k is set as the target cartridge, then replacement is performed in order from the cartridge 70k, 70y, and then 70m. In this case, the total rotation angle of the rotary body 90 for making the three cartridges arrive at the replacement position in order is 180 degrees. On the other hand, in a case where the cartridge 70y or 70m is set as the target cartridge, the total rotation angle of the rotary body 90 for making the three cartridges arrive at the replacement position in order is 270 degrees. Thus, in the present example, the cartridge 70k is determined as the target cartridge in order to minimize the total rotation angle of the rotary body 90.

In step S2606, after the target cartridge is determined, the CPU 103 advances the processing to step S2605. In step S2605, the CPU 103 controls the motor M1 and rotates the rotary body 90 to move the target cartridge to the replacement standby position. When the target cartridge is stopped at the replacement standby position, the CPU 103 ends the processing according to the present process. In this manner, in a case where there is an instruction to replace all of the plurality of cartridges 70 with a replacement possibility, the user can perform the replacement task in a short waiting time.

Note that in the determination processing of step S2606, for example, the cartridge 70 with the smallest toner remaining amount T from among the plurality of cartridges 70 determined to have a replacement possibility may be determined as the target cartridge. In other words, in a case where a plurality of the cartridges are determined to have the toner remaining amount T of equal to or less than the threshold, the CPU 103 may put the rotary body 90 in the replacement standby posture corresponding to the cartridge with the smallest toner remaining amount T from among the plurality of cartridges. Thus, the cartridge 70 with the smallest toner remaining amount T can be said to be the cartridge with the highest possibility of receiving a replacement instruction from the user. Thus, in a case where there is an instruction to replace the target cartridge, the user can perform the replacement task in a short waiting time.

As described above, the image forming apparatus 1 according to the present embodiment includes the rotary body 90 (rotary) that can rotate. The rotary body 90 includes the containing portion (the developing side containing portion 53a) that contains toner supplied from the cartridge 70 and the developing member (the developing roller 51) that develops the electrostatic latent image formed on the photosensitive member (photosensitive drum 2) using the toner contained in the containing portion. The moving device 85 is configured to, in a case where the rotary body 90 is in the replacement posture, move the cartridge 70 from the installed position where the cartridge 70 is located inside the rotary body 90 to the retracted position where the cartridge 70 is located outside the rotary body 90. In a case where a movement instruction (replacement instruction) for the cartridge 70 is received, the replacement control unit 2501 (engine control unit 102) rotates the rotary body 90 to the replacement posture and further causes the cartridge 70 to move from the installed position to the retracted position. The cartridge remaining amount obtaining unit 2502 obtains the toner remaining amount T inside the cartridge 70. In a case where the obtained result of the toner remaining amount T satisfies the predetermined condition, the replacement control unit 2501 executes processing to rotate the rotary body 90 to approach the replacement posture and rotate the rotary body 90 to the standby posture.

In this manner, in the image forming apparatus 1 according to the present embodiment, the cartridge 70 for which an obtained result of the toner remaining amount T satisfies the predetermined condition (the cartridge with a possibility of being replaced) is moved to the replacement standby position before an instruction to replace the cartridge 70 is issued. Specifically, the replacement control unit 2501 rotates the rotary body 90 to the replacement standby posture corresponding to the cartridge 70 for which the obtained result of the toner remaining amount T satisfies the predetermined condition. The predetermined condition is, for example, that the toner remaining amount T is equal to or less than a threshold. The replacement standby position is set so that the rotation angle that the rotary body 90 rotates through from the replacement standby position to the replacement position is equal to or less than 90 degrees.

Accordingly, in a case where a replacement instruction (movement instruction) is received for the cartridge 70 in the replacement standby position, the amount of time required to move the cartridge 70 from the replacement standby position to the replacement position via rotation of the rotary body 90 can be reduced. Thus, in a case where the cartridge 70 in the image forming apparatus 1 needs to be replaced, the user can perform the replacement task in a short waiting time from when the replacement instruction (movement instruction) is issued. Thus, according to the present embodiment, in a case where a cartridge in the image forming apparatus needs to be replaced, the amount of waiting time until the user can perform the replacement task can be reduced.

### Eighth Embodiment

Next, an eighth embodiment will be described, focusing on the points that differ from the seventh embodiment.

As illustrated in FIG. 25B, in the image forming apparatus 1 according to the present embodiment, the engine control unit 102 further includes the unit remaining amount obtaining unit 2503. The unit remaining amount obtaining unit 2503 is configured to manage the toner remaining amount D inside the developing unit 50. The unit remaining amount obtaining unit 2503 is implemented by the CPU 103 executing a control program. Note that the unit remaining amount obtaining unit 2503 may be implemented using an application specific integrated circuit (ASIC) instead of the CPU 103.

The unit remaining amount obtaining unit 2503 is configured to obtain and manage the toner remaining amount D inside the developing unit 50. The toner remaining amount D inside the developing unit 50 is managed by the unit remaining amount obtaining unit 2503 as follows, for example. The engine control unit 102, at the time of image formation, transmits a laser drive signal for driving the laser of the scanner 4 to the scanner 4. The laser drive signal, for example, is a pulse width modulation signal (PWM). While the laser drive signal is at the high level, the scanner 4 emits laser light and exposes the photosensitive drum 2, while the laser drive signal is at the low level, the scanner 4 does not emit laser light and thus the photosensitive drum 2 is not exposed. Note that toner adheres to the region of the photosensitive drum 2 exposed by the laser light, and toner does not adhere to the region of the photosensitive drum 2 that is not exposed by the laser light. Thus, by counting the number of pulses corresponding to the number of high levels of the laser drive signal in the time period during which the laser light is emitted at the photosensitive drum 2, a toner consumption amount C used in image formation can be determined. The unit remaining amount obtaining unit 2503 determines the toner consumption amount C using in image formation in this manner.

The unit remaining amount obtaining unit 2503 can manage the toner remaining amount D inside the developing unit 50 by increasing the toner remaining amount D inside the developing unit 50 by the supply amount Tₛᵤₚ, when one supply is performed from the cartridge 70 to the developing unit 50 and decreasing the toner remaining amount D inside the developing unit 50 by the toner consumption amount C each time image formation is performed. Note that the initial value of the toner remaining amount D inside the developing unit 50 is 0, for example.

Also, the unit remaining amount obtaining unit 2503 may be configured to manage the toner remaining amount D by measuring the toner remaining amount D of the developing unit 50. For example, by measuring the capacitance between the supplying roller 52 and the developing roller 51, the toner remaining amount D of the developing unit 50 can be estimated. The capacitance between the supplying roller 52 and the developing roller 51 can be measured by applying an AC voltage to the supplying roller 52 and detecting the voltage induced in the developing roller 51 in a state where the supplying roller 52 and the developing roller 51 are separated. Alternatively, two electrodes provided for dedicated use in measuring the toner remaining amount D of the developing unit 50 can be provided, and the toner remaining amount D of the developing unit 50 can be measured on the basis of the capacitance between the two electrodes determined by applying a voltage across the two electrodes.

In the present embodiment, as in the seventh embodiment, the CPU 103 performs posture control of the rotary body 90 relating to cartridge replacement by executing the processing via the process illustrated in FIG. 26. However, in the present embodiment, the CPU 103 executes the replacement determination processing of step S2602 via the process illustrated in FIG. 27B.

Steps S2701 and S2702 are similar to those in the seventh embodiment (FIG. 27A). In step S2702, in a case where the toner remaining amount is equal to or less than the threshold (first threshold), the CPU 103 (replacement control unit 2501) advances the processing to step S2711. In step S2711, the CPU 103 compares the threshold (second threshold) to the toner remaining amount inside the developing unit 50 (developing side containing portion 53a) supplied with toner from the selected cartridge managed by the unit remaining amount obtaining unit 2503. The threshold, for example, is stored in the cartridge memory 72 of the cartridge 70 to be determined or the non-volatile memory 105 of the engine control unit 102.

In a case where the toner remaining amount inside the developing unit 50 is equal to or less than the threshold, the CPU 103 advances the processing from step S2711 to step S2703. In step S2703, the CPU 103 generates a determination result indicating the possibility of replacement for the selected cartridge (or high replacement possibility) and advances the processing to step S2705. On the other hand, in a case where the toner remaining amount inside the developing unit 50 is not equal to or less than the threshold (greater than the threshold), the CPU 103 advances the processing from step S2711 to step S2704. In step S2704, the CPU 103 generates a determination result indicating no possibility of replacement for the selected cartridge (or low replacement possibility) and advances the processing to step S2705.

In step S2705, in a case where the processing for all of the plurality of cartridges 70 is complete, the CPU 103 ends the replacement determination processing and advances the processing to step S2603. On the other hand, in a case where the cartridge 70 for which processing is not complete remains, the CPU 103 returns the processing to step S2701 and selects the next cartridge 70 to be processed to repeat the processing described above for all of the cartridges 70 (the four cartridges 70).

In this manner, when the toner remaining amount inside the selected cartridge is equal to or less than the first threshold and the toner remaining amount inside the developing unit 50 is equal to or less than the second threshold, the engine control unit 102 determines that there is a possibility (or a high possibility) of the selected cartridge being replaced (step S2703). On the other hand, even if the toner remaining amount inside the selected cartridge is equal to or less than the first threshold, in a case where the toner remaining amount inside the developing unit 50 is not equal to or less than the second threshold, the engine control unit 102 determines that there is no possibility (or a low possibility) of the selected cartridge being replaced (step S2704). Using such a determination, the possibility of the cartridge 70 being replaced can be more accurately determined. On the basis of such a determination result, the target cartridge can be moved to the replacement standby position before there is a replacement instruction for the cartridge 70, and in a case where there is an instruction to replace the target cartridge, the user can perform the replacement task in a short waiting time.

### Ninth Embodiment

Next, the ninth to eleventh embodiments according to the present disclosure will be described.

### Toner Cartridge Movement Determination

First, control performed by the image forming apparatus 1 to determine whether or not to move the toner cartridge 70 will be described. In a case where there is an instruction from the user to the image forming apparatus to move the toner cartridge 70 to the retracted position, preferably, whether or not to move the toner cartridge 70 is determined depending on the operation status of the image forming apparatus. In a case where a movement instruction for the toner cartridge 70 is received during an image forming operation, the image forming apparatus according to the present embodiment determines whether to continue the image forming operation or to stop the image forming operation and move the toner cartridge 70 to the retracted position.

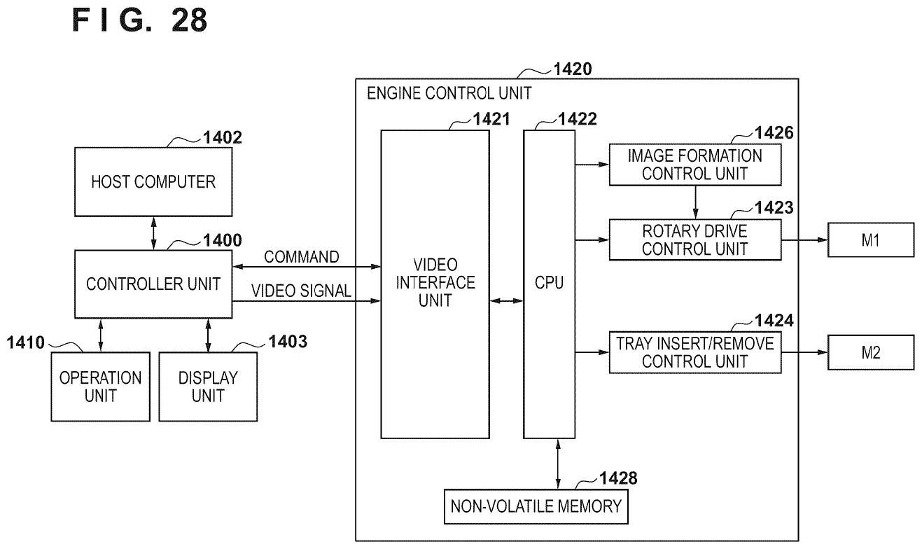

The control configuration of the image forming apparatus will now be described. FIG. 28 is a block diagram illustrating the control configuration of the image forming apparatus according to the present embodiment. The image forming apparatus includes a controller unit 1400, an operation unit 1410, a display unit 1403, a host computer 1402, and an engine control unit 1420. The engine control unit 1420 includes a video interface unit 1421, a CPU 1422, a rotary drive control unit 1423, a tray insert/remove control unit 1424, and a non-volatile memory 1428.

Control at the time when an image forming operation is performed will now be described. When print data is received from the host computer 1402, the controller unit 1400 converts the print data into image data. After the print data is converted into image data, the controller unit 1400 instructs the CPU 1422 to start printing via the video interface unit 1421. The CPU 1422, having received a start printing instruction, transmits a start printing instruction to an image formation control unit 1426. The image formation control unit 1426, having received a start printing instruction, controls the members involved with an image forming operation on the basis of the start printing instruction. For example, the image formation control unit 1426 transmits an instruction to the rotary drive control unit 1423 to make the rotary body 90 transition posture during an image forming operation. The rotary drive control unit 1423, having received the instruction, drives the motor M1 and causes the posture of the rotary body 90 to transition to the developing posture, and then the image forming operation is performed.

Note that before the image forming operation is performed, the engine control unit 1420 executes preprocessing. Preprocessing is a preparatory operation required for performing image forming operations including activating the motor M3, heating the fixing device 40, moving the rotary body 90 to the developing posture, and the like. After the preprocessing is complete, the engine control unit 1420 performs the image forming operation.

Note that the image forming apparatus 1 performs pre-multiple-rotations as the preparatory operation performed at the time of powering on or restoration from the sleep state.

Next, control relating to the replacement of the toner cartridge 70 will be described. In this example, control in the case of replacing the toner cartridge 70y will be described, but the present description also applies to the toner cartridges 70m, 70c, and 70k.

In the case of replacing the toner cartridge 70y, the user transmits a toner cartridge replacement request to the controller unit 1400 via the operation unit 1410. In other words, the operation unit 1410 is an input unit where a movement instruction (information) for the toner cartridge 70 can be input. The operation unit 1410 may be configured as an input button (for example, the buttons 19y, 19m, 19c, and 19k and the button 191 illustrated in FIG. 14). The movement instruction is an instruction to move the toner cartridge 70 from the installed position to the retracted position or an instruction to move the toner cartridge 70 from the retracted position to the installed position. In a case where the toner cartridge 70 is located at the installed position and a movement instruction is input to the operation unit 1410, the toner cartridge 70 is moved from the installed position to the retracted position. On the other hand, in a case where the toner cartridge 70 is located at the retracted position and a movement instruction is input to the operation unit 1410, the toner cartridge 70 is moved from the retracted position to the installed position.

The operation unit 1410 input with the movement instruction transmits the movement instruction to the controller unit 1400. When the movement instruction is received from the operation unit 1410, the controller unit 1400 transmits a movement instruction command to the CPU 1422 via the video interface unit 1421.

When the movement instruction command is received, the CPU 1422 controls the rotary drive control unit 1423, and the rotary drive control unit 1423 controls the rotary body 90 so that the rotary body 90 is moved to the replacement posture. After the rotary body 90 arrives at the replacement posture, the CPU 1422 controls the tray insert/remove control unit 1424, and the tray insert/remove control unit 1424 starts the tray removing operation. Specifically, the tray insert/remove control unit 1424 drives the motor M2. The moving device 85 is driven as the motor M2 is driven, and when the moving device 85 is driven, the tray 80y moves from the stored position to the removal position. As the tray 80y moves from the stored position to the removal position, the toner cartridge 70y moves from the installed position to the retracted position.

The user replaces the toner cartridge 70y located at the retracted position and inputs a movement instruction on the operation unit 1410 again. The operation unit 1410 input with the movement instruction transmits the movement instruction to the controller unit 1400. When the movement instruction is received from the operation unit 1410, the controller unit 1400 transmits a movement instruction command to the CPU 1422 via the video interface unit 1421. When the movement instruction command is received, the CPU 1422 controls the tray insert/remove control unit 1424, and the tray insert/remove control unit 1424 starts the tray inserting operation.

The tray insert/remove control unit 1424 drives the motor M2, and the moving device 85 is driven as the motor M2 is driven. By driving the moving device 85, the tray 80y is moved from the removal position to the stored position. As the tray 80y moves from the removal position to the stored position, the toner cartridge 70y moves from the retracted position to the installed position.

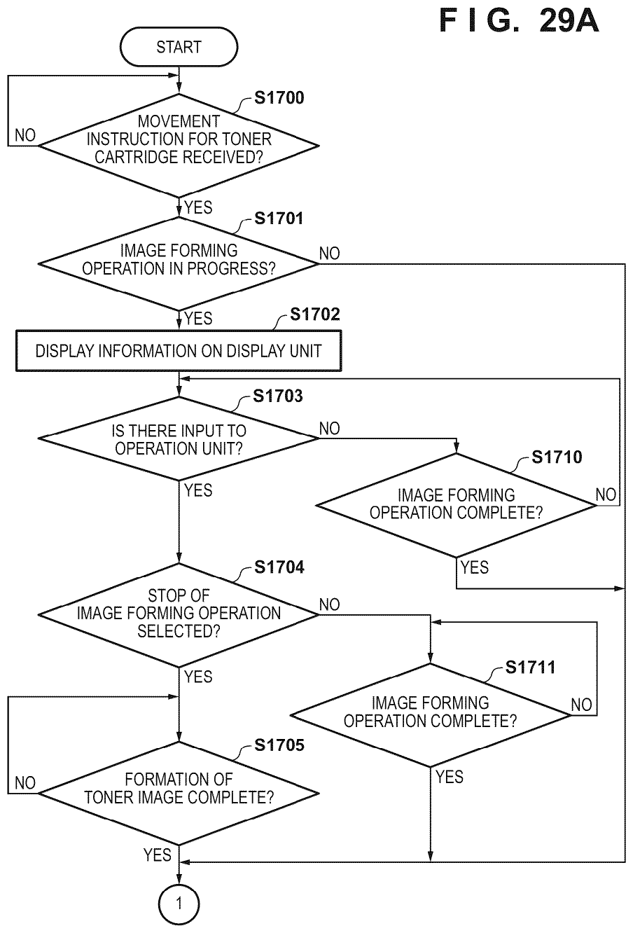

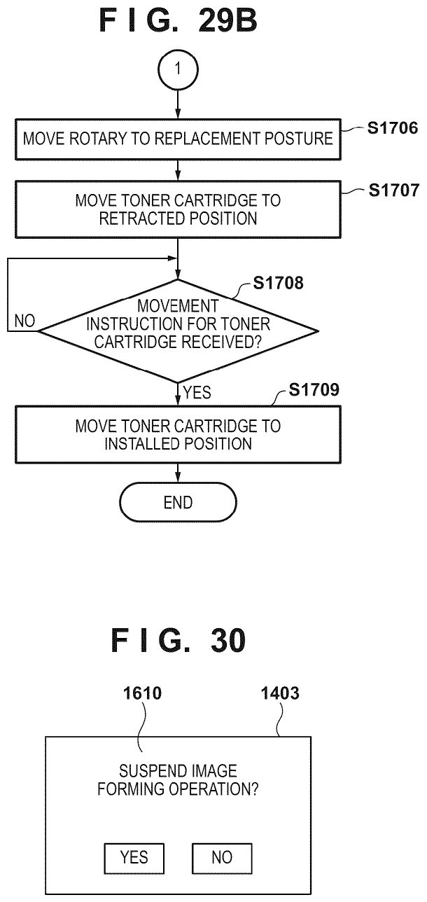

Next, control in the case of receiving a movement instruction for the toner cartridge 70 during an image forming operation will be described using FIGS. 29A, 29B and 30. FIGS. 29A and 29B are flowcharts for describing control according to the present embodiment. FIG. 30 is a diagram illustrating an example of a display screen of the display unit 1403.

Note that the control system including the controller unit 1400 and the engine control unit 1420 is referred to as a printer control unit in the following description. In other words, the printer control unit is a control unit that controls the image forming apparatus.

Control in the case of receiving a movement instruction for the toner cartridge 70 during an image forming operation will now be described using FIGS. 29A and 29B. Before a movement instruction for the toner cartridge 70 is received, the toner cartridge 70 is located at the installed position. In a case where a movement instruction for the toner cartridge 70 is received (YES in step S1700), the engine control unit 1420 checks whether an image forming operation is in progress for the image forming apparatus 1. In a case where an image forming operation is not in progress (NO in step S1701), the engine control unit 1420 moves the rotary body 90 to the replacement posture by rotating the rotary body 90 (step S1706). Thereafter, the toner cartridge 70 is moved from the installed position to the retracted position (step S1707). After the toner cartridge 70 is moved to the retracted position, the user can replace the toner cartridge 70. After the toner cartridge 70 is moved to the retracted position, in a case where the engine control unit 1420 receives a movement instruction for the toner cartridge 70 again via the operation unit 1410 (YES in step S1708), the engine control unit 1420 moves the toner cartridge 70 to the installed position (step S1709).

In a case where an image forming operation is in progress in the image forming apparatus (NO in step S1701), the printer control unit controls the display unit 1403 so that the display unit 1403 displays information (a notification) for checking whether or not to stop the image forming operation (step S1702). The display unit 1403 is a unit including a screen that can display information and may be a display. For example, the display unit 1403 displays message (information) 1610 illustrated in FIG. 30. FIG. 30 illustrates a screen displayed by the display unit 1403. The display unit 1403 displays the information 1610. The information 1610 includes information for checking whether or not to stop the image forming operation. To suspend the image forming operation, the user inputs “YES”, and to not suspend the image forming operation, the user inputs “NO”. Note that “YES” can be input by a single press of a button of the operation unit 1410 and “NO” can be input by consecutively pressing the button twice.

After the information 1610 is displayed, in a case where there is no input via the operation unit 1410 from the user (NO in step S1703), the printer control unit determines whether or not the image forming operation is complete (step S1710). In a case where the image forming operation is not complete, to wait for input from the user, step S1703 is returned to (NO in step S1710). In a case where the operation of the image forming apparatus is complete (YES in step S1710), step S1706 is proceeded to.

In a case where a selection of whether or not to stop the image forming operation is input from the operation unit 1410 (YES in step S1703), the printer control unit determines whether stopping the image forming operation has been selected (step S1704). In a case where stopping the image forming operation has not been selected (NO in step S1704), the engine control unit 1420 waits for the completion of the image forming operation (step S1711). In a case where the operation of the image forming apparatus is complete (YES in step S1711), step S1706 onward is proceeded to. In other words, after the display unit 1403 displays the notification, in a case where there is an input to continue the image forming operation from the operation unit 1410, the printer control unit, after the image forming operation is complete, controls the movement apparatus to move the toner cartridge 70 from the installed position to the retracted position. Note that as described above, performing secondary transfer onto a printing material and discharging the printing material from inside of the image forming apparatus to the outside can be referred to as completing the image forming operation.

In a case where stopping the image forming operation is selected (YES in step S1704), the in-progress operation to transfer onto the intermediate transfer belt 10a is not stopped and completion is awaited for (step S1705). After the in-progress operation to transfer onto the intermediate transfer belt 10a is complete, the transfer operation for the next color is not started, and step S1706 onward is proceeded to. For example, in the case of the yellow transfer operation being in progress, the printer control unit does not start the magenta transfer operation after the yellow transfer operation is complete. The printer control unit moves the rotary body 90 to the replacement posture after the yellow transfer operation is complete. In other words, after the display unit 1403 displays the notification, in a case where there is an input to stop the image forming operation from the operation unit 1410, the printer control unit stops the image forming operation.

In the following description, the status in which the toner cartridge is located at the installed position and the printer control unit receives a movement instruction while the image forming apparatus 1 is performing an image forming operation is referred to as a first status. In other words, in an image forming operation according to the present embodiment, in a case where the first status has occurred and the printer control unit determines that the predetermined condition has been satisfied, the printer control unit stops the image forming operation. Also, after the image forming operation is stopped, the printer control unit controls the moving device to move the toner cartridge 70 from the installed position to the retracted position. Also, after the toner cartridge 70 is again moved from the retracted position to the installed position (step S1709), the printer control unit resumes the stopped image forming operation.

Note that in the flow of step S1706 according to the present embodiment, when the image forming apparatus 1 is executing post-processing, the rotary body 90 is moved to the replacement posture. By moving the rotary body 90 to the replacement posture during post-processing, the amount of time the user spends replacing the toner cartridge 70 can be reduced compared to when the toner cartridge 70 is moved to the replacement posture after post-processing.

As described above, in a case where a movement instruction for the toner cartridge 70 is received, the printer control unit controls the moving device 85 to move the toner cartridge 70 from the installed position to the retracted position. In other words, when the first status occurs, the printer control unit controls the moving device 85 to move the toner cartridge 70 from the installed position to the retracted position after the image forming operation is complete. With this configuration, the image forming operation can be performed before the movement of the toner cartridge 70.

However, in the present embodiment, in a case where a movement instruction is received, the printer control unit displays information for checking whether or not to stop the image forming operation on the display unit 1403 and requests that the user make a determination. With this configuration, control can be performed in accordance with the priority decided by the user.

For example, in a case where stopping the image forming operation has not been selected (NO in step S1704), the engine control unit 1420 waits for the completion of the image forming operation (step S1711). Stopping of the image forming operation not being selected can be said to mean that the image forming apparatus does not satisfy the predetermined condition. In other words, in a case where the first status has occurred and the image forming apparatus does not satisfy the predetermined condition, the control unit controls the moving device to move the toner cartridge 70 from the installed position to the retracted position after the image forming operation is complete.

Also in a case where the first status has occurred, the printer control unit rotates the rotary body 90 and puts it in the replacement posture after the transfer operation on the intermediate transfer belt 10a is complete. Specifically, the printer control unit, during post-processing, rotates the rotary and puts the rotary in the replacement posture. After the rotary body 90 is in the replacement posture, the printer control unit controls the moving device 85 to move the toner cartridge 70 from the installed position to the retracted position. After the toner cartridge 70 is moved to the retracted position and then after the toner cartridge 70 is moved from the retracted position to the installed position, the printer control unit resumes the stopped image forming operation.

### Tenth Embodiment

According to the configuration of the ninth embodiment described above, in a case where a movement instruction for the toner cartridge is received during an image forming operation, the printer control unit determines whether or not to stop the image forming operation and move the toner cartridge to the retracted position on the basis of a user determination.

According to the configuration of the present embodiment described below, in a case where a movement instruction for the toner cartridge is received during an image forming operation, the printer control unit makes the determination on the basis of the type of the operation of the image forming apparatus. Note that only the differences with the configuration of the ninth embodiment described above will be described.

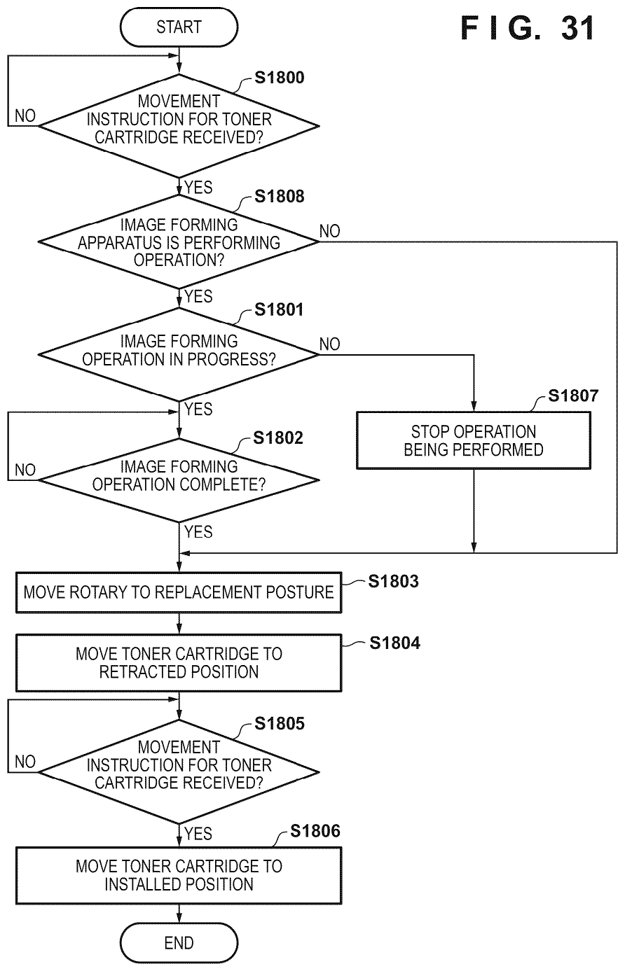

Control in the case of receiving a movement instruction for the toner cartridge 70 during an image forming operation will now be described using FIG. 31. FIG. 31 is a flowchart for describing control according to the present embodiment.

In a case where a movement instruction for the toner cartridge 70 is received (YES in step S1800), the engine control unit 1420 checks whether the image forming apparatus is performing operation (step S1808). In a case where the image forming apparatus is not performing an operation (NO in step S1808), the engine control unit 1420 moves the rotary body 90 to the replacement posture by rotating the rotary body 90 (step S1803). After step S1803, step S1804 is proceeded to. The control from step S1804 onward is the same as in the ninth embodiment and thus will not be described. In the flow of step S1804 according to the present embodiment, at the timing when the image forming apparatus 1 is executing post-processing, the rotary body 90 is moved to the replacement posture as in the ninth embodiment.

In a case where the image forming apparatus is performing an operation (YES in step S1808), the engine control unit 1420 checks whether the image forming apparatus is currently performing an image forming operation (step S1801). In other words, whether the operation of the image forming apparatus is an image forming operation is checked. In a case where the image forming apparatus 1 is not performing an image forming operation (NO in step S1801), this means that the image forming apparatus 1 is performing an operation other than an image forming operation. For example, this operation can be referred to as a first operation. In this case, the image forming apparatus 1 stops the operation being performed (step S1807). The first operation is, for example, preprocessing, post-processing, and pre-multiple-rotations.

After step S1807, the engine control unit 1420 moves the rotary body 90 to the replacement posture by rotating the rotary body 90 (step S1803). In other words, in the present embodiment, at the time when the toner cartridge 70 is located at the installed position and a movement instruction is received by the printer control unit, the image forming apparatus may be performing the first operation and the image forming operation may not be being performed. In this case, the printer control unit stops the first operation and controls the movement apparatus to move the toner cartridge 70 from the installed position to the retracted position.

In a case where the image forming apparatus 1 is performing an image forming operation (YES in step S1801), the printer control unit determines whether or not the image forming operation is complete (step S1802). In a case where the image forming operation is complete (step S1802), step S1803 onward is proceeded to.

As described above, in a case where a movement instruction for the toner cartridge 70 is received, the printer control unit according to the present embodiment controls the moving device 85 to move the toner cartridge 70 from the installed position to the retracted position. In other words, when the first status occurs, the printer control unit controls the moving device 85 to move the toner cartridge 70 from the installed position to the retracted position after the image forming operation is complete. Specifically, in a case where the first status has occurred, the printer control unit performs control to rotate the rotary body 90 to be put it in the replacement position, after the transfer operation onto the intermediate transfer belt 10a is complete. With this configuration, the image forming operation can be performed before the movement of the toner cartridge 70.

Also, the printer control unit, during post-processing, rotates the rotary body 90 and puts the rotary body 90 in the replacement posture. After the rotary body 90 is in the replacement posture, the printer control unit controls the moving device 85 to move the toner cartridge 70 from the installed position to the retracted position. After the toner cartridge 70 is moved to the retracted position and then after the toner cartridge 70 is moved from the retracted position to the installed position, the printer control unit resumes the stopped image forming operation.

Also, in the present embodiment, at the time when the toner cartridge 70 is located at the installed position and a movement instruction is received by the printer control unit, the image forming apparatus may be performing the first operation and the image forming operation may not be being performed. In this case, the printer control unit stops the first operation and controls the movement apparatus to move the toner cartridge 70 from the installed position to the retracted position. With this configuration, the movement of the toner cartridge 70 can be performed before operations with a lower priority to be performed, improving the usability.

### Eleventh Embodiment

According to the configuration of the ninth embodiment described above, in a case where a movement instruction for the toner cartridge is received during an image forming operation, whether or not to stop the image forming operation and move the toner cartridge to the retracted position is determined on the basis of a user determination.

In the present embodiment, the determination of whether or not to move the toner cartridge to the retracted position is performed on the basis of the toner remaining amount of the developing side containing portion 53a and the toner remaining amount inside the toner cartridge 70.

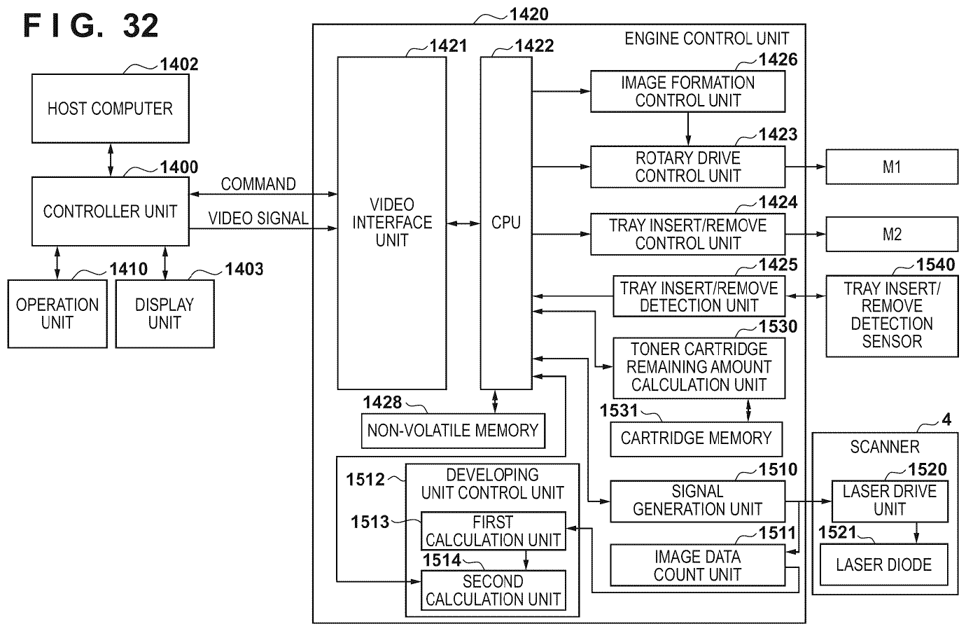

First, the configuration involving calculating the toner remaining amount of the developing side containing portion 53a and the toner remaining amount of the toner cartridge 70 will be described using FIG. 32. FIG. 32 is a block diagram according to the present embodiment.

The engine control unit 1420 includes a toner cartridge remaining amount calculation unit 1530, a cartridge memory 1531, a signal generation unit 1510, an image data count unit 1511, and a developing unit control unit 1512. The developing unit control unit 1512 includes a first calculation unit 1513 and a second calculation unit 1514. The scanner 4 includes a laser drive unit 1520 and a laser diode 1521.

Next, a method of calculating the toner remaining amount of the developing side containing portion 53a will be described. When the controller unit 1400 receives print data from the host computer 1402, the controller unit 1400 loads the print data and converts it into image data for image formation. After the print data is converted into image data, the controller unit 1400 generates a video signal for four color exposure on the basis of the image data. After the controller unit 1400 generates the video signal, the controller unit 1400 transmits a start printing instruction to the CPU 1422 via the video interface unit 1421.

The CPU 1422 transmits the received video signal to the signal generation unit 1510. The signal generation unit 1510 converts the video signal received via the video interface unit 1421 to a laser drive signal. Also, the signal generation unit 1510 transmits the laser drive signal to the laser drive unit 1520. A laser drive signal is a signal for driving the laser drive unit 1520 provided in the scanner 4. The laser drive unit 1520 applies a drive current to and drives the laser diode 1521 provided in the scanner 4 on the basis of the received laser drive signal. When the laser diode 1521 is applied with the drive current, the laser diode 1521 emits laser light and exposes the photosensitive drum 2.

The image data count unit 1511 samples the laser drive signal and counts the number of times the signal is high. In the present description, “high” indicates that a laser drive signal to cause the laser diode 1521 to emit light is output, and “low” indicates that a laser drive signal is not output.

The image data count unit 1511 does not count when the signal is “low” and counts when the signal is “high”. For example, the count amount increases by one each time there is a “high” signal.

The developing unit control unit 1512 obtains, from the image data count unit 1511, a count amount Ha, which is the number of times the laser drive signal becomes “high”. Then, the first calculation unit 1513 calculates a toner consumption amount Df consumed by image formation on the basis of the count amount Ha.

The second calculation unit 1514 calculates a toner remaining amount Dr inside the developing side containing portion 53a. The toner remaining amount Dr inside the developing side containing portion 53a after image formation is calculated via Formula (1) below using a toner remaining amount Dn inside the developing side containing portion 53a before image formation, the toner consumption amount Df consumed by the image formation, and a toner amount (Ts) supplied from the toner cartridge 70 to the developing side containing portion 53a in one supply operation. In the present embodiment, an operation is performed to rotate the rotary body 90 one time before performing the image forming operation so that the toner is supplied from the toner cartridge 70 to the developing side containing portion 53a. This operation is referred to as a supply operation.

$$Dr = Dn + T s - D f \qquad ( 1 )$$

The calculation of Formula (1) is performed each time the image forming operation is performed, and the calculated Dr is stored in the non-volatile memory 1428. Using Formula (1), the present image forming apparatus can calculate the toner remaining amount Dr inside the developing side containing portion 53a. In other words, the engine control unit 1420 calculates a value (referred to as a first value) relating to the remaining amount of developer of the developing side containing portion 53a.

As described below, the engine control unit 1420 determines whether the toner remaining amount Dr inside the developing side containing portion 53a is less than a first threshold α. In a case where Dr is less than the first threshold α, it is determined that the toner remaining amount inside the developing side containing portion 53a is low. In a case where Dr is greater than the first threshold α, it is determined that the toner remaining amount inside the developing side containing portion 53a is sufficient.

Next, a method of calculating the toner remaining amount of the toner cartridge 70 will be described. The toner cartridge 70 includes the toner cartridge memory 1531. The toner cartridge memory 1531 stores the toner remaining amount T of the toner cartridge 70. The toner cartridge remaining amount calculation unit 1530 subtracts a toner amount Ts supplied in one supply from a current toner remaining amount Tr each time the supply operation is performed. In other words, the post-image-formation toner remaining amount Tr is calculated using Formula (2) below. In other words, the engine control unit 1420 calculates a value (referred to as a second value) relating to the remaining amount of developer inside the toner cartridge 70.

$$T r n + 1 = Trn - Ts \qquad ( 2 )$$

The engine control unit 1420 determines whether the toner remaining amount Tr of the toner cartridge 70 is less than a second threshold β each time the toner remaining amount Tr of the toner cartridge 70 is calculated. In a case where Tr is less than the second threshold β, it is determined that the toner remaining amount inside the toner cartridge 70 is low. In a case where Tr is greater than the second threshold β, it is determined that the toner remaining amount inside the developing side containing portion 53a is sufficient.

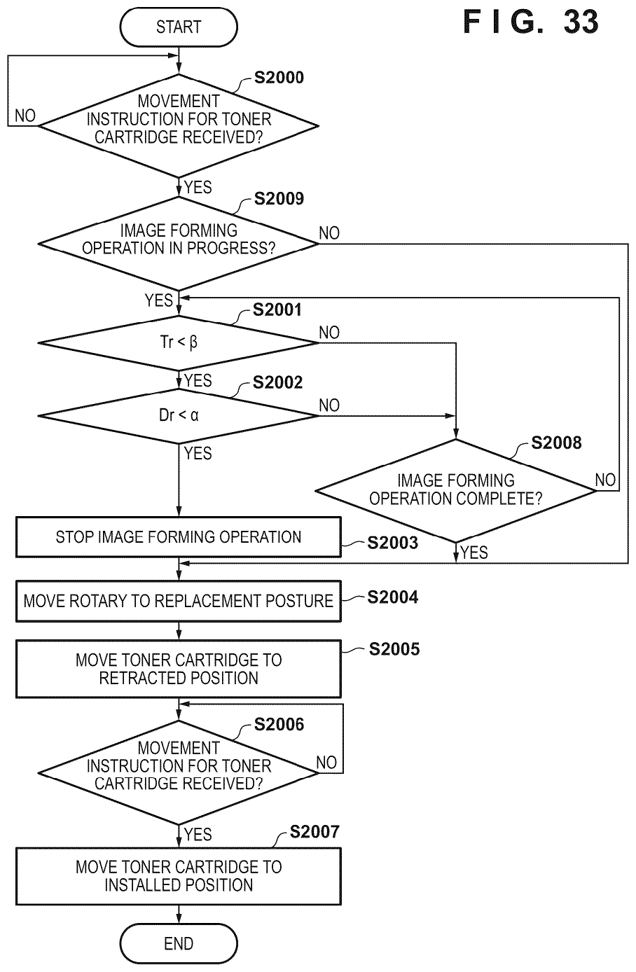

Next, control in the case of receiving a movement instruction for the toner cartridge 70 during an image forming operation will now be described using FIG. 33. FIG. 33 is a flowchart for describing control according to the present embodiment.

In a case where a movement instruction for the toner cartridge 70 is received (YES in step S2000), the engine control unit 1420 checks whether an image forming operation is in progress (step S2009). In a case where an image forming operation is not in progress (NO in step S2009), the engine control unit 1420 moves the rotary body 90 to the replacement posture by rotating the rotary body 90 (step S2004). Note that in the flow of step S2004 according to the present embodiment, at the timing when the image forming apparatus 1 is executing post-processing, the rotary body 90 is moved to the replacement posture as in the ninth embodiment.

Thereafter, the toner cartridge 70 is moved to the retracted position (step S2005). The user replaces the toner cartridge 70 after the toner cartridge 70 is moved to the retracted position and using the operation unit 1410 to input a movement instruction for the toner cartridge again. In a case where the engine control unit 1420 receives a movement instruction for the toner cartridge 70 (YES in step S2006), the engine control unit 1420 moves the toner cartridge 70 to the installed position (step S2007). After the toner cartridge 70 is moved from the retracted position to the installed position, the printer control unit resumes the stopped image forming operation.

In a case where an image forming operation is in progress (YES in step S2009), the engine control unit 1420 determines whether or not the toner remaining amount Tr of the toner cartridge 70 is less than the predetermined second threshold β (step S2001). In a case where the toner remaining amount Tr is greater than the predetermined second threshold β (NO in step S2001), the printer control unit determines whether or not the image forming operation is complete (step S2008). In a case where the image forming operation is not complete (NO in step S2008), step S2001 is returned to. On the other hand, in a case where the image forming operation is complete (YES in step S2008), the engine control unit 1420 moves the rotary body 90 to the replacement position by rotating the rotary body 90 (step S2004).

In a case where the toner remaining amount Tr of the toner cartridge 70 is less than the predetermined second threshold β (YES in step S2001), the engine control unit 1420 determines whether the toner remaining amount Dr inside the developing side containing portion 53a is less than the first threshold α (step S2002). In a case where the toner remaining amount Dr inside the developing side containing portion 53a is greater than the first threshold α (YES in step S2002), the printer control unit determines whether or not the image forming operation is complete (step S2008). In a case where the toner remaining amount Dr inside the developing side containing portion 53a is less than the first threshold α (NO in step S2002), the image forming operation is stopped (step S2003). After the image forming operation is stopped, the printer control unit moves the rotary body 90 to the replacement posture.

Thus, as described above, when the first status occurs, the printer control unit controls the moving device 85 to move the toner cartridge 70 from the installed position to the retracted position. When the first status occurs, the printer control unit controls the moving device 85 to move the toner cartridge 70 from the installed position to the retracted position after the image forming operation is complete.

Specifically, in a case where the first status has occurred, during post-processing, the printer control unit rotates the rotary body 90 and puts it in the replacement posture after the transfer operation onto the intermediate transfer belt 10a is complete. Also, after the rotary body 90 is in the replacement posture, the printer control unit controls the moving device 85 to move the toner cartridge 70 from the installed position to the retracted position. After the toner cartridge 70 is moved to the retracted position and then after the toner cartridge 70 is moved from the retracted position to the installed position, the printer control unit resumes the stopped image forming operation.

Also, in a case where the first status has occurred, the printer control unit references the first value and the second value calculated by the engine control unit 1420. In a case where the first value is greater than the first threshold α or the second value is greater than the second threshold β, after the image forming operation is complete, the moving device 85 is controlled to move the toner cartridge 70 from the installed position to the retracted position. In other words, in a case where there is sufficient toner required for the image forming operation inside the image forming apparatus 1, the image forming operation is prioritized.

On the other hand, in a case where the first value is less than the first threshold α or the second value is less than the second threshold β, the printer control unit stops the image forming operation and controls the moving device to move the toner cartridge 70 from the installed position to the retracted position. In other words, in a case where the first status has occurred and the printer control unit determines that the predetermined condition has been satisfied, the printer control unit stops the image forming operation. Also, after the image forming operation is stopped, the printer control unit controls the movement apparatus 85 to move the toner cartridge 70 from the installed position to the retracted position. With this configuration, in a case where there is not sufficient toner required for the image forming operation inside the image forming apparatus 1, the image forming operation is not performed to prevent image degradation caused by insufficient toner.

Note that in the ninth to eleventh embodiments, the image forming apparatus 1 moves the rotary body 90 to the replacement posture at a timing when the post-processing is being performed. However, the rotary body 90 may be moved to the replacement posture irrespective of the post-processing timing.

Note that according to the configuration of the ninth to eleventh embodiment described above, an instruction to replace the toner cartridge comes from the operation unit 1410. However, another configuration may be used in which the instruction comes from the host computer 1402 or from a mobile terminal such as a smartphone via wireless communication.

Note that in the present embodiments described above, an example of an image forming apparatus including the rotary body 90 is used. However, the present invention can be applied to an image forming apparatus without the rotary body 90. For example, the present invention can be applied to a tandem-type image forming apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-067720, filed Apr. 18, 2024, Japanese Patent Application No. 2024-070812, filed Apr. 24, 2024, Japanese Patent Application No. 2024-070811, filed Apr. 24, 2024, and Japanese Patent Application No. 2024-069170, filed Apr. 22, 2024, which are hereby incorporated by reference herein in their entirety.

What is claimed is:

1. An image forming apparatus configured to have a cartridge containing toner detachably attached thereto, comprising:
a photosensitive member;
a developing unit configured to be supplied with the toner from the cartridge and develop an electrostatic latent image formed on the photosensitive member using the toner; and
a control unit configured to control whether or not to execute replacement processing for replacing the cartridge on a basis of information relating to the cartridge in a case where there is an instruction to replace the cartridge.

2. The image forming apparatus according to claim 1, wherein
the control unit executes processing to notify that replacing the cartridge is unnecessary in a case where the replacement processing is not executed.

3. The image forming apparatus according to claim 1, wherein
the control unit does not execute the replacement processing in a case where a toner remaining amount of the cartridge is greater than a threshold.

4. The image forming apparatus according to claim 3, wherein
the control unit executes the replacement processing in a case where a toner remaining amount of the cartridge is equal to or less than the threshold.

5. The image forming apparatus according to claim 1, wherein
the control unit does not execute the replacement processing, in a case where a toner remaining amount of the cartridge cannot be made equal to or less than a threshold even when supply processing is executed to supply the developing unit with the toner contained in the cartridge.

6. The image forming apparatus according to claim 5, wherein
in a case where the toner remaining amount of the cartridge can be made equal to or less than the threshold by the supply processing being executed, the control unit executes the supply processing to make the toner remaining amount of the cartridge being equal to or less than the threshold, and thereafter the replacement processing.

7. The image forming apparatus according to claim 5, wherein
the control unit does not execute the replacement processing, in a case where the toner remaining amount of the cartridge can be made equal to or less than the threshold by the supply processing being executed, but an estimated time required for the supply processing is longer than a predetermined amount of time.

8. The image forming apparatus according to claim 5, wherein
in a case where the toner remaining amount of the cartridge can be made equal to or less than the threshold by the supply processing being executed, but an estimated time required for the supply processing is longer than a predetermined amount of time, the control unit prompts a user to select whether or not to execute the supply processing, and executes, if the user selects to execute the supply processing, the supply processing to make the toner remaining amount of the cartridge being equal to or less than the threshold, and thereafter the replacement processing.

9. The image forming apparatus according to claim 8, wherein
when prompting the user to select whether or not to execute the supply processing, the control unit notifies the user that the supply processing will take longer than the predetermined amount of time or presents to the user the estimated time.

10. The image forming apparatus according to claim 5, wherein
the cartridge includes a memory device configured to store information indicating a supply amount of one supply from the cartridge to the developing unit, and
the control unit determines the toner remaining amount of the cartridge on a basis of the supply amount.

11. The image forming apparatus according to claim 10, further comprising:
a rotary configured to be rotationally driven about a rotation axis and support the developing unit, wherein
the cartridge installed in the image forming apparatus is stored in the rotary at a position adjacent to the developing unit,
an opening provided in the cartridge and an opening provided in the developing unit face one another in a state where the cartridge is stored in the rotary, and
the supply amount of one supply from the cartridge to the developing unit is an amount of the toner supplied from the cartridge to the developing unit while the rotary is rotated once.

12. The image forming apparatus according to claim 10, wherein
the control unit determines a consumption amount of the toner stored in the developing unit on a basis of a signal for forming the electrostatic latent image on the photosensitive member,
the control unit determines a toner remaining amount of the developing unit on a basis of the supply amount and the consumption amount, and
the control unit determines whether or not the toner remaining amount of the cartridge can be made equal to or less than the threshold by the supply processing, on a basis of the toner remaining amount of the cartridge, the toner remaining amount of the developing unit, and a maximum amount of the toner storable in the developing unit.

13. The image forming apparatus according to claim 5, wherein
the control unit measures a toner remaining amount of the developing unit and determines the toner remaining amount of the cartridge on a basis of a change in the toner remaining amount of the developing unit.

14. The image forming apparatus according to claim 13, wherein the developing unit includes two electrodes,
the control unit measures the toner remaining amount of the developing unit on a basis of a capacitance between the two electrodes determined by applying a voltage across the two electrodes, and
the control unit determines whether or not the toner remaining amount of the cartridge can be made equal to or less than the threshold by the supply processing, on a basis of the toner remaining amount of the cartridge, the toner remaining amount of the developing unit, and a maximum amount of the toner storable in the developing unit.

15. The image forming apparatus according to claim 3, wherein
the cartridge includes a memory device, and
the control unit executes the replacement processing for the cartridge irrespective of the toner remaining amount of the cartridge in a case where predetermined information is not stored in the memory device.

16. The image forming apparatus according to claim 15, wherein
the predetermined information is information indicating that the cartridge is provided by a subscription service.

17. The image forming apparatus according to claim 3, wherein
the control unit executes the replacement processing irrespective of the toner remaining amount of the cartridge if a malfunction is detected in the cartridge.

18. The image forming apparatus according to claim 17, wherein
the control unit detects the malfunction in the cartridge in a case where a toner remaining amount of the developing unit does not change even when the toner is supplied from the cartridge to the developing unit at a time when the toner remaining amount of the cartridge is greater than a predetermined amount.

19. The image forming apparatus according to claim 1, wherein
the replacement processing includes processing to move the cartridge located at a first position to a second position.

20. The image forming apparatus according to claim 19, wherein
a whole of the cartridge located at the first position is inside of a body frame of the image forming apparatus, and
at least a portion of the cartridge located at the second position is outside of the body frame of the image forming apparatus.
